(19) United States
(12) Patent Application Publication
(10) Pub. No.: US 2026/0245565 A1
(43) Pub. Date: Aug. 20, 2026

(54) AUDIO ENCODING METHOD AND APPARATUS, AUDIO DECODING METHOD AND APPARATUS, AND READABLE STORAGE MEDIUM

(71) Applicant: Tencent Technology (Shenzhen) Company Limited, Shenzhen (CN)

(72) Inventor: Wei XIAO, Shenzhen (CN)

(73) Assignee: Tencent Technology (Shenzhen) Company Limited, Shenzhen (CN)

(21) Appl. No.: 19/642,238

(22) Filed: Apr. 8, 2026

Related U.S. Application Data
(63) Continuation of application No. PCT/CN2024/130151, filed on Nov. 6, 2024.

(30) Foreign Application Priority Data
Nov. 29, 2023 (CN) 202311614893.4

(51) Int. Cl. G10L 19/002; G10L 19/00; G10L 19/02; G10L 19/032; G10L 25/30

(52) U.S. Cl. CPC G10L 19/002; G10L 19/0204; G10L 19/032; G10L 25/30; G10L 2019/0001

(57) ABSTRACT

An audio decoding method includes acquiring an audio bitstream encapsulation including an audio bitstream that is being obtained by at least performing, using a target encoding mode and a target bit rate mode, audio encoding based on an audio signal, the target encoding mode being acquired from a plurality of candidate encoding modes, and the target bit rate mode being acquired from a plurality of candidate bit rate modes; acquiring the target encoding mode and the target bit rate mode from a frame header included in the audio bitstream encapsulation performing, using the target encoding mode and the target bit rate mode, signal decoding based on the audio bitstream to obtain an estimated value of an encoding feature corresponding to the audio bitstream; and reconstructing, using the target encoding mode, the estimated value of the encoding feature to obtain a reconstructed audio signal corresponding to the audio bitstream.

### CROSS-REFERENCE TO RELATED APPLICATIONS

This application is a bypass continuation application of International Patent Application No. PCT/CN2024/130151, filed on Nov. 6, 2024, which claims priority to and is based on Chinese Patent Application No. 202311614893.4, filed on Nov. 29, 2023, the disclosures of which are incorporated herein in their entireties by reference.

### FIELD

The present disclosure relates to artificial intelligence technologies, and in particular, to an audio encoding method and apparatus, an audio decoding method and apparatus, an electronic device, a computer-readable storage medium, and a computer program product.

### BACKGROUND

An audio encoding and decoding technology is one of important applications in the field of artificial intelligence. The audio encoding and decoding technology is a core technology in communication services including remote audio and video calls. Simply speaking, a voice encoding technology involves transferring voice information as much as possible using relatively few network bandwidth resources. From the perspective of Shannon's information theory, voice encoding is source encoding. An objective of source encoding is to compress a data volume of to-be-transferred information as much as possible at an encoder side, remove redundancy in the information, and enable lossless (or nearly lossless) recovery at a decoder side.

Quality of an audio generated by decoding at the decoder side can be improved to meet a user requirement.

### SUMMARY

Some embodiments of the present disclosure provide an audio processing method and apparatus, an electronic device, a computer-readable storage medium, and a computer program product, which can output reconstructed audio signals at different quality levels while ensuring efficiency of audio decoding.

According to some embodiments of the disclosure, an audio decoding method performed by an electronic device may include acquiring an audio bitstream encapsulation, the audio bitstream encapsulation including an audio bitstream, the audio bitstream being obtained by at least performing, using a target encoding mode and a target bit rate mode, audio encoding based on an audio signal, the target encoding mode being acquired from a plurality of candidate encoding modes, and the target bit rate mode being acquired from a plurality of candidate bit rate modes; acquiring, when a decoding request for the audio bitstream encapsulation is obtained, the target encoding mode and the target bit rate mode from a frame header included in the audio bitstream encapsulation; performing, using the target encoding mode and the target bit rate mode, signal decoding based on the audio bitstream to obtain an estimated value of an encoding feature corresponding to the audio bitstream; and reconstructing, using the target encoding mode, the estimated value of the encoding feature to obtain a reconstructed audio signal corresponding to the audio bitstream.

According to some embodiments of the disclosure, an audio decoding apparatus includes at least one memory configured to store computer program code; and at least one processor configured to read the program code and operate as instructed by the program code. The program code including acquisition code configured to cause the least one processor to acquire an audio bitstream encapsulation, the audio bitstream encapsulation including an audio bitstream, the audio bitstream being obtained by at least performing, using a target encoding mode and a target bit rate mode, audio encoding based on an audio signal, the target encoding mode being acquired from a plurality of candidate encoding modes, and the target bit rate mode being acquired from a plurality of candidate bit rate modes; and acquire, when a decoding request for the audio bitstream encapsulation is obtained, the target encoding mode and the target bit rate mode from a frame header included in the audio bitstream encapsulation; The program code may further include signal decoding code configured to cause the at least one processor to perform, using the target encoding mode and the target bit rate mode, signal decoding based on the audio bitstream to obtain an estimated value of an encoding feature corresponding to the audio bitstream; and reconstruction code configured to cause the least one processor to reconstruct, using the target encoding mode, the estimated value of the encoding feature to obtain a reconstructed audio signal corresponding to the audio bitstream.

According to some embodiments of the disclosure, the non-transitory computer-readable storage medium, storing computer code, when executed by at least one processor, may cause the at least one processor to at least: acquire an audio bitstream encapsulation, the audio bitstream encapsulation including an audio bitstream, the audio bitstream being obtained by at least performing, using a target encoding mode and a target bit rate mode, audio encoding based on an audio signal, the target encoding mode being acquired from a plurality of candidate encoding modes, and the target bit rate mode being acquired from a plurality of candidate bit rate modes; acquire, when a decoding request for the audio bitstream encapsulation is obtained, the target encoding mode and the target bit rate mode from a frame header included in the audio bitstream encapsulation; perform, using the target encoding mode and the target bit rate mode, signal decoding based on the audio bitstream to obtain an estimated value of an encoding feature corresponding to the audio bitstream; and reconstruct, using the target encoding mode, the estimated value of the encoding feature to obtain a reconstructed audio signal corresponding to the audio bitstream.

According to some embodiments of the disclosure, an audio encoding method performed by an electronic device may include acquiring, when an encoding request for an audio signal is obtained, a target encoding mode for the audio signal from a plurality of encoding modes, and acquiring a target bit rate mode for the audio signal from a plurality of bit rate modes; extracting, using the target encoding mode, an encoding feature of the audio signal from the audio signal; performing, using the target bit rate mode, signal encoding based on the encoding feature to obtain an audio bitstream of the audio signal; determining a frame header based on the target encoding mode and the target bit rate mode; and generating an audio bitstream encapsulation of the audio signal based on the audio bitstream and the frame header.

According to some embodiments of the disclosure, an audio encoding apparatus may include acquisition code configured to cause the at least one processor to acquire, when an encoding request for an audio signal is obtained, a target encoding mode for the audio signal from a plurality of encoding modes, and acquiring a target bit rate mode for the audio signal from a plurality of bit rate modes; extraction code configured to cause the at least one processor to extract, by using the target encoding mode, an encoding feature of the audio signal from the audio signal; signal encoding code configured to cause the at least one processor to perform, using the target bit rate mode, signal encoding based on the encoding feature to obtain an audio bitstream of the audio signal; construction code configured to cause the at least one processor to determine a frame header based on the target encoding mode and the target bit rate mode; and generation code configured to generate an audio bitstream encapsulation of the audio signal based on the audio bitstream and the frame header.

According to some embodiments of the disclosure, a non-transitory computer-readable storage medium, storing computer code, when executed by at least one processor, may cause the at least one processor to at least: acquire, when an encoding request for an audio signal is obtained, a target encoding mode for the audio signal from a plurality of encoding modes, and acquiring a target bit rate mode for the audio signal from a plurality of bit rate modes; extract, using the target encoding mode, an encoding feature of the audio signal from the audio signal; perform, using the target bit rate mode, signal encoding based on the encoding feature to obtain an audio bitstream of the audio signal; determine a frame header based on the target encoding mode and the target bit rate mode; and generate an audio bitstream encapsulation of the audio signal based on the audio bitstream and the frame header.

Some embodiments of the disclosure provide advantages in computer technology and/or technical field: signal decoding is performed on the audio bitstream by using different encoding modes and bit rate modes, to obtain estimated values of the encoding features with different precision, and then the estimated values of the encoding features with different precision are reconstructed to obtain reconstructed audio signals at different quality levels, thereby improving diversification of quality of the reconstructed audio signals, to meet an actual application requirement of a user.

### BRIEF DESCRIPTION OF DRAWINGS

The above and other aspects, features, and advantages of one or more embodiments of the present disclosure will be more apparent from the following description taken in conjunction with the accompanying drawings, in which:

FIG. 1 is a schematic diagram of comparing spectra at different bit rates according to some embodiments of the present disclosure;

FIG. 2 is a schematic architectural diagram of an audio encoding and decoding system according to some embodiments of the disclosure;

FIG. 3A is a first schematic structural diagram of an electronic device according to some embodiments of the disclosure;

FIG. 3B is a second schematic structural diagram of an electronic device according to some embodiments of the disclosure;

FIG. 4A is a first schematic flowchart of an audio encoding method according to some embodiments of the disclosure;

FIG. 4B is a second schematic flowchart of an audio encoding method according to some embodiments of the disclosure;

FIG. 4C is a third schematic flowchart of an audio encoding method according to some embodiments of the disclosure;

FIG. 4D is a fourth schematic flowchart of an audio encoding method according to some embodiments of the disclosure;

FIG. 4E is a fifth schematic flowchart of an audio encoding method according to some embodiments of the disclosure;

FIG. 5A is a first schematic flowchart of an audio decoding method according to some embodiments of the disclosure;

FIG. 5B is a second schematic flowchart of an audio decoding method according to some embodiments of the disclosure;

FIG. 5C is a third schematic flowchart of an audio decoding method according to some embodiments of the disclosure;

FIG. 6A is a schematic diagram of channels without using group convolution according to some embodiments of the disclosure;

FIG. 6B is a schematic diagram of channels using group convolution according to some embodiments of the disclosure;

FIG. 6C is a schematic diagram of a voice communication link according to some embodiments of the disclosure;

FIG. 7 is a schematic flowchart of a multi-mode, multi-rate voice encoding method according to some embodiments of the disclosure;

FIG. 8 is a schematic diagram of a filter bank according to some embodiments of the disclosure;

FIG. 9A is a schematic diagram of an ordinary convolutional network according to some embodiments of the disclosure;

FIG. 9B is a schematic diagram of a dilated convolutional network according to some embodiments of the disclosure;

FIG. 10 is a schematic diagram of bandwidth extension according to some embodiments of the disclosure;

FIG. 11 is a schematic diagram of a third NN according to some embodiments of the disclosure;

FIG. 12A is a schematic structural diagram of a residual block used in an encoding block according to some embodiments of the disclosure;

FIG. 12B is a schematic structural diagram of a residual unit according to some embodiments of the disclosure;

FIG. 13A is a schematic structural diagram of a bitstream encapsulation in a wideband encoding mode according to some embodiments of the disclosure;

FIG. 13B is a schematic structural diagram of a bitstream encapsulation that does not include a residual and does not include flatness side information in an ultra-wideband encoding mode according to some embodiments of the disclosure;

FIG. 13C is a schematic structural diagram of a bitstream encapsulation that includes a residual and does not include flatness side information in an ultra-wideband encoding mode according to some embodiments of the disclosure;

FIG. 13D is a schematic structural diagram of a bitstream encapsulation that does not include a residual and includes flatness side information in an ultra-wideband encoding mode according to some embodiments of the disclosure;

FIG. 13E is a schematic structural diagram of a bitstream encapsulation that includes a residual and flatness side information in an ultra-wideband encoding mode according to some embodiments of the disclosure;

FIG. 14 is a schematic diagram of a first NN according to some embodiments of the disclosure;

FIG. 15A is a schematic structural diagram of a bitstream encapsulation in a wideband stereo encoding mode according to an exemplary embodiment of the disclosure;

FIG. 15B is a schematic structural diagram of a bitstream encapsulation that does not include a residual and does not include flatness side information in an ultra-wideband stereo encoding mode according to some embodiments of the disclosure;

FIG. 15C is a schematic structural diagram of a bitstream encapsulation that includes a residual and does not include flatness side information in an ultra-wideband stereo encoding mode according to some embodiments of the disclosure;

FIG. 15D is a schematic structural diagram of a bitstream encapsulation that does not include a residual and includes flatness side information in an ultra-wideband stereo encoding mode according to some embodiments of the disclosure; and

FIG. 15E is a schematic structural diagram of a bitstream encapsulation that includes a residual and flatness side information in an ultra-wideband stereo encoding mode according to some embodiments of the disclosure.

### DETAILED DESCRIPTION

To make the objectives, technical solutions, and advantages of the present disclosure clearer, the disclosure will be described in further detail below with reference to the accompanying drawings. The described embodiments are not to be considered as a limitation to the disclosure. All other embodiments obtained by a person skilled in the art without creative efforts shall fall within the protection scope of the disclosure.

The terms “first,” “second,” “third,” and the like in the description and in the claims, if any, are used for distinguishing between similar elements and not necessarily for describing a sequential or chronological order. It is to be understood that the terms so used are interchangeable under appropriate circumstances.

The term, involved in the following description, “some embodiments” describes subsets of all possible embodiments, but “some embodiments” may be the same subset or different subsets of all the possible embodiments and may be combined with each other without conflict.

Unless explicitly described or implicitly understood from one or more embodiments of the present disclosure, at least one of the components, elements, modules, units, or nominalized verbs represented by a block or equivalent indication in the drawings may be implemented or embodied by analog and/or digital circuits. These circuits may include one or more of a logic gate, an integrated circuit, a microprocessor, a microcontroller, a memory circuit, a passive electronic component, an active electronic component, an optical component, and the like. Alternatively or additionally, these components may be implemented or embodied by software comprising one or more instructions stored in an internal or external storage medium that is readable by at least one processor. For example, the at least one processor may invoke at least one of the one or more instructions stored in the storage medium and execute it, with or without using one or more other components under the control of the at least one processor. This allows the at least one processor to perform at least one function or operation described above as being performed by each of the components according to the at least one instruction invoked. The at least one processor may include a central processing unit (CPU), a graphics processing unit (GPU), or another type of microprocessor, without limitation. In other examples, the at least one processor may be implemented as an application-specific integrated circuit (ASIC) or field-programmable gate array (FPGA).

Unless defined otherwise, all technical and scientific terminologies used herein have the same meaning as commonly understood by a person skilled in the art to which the disclosure belongs. Terms used herein are merely intended to describe some embodiments of the disclosure, but are not intended to limit the disclosure.

Before some embodiments of the disclosure are further described in detail, nouns and terms involved in some embodiments of the disclosure are described. The nouns and terms involved in some embodiments of the disclosure are applicable to the following explanations.

Further, unless stated otherwise or otherwise clear from context, phrase “based on” may refer to “based at least in part on” and not “based solely on.”

As used herein, an expression, “a and/or b” should be understood as including only a, only b and both a and b. As used herein, expressions “at least one of a, b, and c” and “at least one of a, b, or c” should be understood as including only a, only b, only c, both a and b, both a and c, both b and c, or all of a, b, and c.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

The terms “a,” “an,” “the,” and similar referents in the context of describing the disclosed embodiments (especially in the claims) are to be construed to cover both singular and plural forms, unless otherwise indicated or clearly contradicted by context. The number of items in a plurality is at least two, but may be more when indicated explicitly or by context.
1) NN: it refers to an algorithmic mathematical model that imitates behavior features of an animal NN and performs distributed parallel information processing. The network depends on complexity of a system and adjusts interconnected relationships between a large number of internal nodes to achieve information processing.
2) Deep learning (DL): it refers to a new research direction in the field of machine learning (ML). DL involves learning inherent laws and representation levels of sample data, and information obtained during the learning is of great help in the interpretation of data such as a text, an image, and a sound. Its ultimate objective is to enable a machine to have the ability to analyze and learn like humans, and to recognize the data such as a text, an image, and a sound.
3) Quantization: it refers to a process of approximating continuous values (or a large number of discrete values) of a signal to a limited number of (or fewer) discrete values. Quantization includes vector quantization (VQ) and scalar quantization.

VQ is an effective lossy compression technology, and its theoretical basis is Shannon's rate-distortion theory. A basic principle of VQ is to replace an input vector with an index (also referred to as a quantization value) of a codeword that best matches the input vector in a codebook for transmission and storage. Only a simple table lookup operation is needed during decoding. For example, a vector space is formed according to several pieces of scalar data, and the vector space is divided into several small regions. During quantization, a corresponding index of a vector falling into the small region is adopted to replace the input vector.

Scalar quantization refers to quantizing scalars, e.g., one-dimensional VQ. A dynamic range is divided into several small intervals, and each small interval has a representative value (e.g., an index). When an input signal falls within an interval, the input signal is quantized into the representative value.
4) Entropy encoding: it refers to a lossless encoding mode in which no information is lost according to an entropy principle in an encoding process. It is also a key module in lossy encoding and located at an end of an encoder. Entropy encoding includes Shannon encoding, Huffman encoding, Exponential-Golomb (Exp-Golomb) encoding, and arithmetic encoding.
5) Quadrature mirror filter (QMF) bank: it refers to an analysis-synthesis filter pair. A QMF analysis filter is configured for sub-band signal decomposition to reduce a signal bandwidth so that each sub-band signal may be successfully processed through a respective channel. A QMF synthesis filter is configured to synthesize sub-band signals recovered by the decoder side, for example, to reconstruct an original audio signal through zero-value interpolation, band-pass filtering, or other modes.
6) Bitstream encapsulation: it refers to packaging an encoded bitstream into a specific format to facilitate storage or network transmission. In an encapsulation process, the bitstream that has been encoded and compressed is placed into a file according to a certain format, to form a container. The container includes a bitstream, and may also include some metadata, for example, information such as an encoding type, a bit rate, and a frame rate. An encapsulation format (also referred to as a container format) may be considered as a wrapper of a bitstream (an audio bitstream or a video bitstream). The bitstream is stored in a file in the encapsulation format. Selection of the encapsulation format depends on a specific application scenario and requirement. Different encapsulation formats support different encoding formats. For example, MP4, a Flash video format (FLV Adobe Flash Video), and the like are common encapsulation formats.
7) Wideband: it reflects resolution or a sampling rate of an audio signal. According to definitions of standard organizations such as International Telecommunication Union-Telecommunication Standardization Sector (ITU-T) and 3rd Generation Partnership Project (3GPP), a wideband employs a sampling rate of 16000 Hertz (Hz) and an effective bandwidth up to 8000 Hz. A transmission rate of the wideband is generally above 1.54 megabits per second (Mbps).
8) Ultra-wideband: it reflects resolution or a sampling rate of an audio signal. According to definitions of standard organizations such as the ITU-T and the 3GPP, an ultra-wideband employs a sampling rate of 32000 Hz and an effective bandwidth up to 16000 Hz. The ultra-wideband is a wireless communication technology. The ultra-wideband may means that a bandwidth of an audio signal is at least 500 MHz, or a ratio of the bandwidth to a central frequency of the audio signal exceeds 20%.

The QMF bank, a dilated convolutional network, and bandwidth extension are first described below before the audio encoding method and the audio decoding method provided in some embodiments of the disclosure are specifically described.

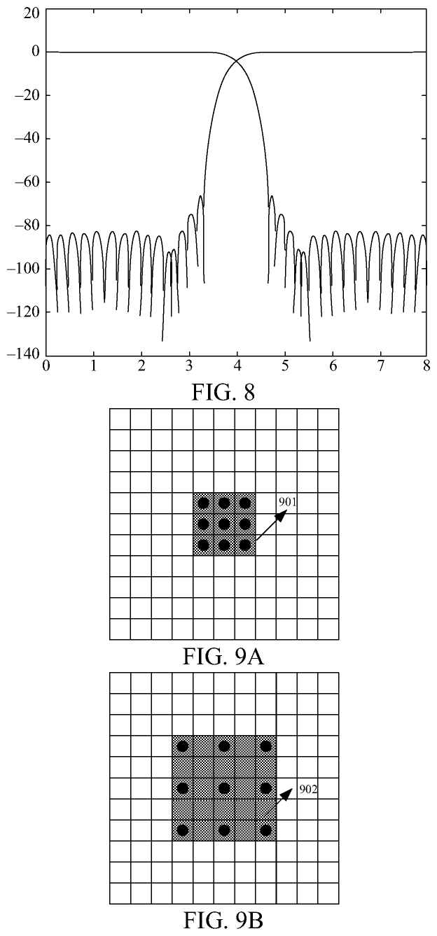

The QMF bank is an analysis-synthesis filter pair. For the QMF analysis filter, an input signal with a sampling rate Fs may be decomposed into two signals with a sampling rate Fs/2, representing a QMF low-pass signal and a QMF high-pass signal, respectively. FIG. 8 shows spectral responses of a low-pass part H_Low(z) and a high-pass part H_High(z) of the QMF. Based on related theoretical knowledge of a QMF analysis filter bank, a correlation between coefficients of low-pass filtering and high-pass filtering may be easily described, as shown in Formula (1):

$${h}_{High} ( k ) = - {1}^{k} {h}_{Low} ( k ) \qquad ( 1 )$$

where h_{Low}(k) represents the coefficient of low-pass filtering, and h_{High}(k) represents the coefficient of high-pass filtering.

Similarly, according to the related theory of the QMF, a QMF synthesis filter bank may be described based on H_Low(z) and H_High(z) of the QMF analysis filter bank, as shown in Formula (2):

$${G}_{Low} ( z ) = {H}_{Low} ( z ) \qquad ( 2 )$$

$${G}_{High} ( z ) = ( - 1 ) * {H}_{High} ( z )$$

where G_{Low}(z) represents a recovered low-pass signal, and G_{High}(z) represents a recovered high-pass signal.

The low-pass and high-pass signals recovered by the decoder side are synthesized through the QMF synthesis filter bank so that a reconstructed signal (e.g., a synthesized signal) with a sampling rate Fs corresponding to the input signal may be recovered.

Referring to FIG. 9A and FIG. 9B, FIG. 9A is a schematic diagram of an ordinary convolutional (e.g., causal convolutional) network according to some embodiments of the disclosure, and FIG. 9B is a schematic diagram of a dilated convolutional network according to some embodiments of the disclosure. Compared with the ordinary convolutional network, dilated convolution can increase a receptive field, keep a size of a feature map unchanged, and further avoid errors caused by upsampling and downsampling. Convolution kernel sizes shown in FIG. 9A and FIG. 9B are each 3×3. However, a receptive field 901 in the ordinary convolution shown in FIG. 9A is only 3, and a receptive field 902 in the dilated convolution shown in FIG. 9B reaches 5. For a convolution kernel having a size of 3×3, the ordinary convolution shown in FIG. 9A has a receptive field of 3 and a dilation rate (a quantity of intervals of points in the convolution kernel) of 1. However, the dilated convolution shown in FIG. 9B has a receptive field of 5 and a dilation rate of 2.

The convolution kernel may alternatively move on a plane similar to that in FIG. 9A or FIG. 9B, and a concept of a stride rate (e.g., step size) is involved herein. For example, each time the convolution kernel is shifted by 1 grid, a corresponding stride rate is 1.

In addition, a quantity of convolution channels may correspond to how many parameters corresponding to the convolution kernel are used to perform convolution analysis. Theoretically, a larger quantity of channels indicates more comprehensive signal analysis and higher precision. However, a larger quantity of channels indicates higher complexity. For example, for a 1×320 tensor, a 24-channel convolution operation may be adopted to output a 24×320 tensor.

A dilated convolution kernel size (e.g., for a voice signal, a convolution kernel size may be set to 1×3), the dilation rate, the stride rate, and the quantity of channels may be defined according to actual application requirements, which is not specifically limited in some embodiments of the disclosure.

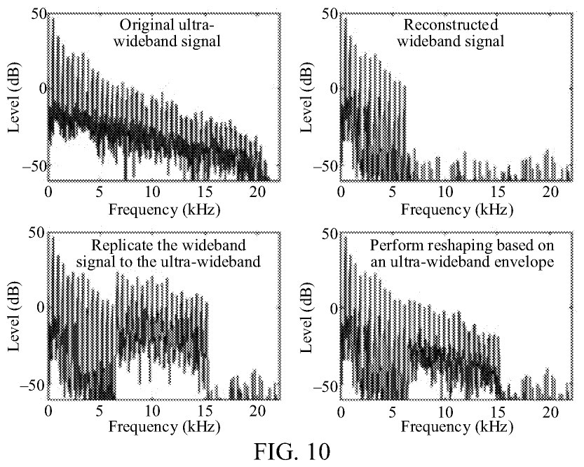

As shown in a schematic diagram of bandwidth extension (or bandwidth replication) in FIG. 10, a wideband signal is first reconstructed, then the wideband signal is replicated to an ultra-wideband signal, and finally, reshaping is performed based on an ultra-wideband envelope. A frequency domain implementation solution shown in FIG. 10 specifically includes: 1) implementing encoding of one core layer at a low sampling rate; 2) selecting a low-frequency spectrum for replication to a high-frequency spectrum; and 3) performing gain processing on the replicated high-frequency spectrum according to boundary information (describing an energy correlation between a high frequency and a low frequency, and the like) recorded in advance. The sampling rate may be doubled only at a bit rate of 1 to 2 kbps.

The voice encoding technique may include transferring voice information as much as possible using relatively few network bandwidth resources. A compression rate of a voice codec may reach more than 10 times. For example, after voice data of original 10 MB is compressed by an encoder, only 1 MB is needed for transmission, thereby greatly reducing the bandwidth resources consumed for information transferring. For example, for a wideband voice signal with a sampling rate of 16000 Hz, if a 16-bit sampling depth is used (fineness of voice strength recorded in sampling), a bit rate (a transmitted data volume per unit time) of an uncompressed version is 256 kbps. If the voice encoding technology is used, even with lossy encoding, in a bit rate range of 10 to 20 kbps, the quality of a reconstructed voice signal may be close to that of the uncompressed version, and even audibly perceived as indistinguishable. If a service with a higher sampling rate is needed, for example, an ultra-wideband voice of 32000 Hz, a bit rate range reaches at least 30 kbps.

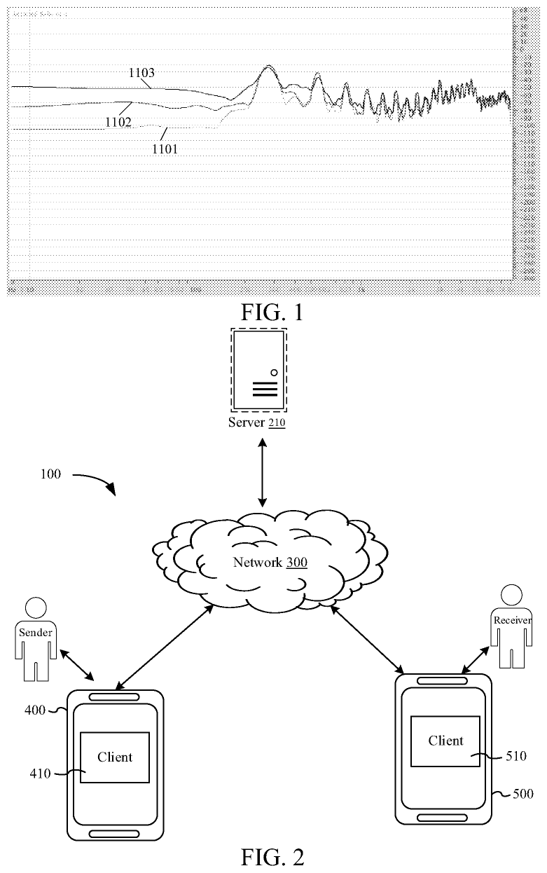

In a communication system, to ensure successful communication, a standard voice encoding and decoding protocol is deployed in the industry, for example, standards from international and domestic standard organizations such as ITU-T, 3GPP, IETF, AVS, and CCSA, G.711, G.722, AMR series, EVS, and OPUS. FIG. 1 is a schematic diagram of comparing spectra at different bit rates, to demonstrate a relationship between compressed bit rates and quality. A curve 1101 is a spectrum curve of an original voice, e.g., an uncompressed signal. A curve 1102 is a spectrum curve of an OPUS encoder at a bit rate of 20 kbps. A curve 1103 is a spectrum curve of OPUS encoding at a bit rate of 6 kbps. It can be learned from FIG. 1 that as the encoding bit rate increases, a compressed signal is closer to an original signal.

A voice encoding principle is roughly as follows. The voice encoding may directly encode voice waveform samples one by one. Alternatively, related low-dimensional features are extracted based on a human sounding principle, an encoder side encodes the features, and a decoder side reconstructs a voice signal based on these parameters.

The foregoing encoding principles come from voice signal modeling, e.g., a signal processing-based compression method, and the audio encoding quality cannot be ensured. To improve the encoding efficiency while ensuring the voice quality, some embodiments of the disclosure provide an audio encoding method and apparatus, an audio decoding method and apparatus, an electronic device, a computer-readable storage medium, and a computer program product. Exemplary application of an electronic device provided in some embodiments of the disclosure is described below. The electronic device provided in some embodiments of the disclosure may be implemented as a terminal device or as a server or may be collaboratively implemented by a terminal device and a server. An example in which the electronic device is implemented as the terminal device is used for description below.

For example, referring to FIG. 2, FIG. 2 is a schematic architectural diagram of an audio encoding and decoding system 10 according to some embodiments of the disclosure. The audio encoding and decoding system 10 includes: a server 210, a network 300, a terminal device 400 (e.g., an encoder side), and a terminal device 500 (e.g., a decoder side). The network 300 may be a local area network, a wide area network, or a combination thereof.

In some embodiments, a client 410 runs on the terminal device 400. The client 410 may be various types of clients, such as an instant messaging client, a web conference client, a livestreaming client, or a browser. In response to an audio acquisition instruction triggered by a sender (e.g., an initiator of a web conference, a host, or an initiator of a voice call), the client 410 invokes a microphone provided in the terminal device 400 to acquire an audio signal, and performs audio encoding on the acquired audio signal to obtain an audio bitstream.

For example, the client 410 invokes the audio encoding method provided in some embodiments of the disclosure to encode the acquired audio signal. A target encoding mode for the audio signal is acquired from a plurality of encoding modes, and a target bit rate mode for the audio signal is acquired from a plurality of bit rate modes; an encoding feature of the audio signal is extracted from the audio signal by using the target encoding mode; signal encoding is performed on the encoding feature of the audio signal by using the target bit rate mode, to obtain an audio bitstream of the audio signal; a frame header is determined based on the target encoding mode and the target bit rate mode; and an audio bitstream encapsulation of the audio signal is generated based on the audio bitstream and the frame header.

The client 410 may transmit the audio bitstream encapsulation to the server 210 through the network 300 so that the server 210 transmits the audio bitstream encapsulation to the terminal device 500 associated with a receiver (e.g., a participant of a web conference, an audience, or a receiver of a voice call).

After receiving the audio bitstream encapsulation transmitted by the server 210, a client 510 running on the terminal device 500 (e.g., an instant messaging client, a web conference client, a livestreaming client, or a browser) may perform audio decoding on the audio bitstream encapsulation to obtain a reconstructed audio signal, thereby achieving audio communication.

For example, the client 510 invokes the audio decoding method provided in some embodiments of the disclosure to decode a received audio bitstream encapsulation. A target encoding mode and a target bit rate mode are acquired from a frame header included in the audio bitstream encapsulation; where an audio bitstream included in the audio bitstream encapsulation is obtained by performing audio encoding on an audio signal by using the target encoding mode and the target bit rate mode, the target encoding mode is acquired from a plurality of encoding modes, and the target bit rate mode is acquired from a plurality of bit rate modes; signal decoding is performed on the audio bitstream by using the target encoding mode and the target bit rate mode, to obtain an estimated value of an encoding feature corresponding to the audio bitstream; and the estimated value of the encoding feature corresponding to the audio bitstream is reconstructed by using the target encoding mode, to obtain a reconstructed audio signal corresponding to the audio bitstream.

For example, the server 210 shown in FIG. 2 may be an independent physical server, may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal device 400 and the terminal device 500 shown in FIG. 2 may each be a smartphone, a tablet computer, a notebook computer, a desktop computer, a smart speaker, a smart watch, an in-vehicle terminal, or the like, but is not limited thereto. The terminal device (for example, the terminal device 400 and the terminal device 500) and the server 210 may be directly or indirectly connected in a wired or wireless communication manner, which is not limited in some embodiments of the disclosure.

In some embodiments, the terminal device or the server 210 may implement, by running a computer program, the audio encoding method or the audio decoding method provided in some embodiments of the disclosure. For example, the computer program may be a native program or a software module in an operating system, may be a native application (APP), e.g., a program such as a livestreaming APP, a web conference APP, or an instant messaging APP that needs to be installed in an operating system to run, may be a mini program, which may be run after being downloaded to a browser environment, or may be a mini program that can be embedded in any APP. In summary, the foregoing computer program may be an APP, a module, or a plug-in in any form.

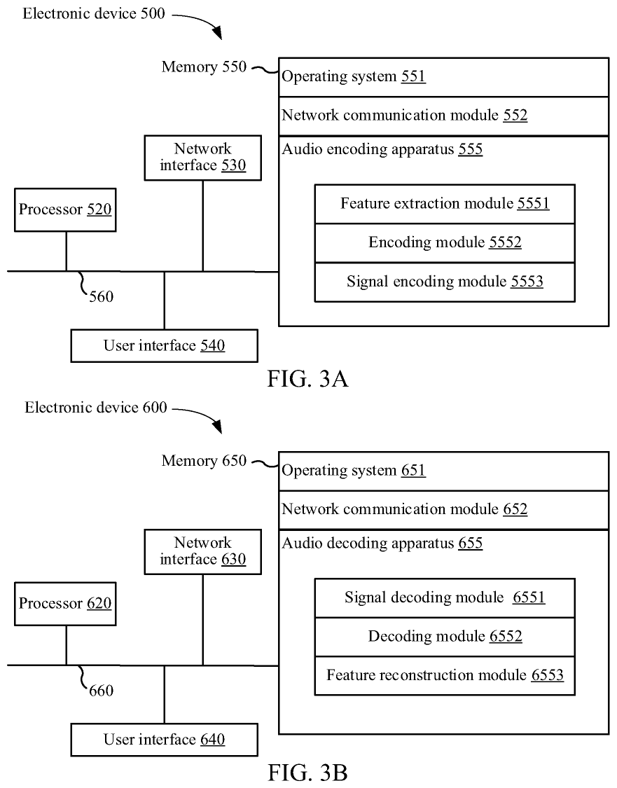

Referring to FIG. 3A, FIG. 3A is a schematic structural diagram of an electronic device 500 according to some embodiments of the disclosure. An example in which the electronic device 500 is a terminal device is used for description. The electronic device 500 shown in FIG. 3A includes: at least one processor 520, a memory 550, at least one network interface 530, and a user interface 540. Components in the electronic device 500 are coupled together through a bus system 560. The bus system 560 is configured to implement connection and communication between the components. In addition to a data bus, the bus system 560 further includes a power bus, a control bus, and a state signal bus. However, for clear description, various types of buses in FIG. 3A are marked as the bus system 560.

The processor 520 may be an integrated circuit chip having a signal processing capability, for example, a general-purpose processor, a digital signal processor (DSP), or another programmable logic device, discrete gate, transistor logical device, or discrete hardware component. The general-purpose processor may be a microprocessor, any conventional processor, or the like.

The memory 550 may be a removable memory, a non-removable memory, or a combination thereof. Exemplary hardware devices include a solid-state memory, a hard disk drive, a compact disc (CD) drive, and the like. The memory 550 alternatively includes one or more storage devices physically located away from the processor 520.

The memory 550 includes a volatile memory or a non-volatile memory, or may include both a volatile memory and a non-volatile memory. The non-volatile memory may be a read only memory (ROM), and the volatile memory may be a random access memory (RAM). The memory 550 described in some embodiments of the disclosure is intended to include any suitable type of memory.

In some embodiments, the memory 550 can store data to support various operations. Examples of the data include a program, a module, and a data structure, or a subset or a superset thereof, which are exemplarily described below.

An operating system 551 includes a system program configure for processing various basic system services and performing hardware-related tasks, for example, a framework layer, a kernel library layer, and a driver layer for implementing various basic services and process hardware-based tasks.

A network communication module 552 is configured to communicate with another computing device via one or more (wired or wireless) network interfaces 530. Illustratively, the network interface 530 includes: Bluetooth, wireless fidelity (WiFi), a universal serial bus (USB), and the like.

In some embodiments, an audio encoding apparatus provided in some embodiments of the disclosure may be implemented in a software manner. FIG. 3A shows an audio encoding apparatus 555 stored in the memory 550, which may be software in the form of a program, a plug-in, or the like, and includes the following software modules: a second acquisition module 5551, an extraction module 5552, a signal encoding module 5553, a construction module 5554, and a generation module 5555. The second acquisition module 5551, the extraction module 5552, the signal encoding module 5553, the construction module 5554, and the generation module 5555 are configured to implement an audio encoding function. These modules are logical, and therefore may be arbitrarily combined or further split according to the implemented function.

Referring to FIG. 3B, FIG. 3B is a schematic structural diagram of an electronic device 600 according to some embodiments of the disclosure. An example in which the electronic device 600 is a terminal device is used for description. The electronic device 600 shown in FIG. 3B includes: at least one processor 620, a memory 650, at least one network interface 630, and a user interface 640. Components in the electronic device 600 are coupled together through a bus system 660. The memory 650 includes an operating system 651 and a network communication module 652. A function of the structure in FIG. 3B is similar to that of the structure in FIG. 3A. An audio encoding apparatus provided in some embodiments of the disclosure may be implemented in a software manner. FIG. 3B shows an audio decoding apparatus 655 stored in the memory 650, which may be software in the form of a program, a plug-in, or the like, and includes the following software modules: a first acquisition module 6551, a signal decoding module 6552, and a reconstruction module 6553. The first acquisition module 6551, the signal decoding module 6552, and the reconstruction module 6553 are configured to implement an audio decoding function. These modules are logical, and therefore may be arbitrarily combined or further split according to the implemented function.

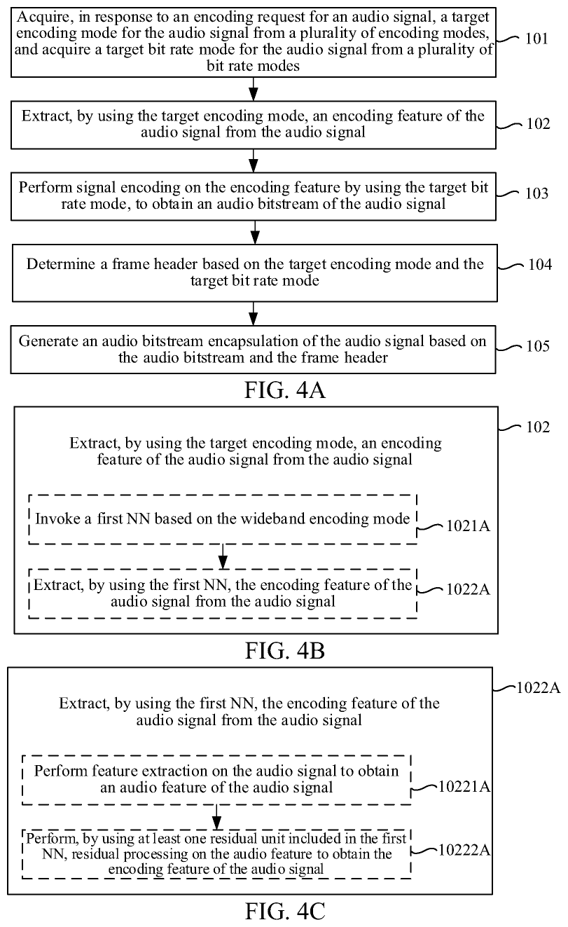

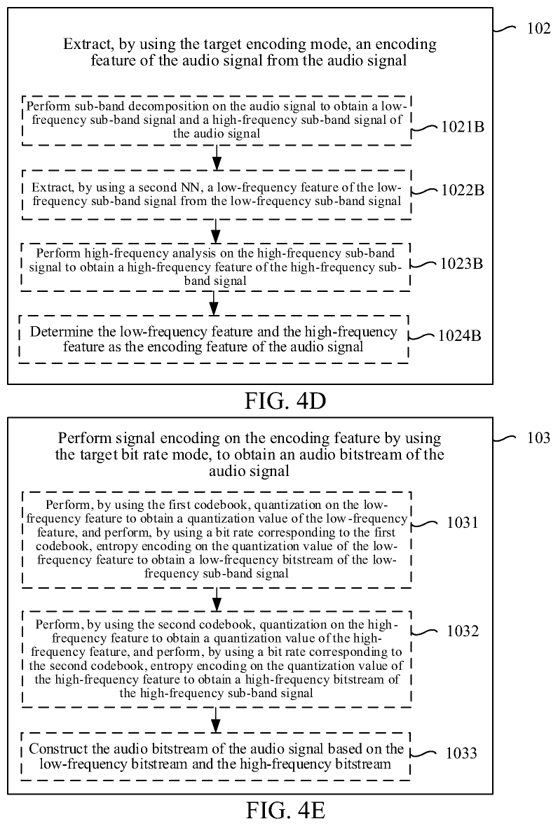

As described above, the audio encoding method provided in some embodiments of the disclosure may be implemented by various types of electronic devices. Referring to FIG. 4A, FIG. 4A is a schematic flowchart of an audio encoding method according to some embodiments of the disclosure. An audio encoding function is implemented through the audio encoding method. Descriptions are provided below with reference to operation 101 to operation 105 shown in FIG. 4A.

Before the following operations are described, the audio encoding method provided in this embodiment of the disclosure is explained. The audio encoding method provided in this embodiment of the disclosure includes two encoding methods (e.g., a signal encoding method in the signal processing technology and feature encoding (or feature extraction) in the artificial intelligence technology). For details of the feature encoding in the artificial intelligence technology, refer to operation 102 below, and for details of the signal encoding method in the signal processing technology, refer to operation 103 below. In the following embodiments, operations may be performed sequentially, in a different order, in parallel, or with some operations skipped or repeated.

Operation 101: Acquire, in response to an encoding request for an audio signal, a target encoding mode for the audio signal from a plurality of encoding modes, and acquire a target bit rate mode for the audio signal from a plurality of bit rate modes.

The encoding request is configured for indicating performing audio encoding on the audio signal. The encoding request includes encoding configuration information, such as a sampling rate of the audio signal and a type of the audio signal (e.g., a wideband signal or an ultra-wideband signal). The plurality of encoding modes include a wideband encoding mode and an ultra-wideband encoding mode. The wideband encoding mode is configured for indicating performing wideband encoding on the audio signal, which indicates that the audio signal is a wideband signal. Compared with an ultra-wideband signal, a sampling rate of the wideband signal is low, and sub-band decomposition does not need to be performed on the audio signal. The ultra-wideband encoding mode is configured for indicating performing ultra-wideband encoding on the audio signal, which indicates that the audio signal is an ultra-wideband signal. Compared with a wideband signal, a sampling rate of the ultra-wideband signal is high. Sub-band decomposition may be performed on the audio signal, and then a sub-band signal obtained through decomposition is encoded. The bit rate mode is configured for indicating using a specified codebook and a corresponding bit rate to perform signal encoding or signal decoding. Different bit rate modes correspond to different codebooks and bit rates. In a configuration stage, different encoding modes and bit rate modes may be configured for different audio signals.

As an example of acquiring the audio signal, an encoder side, in response to an audio acquisition instruction triggered by a sender (for example, an initiator of a web conference, a host, or an initiator of a voice call), invokes a microphone provided in a terminal device of the encoder side to acquire an audio signal to obtain the audio signal (alternatively referred to as an input signal).

As an example of acquiring the encoding request for the audio signal, the encoder side selects, in response to a selection operation of the sender on a plurality of encoding models, a target encoding mode for the audio signal from a plurality of encoding modes, or selects, in response to a selection operation of the sender on a plurality of bit rate modes, a target bit rate mode for the audio signal from a plurality of bit rate modes, and generates the encoding request for the audio signal based on the target encoding mode and the target bit rate mode, so that different encoding modes and bit rate modes may be configured for different audio signals according to user requirements.

As another example of acquiring the encoding request for the audio signal, the encoder side may pre-store a configuration table. Correspondence between different configuration information and different encoding modes and correspondence between different configuration information and different bit rate modes are stored in the configuration table. After acquiring the audio signal, the encoder side generates the encoding request for the audio signal based on configuration information of the audio signal, to facilitate subsequent acquisition of the configuration information of the audio signal from the encoding request, queries the configuration table based on the configuration information, determines a found encoding mode corresponding to the configuration information of the audio signal as the target encoding mode, and determines a found bit rate mode corresponding to the configuration information of the audio signal as the target bit rate mode.

Operation 102: Extract, by using the target encoding mode, an encoding feature of the audio signal from the audio signal.

For example, when the target encoding mode is a wideband encoding mode, the encoding feature of the audio signal is extracted from the audio signal based on the wideband encoding mode. When the target encoding mode is an ultra-wideband encoding mode, the encoding feature of the audio signal is extracted from the audio signal based on the ultra-wideband encoding mode.

As shown in FIG. 4B, FIG. 4B is a schematic flowchart of an audio encoding method according to some embodiments of the disclosure. When the target encoding mode is a wideband encoding mode, FIG. 4B shows that operation 102 shown in FIG. 4A may be implemented by using operation 1021A to operation 1022A. Operation 1021A: Invoke a first NN based on the wideband encoding mode. Operation 1022A: Extract, by using the first NN, the encoding feature of the audio signal from the audio signal.

Herein, when the target encoding mode is the wideband encoding mode, it indicates that the audio signal is a wideband signal (a low-frequency signal), and the encoding feature of the audio signal may be directly extracted by using the artificial intelligence technology, so as to subsequently generate a corresponding audio bitstream based on the encoding feature of the audio signal. This embodiment of the disclosure is not limited to the structure of the first NN. The first NN may be a convolutional NN, a deep NN, or the like.

As shown in FIG. 4C, FIG. 4C is a schematic flowchart of an audio encoding method according to some embodiments of the disclosure. FIG. 4C shows that operation 1022A shown in FIG. 4B may be implemented by using operation 10221A and operation 10222A.

Operation 10221A: Perform feature extraction on the audio signal to obtain an audio feature of the audio signal.

Herein, in this embodiment of the disclosure, the first NN may be invoked based on the audio signal, and the audio feature is extracted from the audio signal by using the first NN, so as to subsequently continue to perform feature extraction based on the audio feature. This embodiment of the disclosure is not limited to the structure of the first NN. The first NN may be a convolutional NN, a deep NN, or the like.

Operation 10222A: Perform, by using at least one residual unit included in the first NN, residual processing on the audio feature to obtain the encoding feature of the audio signal.

Herein, the first NN includes 4 encoding blocks, and each encoding block includes 4 or 5 residual units.

In an NN model, the residual unit refers to a special structure and is configured to construct residual networks (ResNets). The residual unit aims to solve problems of gradient vanishing and gradient exploding during training of the deep NN, and help the network better learn features. A skip connection is introduced into the residual unit, where an input is directly added to an output, instead of simply transferring layer by layer. This skip connection enables the network to learn a residual function (e.g., learn a difference between the input and the output), instead of directly learning a mapping relationship. This design makes the network easier to be optimized, and helps alleviate the problem of gradient vanishing.

Herein, residual processing at an encoding side is performed on the audio feature. Based on characteristics of the residual processing, it is ensured that shallow feature information of the audio feature can be better utilized while comprehensively learning the audio feature, thereby avoiding omission of the shallow feature information of the audio feature.

Based on the characteristics of the residual unit, the residual processing in operation 10222A is configured for calculating a residual of the audio feature at the encoding side and determining the residual of the audio feature as the encoding feature to perform subsequent signal encoding. For example, the residual of the audio feature is obtained by adding the audio feature to the output of the residual unit. The audio feature is used as the input of the residual unit. After the audio feature is processed by the residual unit, the output of the residual unit is obtained. In addition, the input of the residual unit and the output of the residual unit are added by using the characteristics of the skip connection of the residual unit, to obtain the residual of the audio feature.

As shown in FIG. 4D, FIG. 4D is a schematic flowchart of an audio encoding method according to some embodiments of the disclosure. When the target encoding mode is an ultra-wideband encoding mode, FIG. 4D shows that operation 102 shown in FIG. 4A may be implemented by using operation 1021B to operation 1024B.

Operation 1021B: Perform sub-band decomposition on the audio signal to obtain a low-frequency sub-band signal and a high-frequency sub-band signal of the audio signal.

Herein, when the target encoding mode is the ultra-wideband encoding mode, it indicates that the audio signal is an ultra-wideband signal, and sub-band decomposition may be performed on the ultra-wideband signal to obtain the low-frequency sub-band signal and the high-frequency sub-band signal of the audio signal.

In this embodiment of the disclosure, bands of the low-frequency sub-band signal and the high-frequency sub-band signal are not limited. The low-frequency sub-band signal and the high-frequency sub-band signal obtained through decomposition may be two sub-band signals obtained by evenly splitting a band of the audio signal, or may be two sub-band signals obtained by unevenly splitting the band of the audio signal. For example, if an effective bandwidth of an audio signal x(n) is 0 to 16 kHz, effective bandwidths of a low-frequency sub-band signal x_{LB}(n) and a high-frequency sub-band signal x_{HB}(n) are 0 to 8 kHz and 8 to 16 kHz, respectively, or the effective bandwidths of the low-frequency sub-band signal x_{LB}(n) and the high-frequency sub-band signal x_{HB}(n) may be 0 to 6 kHz and 6 to 16 kHz, respectively. In addition, a quantity of bands to be split is not limited in this embodiment of the disclosure. Two sub-band signals may be obtained through even/uneven splitting, or more than two sub-band signals may be obtained by evenly/unevenly splitting the band of the audio signal, for example, 3, 4, or more sub-band signals.

The audio signal includes a low-frequency part and a high-frequency part. A low-frequency signal (e.g., the low-frequency sub-band signal) is the low-frequency part of the audio signal separated from an audio signal with a specific sampling rate by using a filter based on the characteristics of the audio signal. The high-frequency signal (e.g., the high-frequency sub-band signal) is the high-frequency part of the audio signal separated from the audio signal with a specific sampling rate. For example, if the effective bandwidth of the audio signal x(n) is 0 to 16 kHz, the effective bandwidth of the low-frequency signal is 0 to 8 kHz, and the effective bandwidth of the high-frequency signal x_{HB}(n) may be 6 to 16 kHz. In addition, band division of the audio signal is not limited in this embodiment of the disclosure. For example, the audio signal may be evenly or non-evenly divided to obtain a uniform low-frequency signal and a uniform high-frequency signal.

As an example of sub-band decomposition, the audio signal is decomposed into the low-frequency sub-band signal x_{LB}(n) and the high-frequency sub-band signal x_{HB}(n) by using a QMF analysis filter. Since the low-frequency sub-band signal has a greater impact on audio encoding than the high-frequency sub-band signal, differential signal processing may be subsequently performed on the low-frequency sub-band signal and the high-frequency sub-band signal.

In some embodiments, operation 1021B may be implemented in the following manner: sampling the audio signal to obtain a sampled signal, the sampled signal including a plurality of sample points obtained through sampling; performing low-pass filtering on the sampled signal to obtain a low-pass filtered signal; downsampling the low-pass filtered signal to obtain the low-frequency sub-band signal of the audio signal; performing high-pass filtering on the sampled signal to obtain a high-pass filtered signal; and downsampling the high-pass filtered signal to obtain the high-frequency sub-band signal of the audio signal.

Herein, the audio signal is a continuous analog signal, the sampled signal is a discrete digital signal, and the sampling points are sampling values obtained by sampling the audio signal.

In the field of digital signal processing, downsampling is configured for reducing the sampling rate of the audio signal to reduce a data volume, reduce system complexity, or adapt to specific application requirements. A downsampling factor of the downsampling may be a multiple of 2, for example, 2, 4, or 8.

As an example, an example in which the audio signal is an input signal with a sampling rate Fs=32000 Hz is used. The audio signal is sampled to obtain a sampled signal x(n) including 640 sample points. An analysis filter (2 channels) in the QMF bank is invoked to perform low-pass filtering on the sampled signal to obtain a low-pass filtered signal, perform high-pass filtering on the sampled signal to obtain a high-pass filtered signal, downsample the low-pass filtered signal to obtain the low-frequency sub-band signal x_{LB}(n) of the audio signal, and downsample the high-pass filtered signal to obtain the high-frequency sub-band signal x_{HB}(n) of the audio signal. Effective bandwidths of the low-frequency sub-band signal x_{LB}(n) and the high-frequency sub-band signal x_{HB}(n) are 0 to 8 kHz and 8 to 16 kHz, respectively, and a quantity of sample points of the low-frequency sub-band signal x_{LB}(n) and the high-frequency sub-band signal x_{HB}(n) is 320.

The QMF bank is an analysis-synthesis filter pair. For the QMF analysis filter, an input signal with a sampling rate Fs may be decomposed into two signals with a sampling rate Fs/2, representing a QMF low-pass signal and a QMF high-pass signal, respectively. The low-pass signal and the high-pass signal recovered by the decoder side are synthesized by using the QMF synthesis filter, so that a reconstructed signal with a sampling rate Fs corresponding to the input signal may be recovered.

In this embodiment of the disclosure, in the field of digital signal processing, the audio signal is first filtered by using a filter (such as a low-frequency filter or a high-pass filter), to remove a high-frequency component and aliasing interference from the audio signal to ensure that the downsampled audio signal may not lose necessary information. Then, in the filtered audio signal, a sampling point is reserved at regular intervals through downsampling, thereby reducing the sampling rate of the audio signal.

Operation 1022B: Extract, by using a second NN, a low-frequency feature of the low-frequency sub-band signal from the low-frequency sub-band signal.

Operation 1022B is similar to operation 10221A, and a difference lies in that the processing object in operation 10221A is the audio signal, while the processing object in operation 1022B is the low-frequency sub-band signal. The structure of the first NN is similar to that of the second NN. For example, the second NN is the same as the first NN. The second NN includes 4 encoding blocks, and each encoding block includes 4 or 5 residual units.

In some embodiments, operation 1022B may be implemented by using operation 10221B to operation 10222B.

Operation 10221B: Perform feature extraction on the low-frequency sub-band signal to obtain a low-frequency feature of the low-frequency sub-band signal.

Herein, in this embodiment of the disclosure, the second NN may be invoked based on the low-frequency sub-band signal, and the low-frequency feature is extracted from the low-frequency sub-band signal by using the second NN, to facilitate subsequent continuous feature extraction based on an important low-frequency feature. This embodiment of the disclosure is not limited to the structure of the second NN. The second NN may be a CNN, a deep NN, or the like.

In some embodiments, operation 1022B may be implemented in the following manner: performing, by using the second NN, causal convolution on the low-frequency sub-band signal of the audio signal to obtain a causal convolution feature; and performing pooling on the causal convolution feature to obtain a low-frequency encoding feature of the low-frequency sub-band signal.

In the field of audio encoding and decoding, operations such as causal convolution and pooling of the NN play important roles and are configured for processing an audio signal and extracting a feature from the audio signal. During audio encoding and decoding, a causal convolution operation may be configured for extracting a local feature from the audio signal. A convolution operation may be performed in a time dimension of the audio signal by applying a convolution kernel (a learnable filter), to capture a mode and resonance in the signal. Through causal convolution, time domain and frequency domain features may be extracted from the audio signal for tasks such as denoising, feature extraction, and signal separation. The pooling operation is configured for reducing the time dimension of the audio signal, thereby reducing data complexity and a calculation amount. In the pooling operation, a local region of an input signal may be sampled, and information of the region, such as a maximum value or an average value, is summarized, thereby generating a more compact feature representation. In the audio signal, the pooling operation may help to improve robustness and a generalization capability of the network and reduce a risk of overfitting. In the field of audio encoding and decoding, operations such as convolution and pooling may implement tasks such as feature extraction, encoding, and decoding of the audio signal by constructing an appropriate NN structure. These operations help to improve efficiency and quality of audio signal processing, and extend an application range of the audio encoding and decoding technology in fields such as audio processing, voice recognition, and music generation.

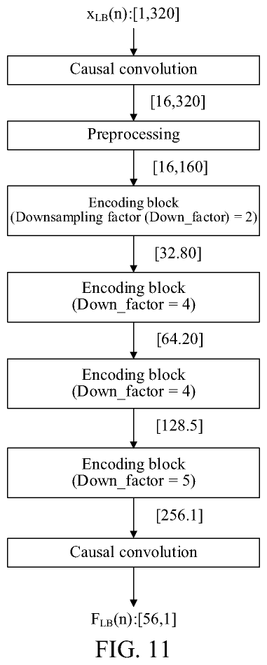

For example, referring to a network structure diagram of the second NN shown in FIG. 11, the second NN includes a causal convolution layer and a preprocessing layer. First, a 16-channel causal convolution layer is invoked, and an input tensor (e.g., the low-frequency sub-band signal) may be extended into a 16×320 causal convolution feature. Then, the 16×320 causal convolution feature is preprocessed by using the preprocessing layer. For example, after a convolution operation is performed on the 16×320 causal convolution feature, pooling with a factor of 2 is performed, and an activation function may be a parametric rectified linear unit (PReLU) to generate a 16×160 tensor (e.g., the low-frequency encoding feature).

Operation 10222B: Perform, by using at least one residual unit included in the second NN, residual processing on the low-frequency encoding feature to obtain the low-frequency feature of the low-frequency sub-band signal.

Herein, residual processing is performed on the low-frequency encoding feature of the low-frequency sub-band signal. Based on the characteristics of the residual processing, it is ensured that shallow feature information of the low-frequency encoding feature can be better utilized while comprehensively learning the low-frequency encoding feature, thereby avoiding omission of the shallow feature information of the low-frequency encoding feature.

In some embodiments, operation 10222B may be implemented by using operation 102221B to operation 102222B.

Operation 102221B: Perform, by using the at least one residual unit included in the second NN, feature residual processing on the low-frequency feature to obtain a residual feature of the low-frequency sub-band signal.

The feature residual processing in operation 102221B is configured for calculating a residual of the low-frequency feature and determining the residual of the low-frequency feature as the residual feature of the low-frequency sub-band signal to facilitate subsequent feature encoding.

In some embodiments, when the at least one residual unit includes one residual unit, operation 102221B may be implemented in the following manner: performing, by using one residual unit, single residual processing on the low-frequency feature to obtain the residual feature of the low-frequency sub-band signal. The single residual processing of one residual unit is configured for calculating a residual corresponding to the low-frequency sub-band signal at the encoding side.

In some embodiments, when the at least one residual unit includes a plurality of cascaded residual units, operation 102221B may be implemented in the following manner: performing single residual processing on the low-frequency encoding feature by using a first residual unit of the plurality of cascaded residual units, where the single residual processing of the first residual unit is configured for calculating a residual of the low-frequency encoding feature and determining the residual of the low-frequency encoding feature as a residual result of the first residual unit; outputting the residual result outputted by the first residual unit to a subsequent cascaded residual unit, and continuing to perform single residual processing by using the subsequent cascaded residual unit and output a residual result, where the single residual processing of the subsequent cascaded residual unit is configured for calculating a residual of the residual result inputted to the subsequent cascaded residual unit; and using a residual result outputted by a last residual unit as the residual feature of the low-frequency sub-band signal.

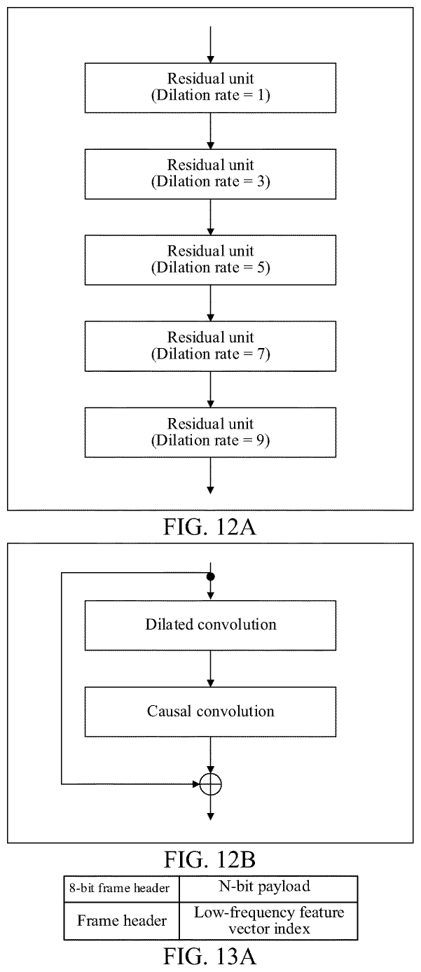

For example, the second NN includes 4 encoding blocks, and each encoding block includes 4 or 5 residual units. As shown in FIG. 12A, when the at least one residual unit configured for feature residual processing includes 5 cascaded residual units, a first residual unit performs single residual processing on the low-frequency encoding feature and outputs a residual result outputted by the first residual unit to a second residual unit. The second residual unit performs single residual processing on the residual result outputted by the first residual unit and outputs a residual result outputted by the second residual unit to a third residual unit. The third residual unit performs single residual processing on the residual result outputted by the second residual unit and outputs a residual result outputted by the third residual unit to a fourth residual unit. The fourth residual unit performs single residual processing on the residual result outputted by the third residual unit and outputs a residual result outputted by the fourth residual unit to a fifth residual unit. The fifth residual unit performs single residual processing on the residual result outputted by the fourth residual unit, to obtain the residual feature of the low-frequency sub-band signal.

The quantity of the encoding blocks is not limited in some embodiments of the disclosure, which may be any positive integer such as 2, 3, 4, or 5. In some embodiments of the disclosure, a quantity of residual units in an encoding block is not limited, which may be any positive integer such as 2, 3, 4, 5, or 6, and quantities of residual units in a plurality of encoding blocks may be the same or may be different. For example, one encoding block includes 4 residual units, and another encoding block includes 5 residual units.

In some embodiments, a processing process of the residual unit is as follows: performing the following processing through a k^{th} residual unit of the plurality of cascaded residual units: convolving an input of the k^{th} residual unit to obtain a convolution result of the k^{th} residual unit; and adding the convolution result of the k^{th} residual unit to an input of the k^{th} residual unit to obtain a residual result outputted by the k^{th} residual unit, where k is a sequentially increasing positive integer, 1≤k≤J, and J is a quantity of residual units; when k is 1, the input of the k^{th} residual unit is a low-frequency encoding feature, and when k is not 1, the input of the k^{th} residual unit is a residual feature, e.g., a residual result outputted by a (k−1)^{th} residual unit.

Following the foregoing embodiment, each residual unit includes a dilated convolution operator; and the convolving an input of the k^{th} residual unit to obtain a convolution result of the k^{th} residual unit may be implemented in the following manner: performing the following processing by using the k^{th} residual unit of the plurality of cascaded residual units: performing dilated convolution on the input of the k^{th} residual unit to obtain the convolution result of the k^{th} residual unit. Dilated convolution is performed on the low-frequency encoding feature by using a dilated convolution operator included in the first residual unit, to obtain a dilated convolution result of the first residual unit. The following processing is performed by using a j^{th} residual unit of the plurality of cascaded residual units: performing, by using a dilated convolution operator included in the j^{th} residual unit, dilated convolution on a residual result outputted by a (j−1)^{th} residual unit to obtain a dilated convolution result of the j^{th} residual unit, where j is a sequentially increasing positive integer, 1<j≤J, and J is a quantity of residual units. Each residual unit includes a dilated convolution operator of a specified dilation rate. A dilated convolution operator of progressive dilation rates is used, which is equivalent to extracting features of an input at different resolution by using different receptive fields, so that data can be better analyzed comprehensively. After being convolved through a dilated convolution operator of a dilation rate, each residual unit is added to a shallow feature (e.g., an input of each residual unit) obtained through skip connection, thereby directly using shallow feature information. Thus, the network may make full use of the shallow feature information in a learning process.

Following the foregoing embodiment, each residual unit not only includes the dilated convolution operator, but also includes at least one causal convolution operator. After the input of the k^{th} residual unit is convolved to obtain the convolution result of the k^{th} residual unit, causal convolution is performed on an obtained dilated convolution result by using at least one causal convolution operator included in the k^{th} residual unit, and an obtained causal convolution result is used as the convolution result of the k^{th} residual unit. Causal convolution is performed on the dilated convolution result of the first residual unit by using at least one causal convolution operator included in the first residual unit, and an obtained causal convolution result is used as a convolution result outputted by the first residual unit. After dilated convolution is performed on the residual result outputted by the (j−1)^{th} residual unit by using the dilated convolution operator included in the j^{th} residual unit, to obtain the dilated convolution result of the j^{th} residual unit, causal convolution is performed on the dilated convolution result of the j^{th} residual unit by using at least one causal convolution operator included in the j^{th} residual unit, and a causal convolution result of the j^{th} residual unit is used as the convolution result of the j^{th} residual unit. Each residual unit further includes at least one causal convolution operator, and local information of features inputted to the causal convolution operator continues to be extracted by using the causal convolution operator.

In the neural NN, causal convolution is a special type when time sequence data (the audio signal is a type of time sequence data) is processed, which may ensure that an output of the NN depends on only a current time step and a previous time step, thereby maintaining a causal relationship over time. In actual application, for the causal convolution, a size of a convolution kernel may be adjusted to ensure that the convolution kernel may not span a region before the current time step. In this way, a long-term dependency relationship in a time sequence may be effectively captured, and the problem of gradient vanishing or exploding caused by confusion of future information may be avoided. The causal convolution is especially important in fields such as natural language processing, voice recognition, and time sequence prediction. The causal convolution follows the time sequence of data so that confusion of past information is avoided, and long-time sequence data can be effectively processed and predicted. In tasks such as voice recognition and time sequence prediction, the causal convolution exhibits good performance due to characteristics of keeping a time sequence.

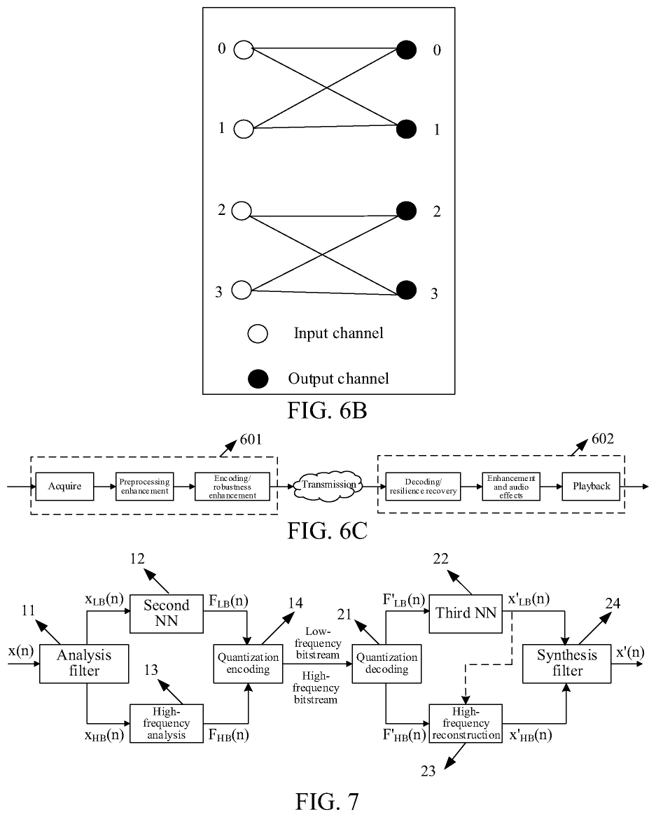

In some embodiments, group convolution may be applied to convolution operators (including the dilated convolution operator and the causal convolution operator) of the residual unit. The group convolution is to divide the input channels into a plurality of groups to perform a convolution operation, and only the input channels and the output channels in each group are associated. After the input channels are divided into a plurality of groups, the corresponding output channels may also be divided into a plurality of groups. For example, a quantity of groups of the input channels is the same as a quantity of groups of the output channels, so that after convolution is performed in a group, only the input channels and the output channels in each group are associated. Herein, it is assumed that the feature inputted to a convolution operator has 4 input channels and 4 output channels. If the quantity of groups is 1, each input channel is associated with 4 output channels. If the quantity of groups is 2, the 4 input channels are first divided into two groups 0-1 and 2-3. In each of the two groups, the input channel is associated with the output channel in this group. For example, input channels 0-1 in a first group are associated with output channels 0-1, and input channels 2-3 in a second group are associated with output channels 2-3. As shown in FIG. 6A, when the group convolution solution is not used, each input channel is associated with 4 output channels. As shown in FIG. 6B, when the group convolution solution is not used, the output channel 0 is only associated with the input channels 0-1 and is not associated with the input channels 2-3, and the output channel 2 is only associated with the input channels 2-3 and is not associated with the input channels 0-1. As can be seen from such a comparison, the introduction of group convolution may prevent association of any input channel with all output channels and reduce a quantity of connections, thereby reducing the complexity.

For example, when group convolution is applied to the dilated convolution operator included in the residual unit, performing dilated convolution on the low-frequency encoding feature may be implemented in the following manner: grouping input channels of the low-frequency encoding feature to obtain a plurality of groups, where each group includes first elements corresponding to at least two channels in the low-frequency encoding feature; and performing dilated convolution on the first elements in each group. When group convolution is applied to the causal convolution operator included in the residual unit, performing causal convolution on the obtained dilated convolution result may be implemented in the following manner: grouping input channels of the dilated convolution result to obtain a plurality of groups, where each group includes second elements corresponding to at least two channels in the dilated convolution result; and performing causal convolution on the second elements in each group.

For example, group convolution may be applied to convolution operators (including the dilated convolution operator and the causal convolution operator) of the residual unit. The group convolution is to divide the input channels into a plurality of groups to perform a convolution operation, and only the input channels and the output channels in each group are associated. After the input channels are divided into a plurality of groups, the corresponding output channels may also be divided into a plurality of groups. For example, a quantity of groups of the input channels is the same as a quantity of groups of the output channels, so that after convolution is performed in a group, only the input channels and the output channels in each group are associated. Herein, it is assumed that the feature inputted to a convolution operator has 4 input channels and 4 output channels. If the quantity of groups is 1, each input channel is associated with 4 output channels. If the quantity of groups is 2, the 4 input channels are first divided into two groups 0-1 and 2-3. In each of the two groups, the input channel is associated with the output channel in this group. For example, input channels 0-1 in a first group are associated with output channels 0-1, and input channels 2-3 in a second group are associated with output channels 2-3. As shown in FIG. 6A, when the group convolution solution is not used, each input channel is associated with 4 output channels. As shown in FIG. 6B, when the group convolution solution is not used, the output channel 0 is only associated with the input channels 0-1 and is not associated with the input channels 2-3, and the output channel 2 is only associated with the input channels 2-3 and is not associated with the input channels 0-1. As can be seen from such a comparison, the introduction of group convolution may prevent association of any input channel with all output channels and reduce a quantity of connections, thereby reducing the complexity.

Following operation 102221B, in operation 102222B, feature encoding is performed on the residual feature to obtain the low-frequency feature of the low-frequency sub-band signal.

Herein, feature encoding is performed on the residual feature to obtain the low-frequency feature of the low-frequency sub-band signal to subsequently perform signal encoding based on the low-frequency feature to obtain a low-frequency bitstream of the audio signal.

In some embodiments, operation 102222B may be implemented in the following manner: convolving the residual feature to obtain a convolution feature, where a quantity of channels of the convolution feature is greater than a quantity of channels of the residual feature; and performing pooling on the convolution feature to obtain the low-frequency feature of the low-frequency sub-band signal.

For example, the second NN is invoked based on the low-frequency sub-band signal, and after processing by the residual unit in the second NN, the residual feature is obtained. Then, the residual feature is convolved by using a convolution layer in the second NN, to increase the quantity of channels of the residual feature. Finally, pooling is performed on the convolution feature by using a pooling layer in the second NN, to obtain the low-frequency feature of the low-frequency sub-band signal. Certainly, the second NN may further include a causal convolution layer. The causal convolution layer performs causal convolution on the low-frequency feature to obtain a low-frequency feature obtained after the causal convolution, and performs signal encoding on the low-frequency feature of the low-frequency sub-band signal obtained after the causal convolution, to obtain the low-frequency bitstream of the audio signal.

For example, as shown in FIG. 11, after the second NN is invoked based on the low-frequency sub-band signal, a low-frequency encoding feature (a 16×160 tensor obtained after preprocessing in FIG. 11) is obtained by using the second NN, and the second NN includes 4 cascaded encoding blocks having different downsampling factors (Down_factor). Each encoding block includes a residual block (including at least one residual unit), a convolution layer, and a pooling layer. Each residual block includes 5 dilated convolution-based residual units (feature dimensions of the input and output of the residual unit may not change). The convolution layer is configured to double the quantity of input channels, and an activation function may be a PReLU, thereby ensuring the data volume and avoiding data loss. The pooling layer is a pooling operation including Down_factor to complete downsampling and implement data compression. Herein, Down_factors of the 4 encoding blocks are respectively set to 2, 4, 4, and 5. Therefore, quantities of output channels of the 4 encoding blocks are respectively set to 32, 64, 128, and 256. After being processed by the 4 encoding blocks, an input 16×160 tensor is converted into 32×80, 64×20, 128×5, and 256×1 tensors. For example, residual processing is performed on the low-frequency encoding feature (e.g., the 16×160 tensor) by using a residual block in the first encoding block, and a residual result outputted by the residual block in the first encoding block is outputted to a feature encoding block in the first encoding block. After the residual result is processed by using the feature encoding block (including a convolution layer and a pooling layer) in the first encoding block, an encoding result (e.g., a 32×80 tensor) of the feature encoding block in the first encoding block is obtained, and the encoding result (e.g., the 32×80 tensor) of the feature encoding block in the first encoding block is outputted to a second encoding block. Residual processing is performed on the encoding result (e.g., the 32×80 tensor) of the feature encoding block in the first encoding block by using a residual block in the second encoding block, and a residual result outputted by the residual block in the second encoding block is outputted to a feature encoding block in the second encoding block. After the residual result is processed by using the feature encoding block (including a convolution layer and a pooling layer) in the second encoding block, an encoding result (e.g., a 64×20 tensor) of the feature encoding block in the second encoding block is obtained, and the encoding result (e.g., the 64×20 tensor) of the feature encoding block in the first encoding block is outputted to a third encoding block. The foregoing processing is sequentially performed, and an output of the last encoding block is used as the low-frequency feature. The quantity of the encoding blocks is not limited in this embodiment of the disclosure, which may be any positive integer such as 2, 3, 4, or 5.

Operation 1023B: Perform high-frequency analysis on the high-frequency sub-band signal to obtain a high-frequency feature of the high-frequency sub-band signal.

Since the low-frequency sub-band signal has a greater impact on audio encoding than the high-frequency sub-band signal, differential signal processing is performed on the low-frequency sub-band signal and the high-frequency sub-band signal so that a feature dimension of a high-frequency feature is lower than a feature dimension of a low-frequency feature. For example, the feature dimension of the low-frequency feature is 56, and the feature dimension of the high-frequency feature is 8. The high-frequency analysis is configured for performing dimension reduction on the high-frequency sub-band signal to implement a function of data compression. The high-frequency encoding feature is a feature characterizing the high-frequency sub-band signal, and a feature dimension of the high-frequency encoding feature is smaller than a feature dimension of the high-frequency sub-band signal.

In some embodiments, a fifth NN may be invoked to extract a high-frequency feature of the high-frequency sub-band signal from the high-frequency sub-band signal. A structure of the fifth NN is similar to that of the second NN. A dimension of the high-frequency feature is smaller than a dimension of the low-frequency feature.

In some embodiments, the performing high-frequency analysis on the high-frequency sub-band signal to obtain a high-frequency feature of the high-frequency sub-band signal may be implemented in the following manner: performing framing on the high-frequency sub-band signal to obtain a plurality of sub-frames of the high-frequency sub-band signal; performing bandwidth extension processing on each of the sub-frames to obtain a sub-band spectral envelope of the sub-frame; and using the sub-band spectral envelopes respectively corresponding to the plurality of sub-frames as the high-frequency feature of the high-frequency sub-band signal. A quantity of the plurality of sub-frames may be 2, 4, 6, or the like. This embodiment of the disclosure is not limited to the quantity of the sub-frames.

Herein, relative to the low-frequency sub-band signal, the high-frequency sub-band signal is less important for quality. Therefore, the high-frequency sub-band signal may be compressed with another method, e.g., bandwidth extension (recovering a wideband voice signal from a band-limited narrowband voice signal), to rapidly compress the high-frequency sub-band signal and extract the high-frequency feature of the high-frequency sub-band signal.

In some embodiments, the performing bandwidth extension processing on each of the sub-frames to obtain a sub-band spectral envelope of the sub-frame may be implemented in the following manner: performing frequency domain transform based on a plurality of sample points included in the sub-frame to obtain transform coefficients respectively corresponding to the plurality of sample points; dividing the transform coefficients respectively corresponding to the plurality of sample points into a plurality of sub-bands; and averaging the transform coefficients included in each of the sub-bands to obtain average energy corresponding to the sub-band, and using the average energy as a sub-band spectral envelope corresponding to the sub-band.

A frequency domain transform method in this embodiment of the disclosure includes modified discrete cosine transform (MDCT), discrete cosine transform (DCT), fast Fourier transform (FFT), and the like. This embodiment of the disclosure is not limited to the frequency domain transform mode. The averaging in this embodiment of the disclosure includes arithmetic averaging and geometric averaging. The averaging mode is not limited in this embodiment of the disclosure.

In some embodiments, the performing frequency domain transform based on a plurality of sample points included in the sub-frame to obtain transform coefficients respectively corresponding to the plurality of sample points may be implemented in the following manner: performing the following processing on each sub-frame: acquiring a neighboring sub-frame of the sub-frame; and performing, based on the plurality of sample points included in the neighboring sub-frame and the plurality of sample points included in the sub-frame, discrete cosine transform on the plurality of sample points included in the sub-frame, to obtain the transform coefficients respectively corresponding to the plurality of sample points included in the sub-frame.

As an example, for a high-frequency sub-band signal x_{HB}(n) including 320 points, the high-frequency sub-band signal x_{HB}(n) including 320 points is divided into two sub-frames (a first sub-frame and a second sub-frame). Each sub-frame includes 160 points. For any sub-frame (e.g., the high-frequency sub-band signal including 160 points), MDCT is invoked, to generate an MDCT coefficient of 160 points (e.g., transform coefficients respectively corresponding to the plurality of sample points included in the sub-frame). Specifically, if the overlap is 50%, a first sub-frame of an (n+1)^{th} frame and a second sub-frame of an n^{th} frame may be combined (spliced), MDCT of 320 points is calculated, and MDCT coefficients of 160 points of the first sub-frame of the (n+1)^{th} frame are obtained. The second sub-frame of an (n+1)^{th} frame is combined with the first sub-frame of the (n+1)^{th} frame, MDCT of 320 points is calculated, and MDCT coefficients of 160 points of the second sub-frame of the (n+1)^{th} frame are obtained.

In some embodiments, a process of performing geometric averaging on the transform coefficients included in each sub-band is as follows: determining a quadratic sum of transform coefficients corresponding to sample points included in each sub-band; and determining a ratio of the quadratic sum to a quantity of sample points included in the sub-band as the average energy corresponding to each sub-band.

Following operation 1023B, in operation 1024B, the low-frequency feature and the high-frequency feature are determined as the encoding feature of the audio signal.

Following operation 102, in operation 103, signal encoding is performed on the encoding feature by using the target bit rate mode, to obtain an audio bitstream of the audio signal.

Herein, a bit rate mode is configured for performing signal encoding by using a specified codebook and a corresponding bit rate. Therefore, signal encoding is performed on the encoding feature of the audio signal by using a codebook and a bit rate that correspond to the target bit rate mode, to obtain the audio bitstream of the audio signal. In the field of digital signal processing, operation 103 may be implemented in the following manner: performing, by using a codebook and a bit rate that correspond to the target bit rate mode, digital signal-based encoding on the encoding feature to obtain the audio bitstream of the audio signal.

In some embodiments, when the target encoding mode is the wideband encoding mode, the target bit rate mode is configured for indicating using a target codebook to perform signal encoding on the encoding feature of the audio signal. Operation 103 may be implemented in the following manner: performing, by using the target codebook, quantization on the encoding feature of the audio signal to obtain a quantization value of the encoding feature; and performing, by using a target bit rate corresponding to the target codebook, entropy encoding on the quantization value to obtain the audio bitstream of the audio signal.

As shown in FIG. 4E, FIG. 4E is a schematic flowchart of an audio encoding method according to some embodiments of the disclosure. When the target encoding mode is an ultra-wideband encoding mode, the target bit rate mode includes indicating using a first codebook to perform signal encoding on the low-frequency feature, and using a second codebook to perform signal encoding on the high-frequency feature. FIG. 4E shows that operation 103 in FIG. 4A may be implemented by using operation 1031 to operation 1033. Operation 1031: Perform, by using the first codebook, quantization on the low-frequency feature to obtain a quantization value of the low-frequency feature, and perform, by using a bit rate corresponding to the first codebook, entropy encoding on the quantization value of the low-frequency feature to obtain a low-frequency bitstream of the low-frequency sub-band signal. Operation 1032: Perform, by using the second codebook, quantization on the high-frequency feature to obtain a quantization value of the high-frequency feature, and perform, by using a bit rate corresponding to the second codebook, entropy encoding on the quantization value of the high-frequency feature to obtain a high-frequency bitstream of the high-frequency sub-band signal. Operation 1033: Construct the audio bitstream of the audio signal based on the low-frequency bitstream and the high-frequency bitstream.

Quantization degrees (e.g., quantization precision) corresponding to different codebooks may be different. For example, quantization precision of the first codebook is greater than quantization precision of the second codebook. Since a value interval of each dimension in the low-frequency feature is [−1, 1], the interval [−1, 1] may be evenly divided into 11 equal parts to form a first codebook including 11 elements, and quantization is performed on the low-frequency feature by using the first codebook. Since a value interval of each dimension in the high-frequency feature is [−1, 1], the interval [−1, 1] may be evenly divided into 5 equal parts to form a second codebook including 5 elements, and quantization is performed on the high-frequency feature by using the second codebook.

Herein, scalar quantization (the components are quantized separately) and an entropy encoding method may be performed on a low-frequency feature F_{LB}(n) of the low-frequency sub-band signal and a high-frequency encoding feature F_{HB}(n) of the high-frequency sub-band signal. In addition, in this embodiment of the disclosure, a technical combination of VQ (combining a plurality of adjacent components into a vector for joint quantization) and entropy encoding is not limited.

When the target bit rate mode only includes indicating using the first codebook to perform signal encoding on the low-frequency feature and using the second codebook to perform signal encoding on the high-frequency feature, the low-frequency bitstream and the high-frequency bitstream are combined to obtain the audio bitstream of the audio signal.

In some embodiments, the target bit rate mode further includes indicating using a third codebook to perform signal encoding on the residual feature of the high-frequency feature. Before operation 1033, sub-bands corresponding to sub-frames of the high-frequency sub-band signal are determined, and the sub-bands are divided into a plurality of subsets; transform coefficients included in each of the subsets are averaged to obtain average energy corresponding to the subset, and the average energy is used as an envelope value corresponding to the subset; in the quantization value of the high-frequency feature, a quantization value of a sub-band spectral envelope of a sub-band corresponding to the subset is determined, and a difference between the envelope value corresponding to the subset and the quantization value of the sub-band spectral envelope is used as a first residual value; the residual feature of the high-frequency feature is determined based on the first residual value; and by using the third codebook, quantization is performed on the residual feature of the high-frequency feature to obtain a quantization value of the residual feature of the high-frequency feature, and by using a bit rate corresponding to the third codebook, entropy encoding is performed on the quantization value of the residual feature of the high-frequency feature to obtain a residual bitstream of the residual feature. Correspondingly, operation 1033 may be implemented in the following manner: using the low-frequency bitstream, the high-frequency bitstream, and the residual bitstream as the audio bitstream of the audio signal. A quantization degree of the third codebook may be different from quantization degrees of the first codebook and the second codebook.

In some embodiments, when a quantity of residual values is N, N is a positive integer greater than 1, the determining the residual feature of the high-frequency feature based on the first residual value may be implemented in the following manner: determining a quantization value of an n^{th} residual value, and determining a sum of the quantization value of the n^{th} residual value and the quantization value of the sub-band spectral envelope of the corresponding sub-band; using a difference between the envelope value corresponding to the subset and the sum as an (n+1)^{th} residual value; and determining the N residual values as the residual feature of the high-frequency feature; where n is a sequentially increasing positive integer, and 1≤n≤N.

An example in which the quantity of residual values is 2 is used for description. The residual values are determined in the following manner.
1) For each 10 ms sub-frame, the sub-frame is divided into 4 sub-bands, and each sub-band is further evenly divided into 2 subsets.

For example, a set of envelope values of the 4 sub-bands is {e₁, e₂, e₃, e₄}.
2) For each subset of each sub-band, an envelope value of the subset is calculated.

For example, a set of the envelope values of all the subsets is {e₁ₐ, e_{1b}, e₂ₐ, e_{2b}, e₃ₐ, e_{3b}, e₄ₐ, e_{4b}}.
3) A quantization value of a corresponding high-frequency feature vector (e.g., a quantization value of a high-frequency feature) is subtracted from the envelope value of each subset to obtain a first high-frequency feature vector residual (briefly referred to as a first residual value).

For example, if the quantization value of the high-frequency feature vector is { [symbol] }, first high-frequency feature vector residual is {e₁ₐ- [symbol] , e_{1b}- [symbol] , e₂ₐ- [symbol] , e_{2b}- [symbol] , e₃ₐ- [symbol] , e_{3b}- [symbol] , e₄ₐ- [symbol] , e_{4b}- [symbol] }.
4) Similar quantization and entropy encoding are performed on the foregoing first high-frequency feature residual to obtain a quantization value of the first high-frequency feature vector residual (briefly referred to as a quantization value of the first residual value).

Herein, considering that a dynamic range of a residual value is much lower than that of an original value, when scalar quantization is performed on each residual, only 2 bits need to be allocated. In this way, a reference bit rate of 2*16*50=1.6 kbps (similarly, due to the use of entropy encoding of non-uniform distribution, an actual bit rate is generally less than 1.6 kbps) is required, to obtain the quantization value of the first high-frequency feature vector residual.
5) A sum of the quantization value of the corresponding high-frequency feature vector and the quantization value of the first high-frequency feature vector residual is subtracted from the envelope value of each subset to obtain a second high-frequency feature vector residual (briefly referred to as a second residual value).

Operation 104: Determine a frame header based on the target encoding mode and the target bit rate mode.

Herein, an empty frame header may be first constructed. The empty frame header includes an encoding mode bit and a bit rate mode bit. The target encoding mode is written to the encoding mode bit included in the empty frame header, and the target bit rate mode is written to the bit rate mode bit included in the empty frame header, to determine the frame header. In this embodiment of the disclosure, a quantity of bits of the frame header is not limited, and positions of the target encoding mode and the target bit rate mode in the frame header are not limited. For example, the target encoding mode may be written to the first bit of the frame header, or may be written to the last bit of the frame header. Quantities of bits occupied by the encoding mode bit and the bit rate mode bit in the frame header are not limited.

Operation 105: Generate an audio bitstream encapsulation of the audio signal based on the audio bitstream and the frame header.

For example, after the audio bitstream and the frame header are acquired, the audio bitstream and the frame header are packaged into a file according to a specific format, to obtain the audio bitstream encapsulation. The audio bitstream encapsulation includes the audio bitstream and the frame header.

In some embodiments, before operation 105, flatness side information of the high-frequency sub-band signal is determined. Therefore, operation 105 may be implemented in the following manner: obtaining the audio bitstream encapsulation of the audio signal by combining the audio bitstream, the frame header, and the flatness side information.

For example, the frame header is placed at the first position of the audio bitstream encapsulation, and the audio bitstream and the flatness side information are placed behind the frame header. This embodiment of the disclosure is not limited to the sequence of the audio bitstream and the flatness side information. In some embodiments, the target encoding mode and the target bit rate mode may alternatively be at other positions of the audio bitstream encapsulation.

Flatness of the high-frequency sub-band signal refers to a degree of uniform distribution of amplitude of frequency components of the high-frequency sub-band signal in a frequency domain, and the flatness is an important indicator for measuring quality of the high-frequency sub-band signal. The flatness side information of the high-frequency sub-band signal refers to additional information of the flatness of the high-frequency sub-band signal when the high-frequency sub-band signal is processed. When frequency domain analysis is performed on the high-frequency sub-band signal, the flatness side information includes amplitude distribution of the high-frequency sub-band signal at frequency points, and is configured for determining whether the high-frequency sub-band signal keeps consistent in a particular frequency range or whether an abrupt peak value exists. When signal equalization is performed, the flatness side information helps to identify a trough and a peak in the high-frequency sub-band signal, thereby performing proper gain adjustment on the high-frequency sub-band signal. Therefore, an overall frequency response is flatter, and sound quality is improved. The flatness side information may also be configured for analyzing a distortion degree of a signal. If amplitude of the high-frequency sub-band signal at some frequency points is significantly different from that at other frequency points, distortion may be caused, thereby affecting the sound quality. In conclusion, the flatness side information of the high-frequency sub-band signal is of great significance for aspects such as signal preprocessing, analysis, equalization, and post-processing, and helps improve accuracy and an effect of audio signal processing.

In some embodiments, the determining flatness side information of the high-frequency sub-band signal may be implemented in the following manner: dividing transform coefficients included in sub-frames of the high-frequency sub-band signal into a plurality of blocks; determining first flatness of each of the blocks, and determining second flatness of a specified low-frequency band of the audio signal; setting the flatness side information to a first value when the first flatness is less than the second flatness or the first flatness is less than a flatness threshold, where the first value indicates that flattening processing is required during audio decoding; and setting the flatness side information to a second value when the first flatness is greater than or equal to the second flatness and the first flatness is greater than or equal to the flatness threshold, where the second value indicates that flattening processing is not required during audio decoding.

The specified low-frequency band is a low-frequency band set according to an actual application requirement. The flatness threshold is also a threshold set according to an actual application requirement.

For example, herein, the first value may be 1, and the second value may be 0. Alternatively, the first value may be 0, and the second value may be 1.

In some embodiments, the frame header further includes at least 1 channel bit, and the channel bit is configured for indicating performing audio encoding on the audio signal by using mono encoding or stereo encoding. When the audio signal is a stereo signal obtained by downmixing a left-channel input signal and a right-channel input signal, the channel bit in the frame header is set to the first value (e.g., 1). The first value indicates encoding the audio signal by stereo encoding. Parametric stereo encoding is performed on the left-channel input signal and the right-channel input signal to obtain a stereo feature vector, and the audio bitstream encapsulation of the audio signal is generated based on the stereo feature vector, the audio bitstream, and the frame header. When the audio signal is a mono input signal, a channel bit in the frame header is set to a second value (e.g., 0). The second value indicates encoding the audio signal by mono encoding. The audio bitstream encapsulation of the audio signal is generated based on the audio bitstream and the frame header.

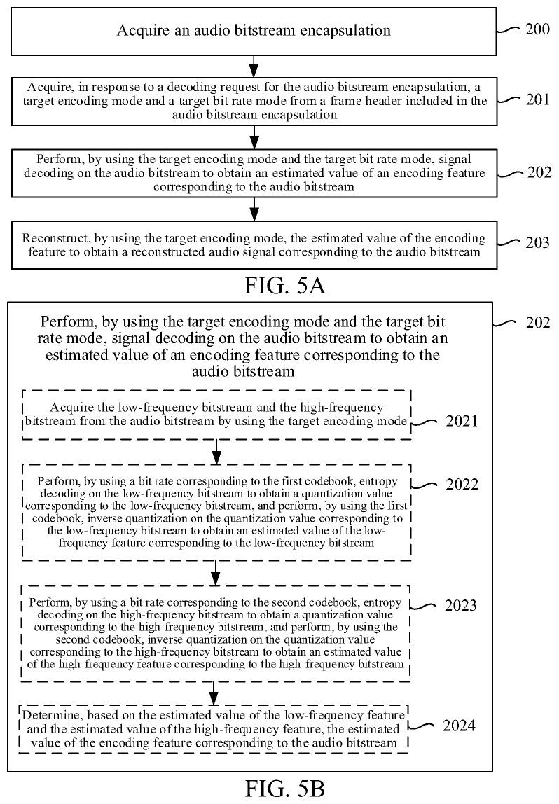

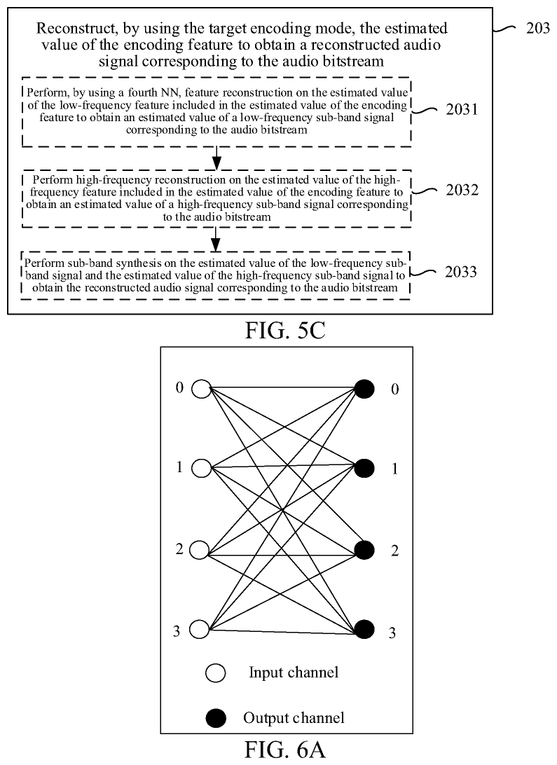

As described above, the audio decoding method provided in some embodiments of the disclosure may be implemented by various types of electronic devices. Referring to FIG. 5A, FIG. 5A is a schematic flowchart of an audio decoding method according to some embodiments of the disclosure. An audio decoding function is implemented with the audio decoding method. The audio decoding method and the foregoing audio encoding method are inverse processes of each other. Descriptions are provided with reference to operations shown in FIG. 5A.

Before the following operations are described, the audio decoding method provided in this embodiment of the disclosure is explained. The audio decoding method provided in this embodiment of the disclosure includes two decoding methods (e.g., a signal decoding method in the signal processing technology and feature decoding (such as a reconstruction method) in the artificial intelligence technology). For details of the signal decoding method in the signal processing technology, refer to operation 202 below, and for details of the feature decoding in the artificial intelligence technology, refer to operation 203 below. In the following embodiments, operations may be performed sequentially, in a different order, in parallel, or with some operations skipped or repeated.

Operation 200: Acquire an audio bitstream encapsulation.

The audio bitstream encapsulation includes an audio bitstream. The audio bitstream is obtained by performing audio encoding on an audio signal by using a target encoding mode and a target bit rate mode. The target encoding mode is acquired from a plurality of candidate encoding modes, and the target bit rate mode is acquired from a plurality of candidate bit rate modes.

As an example, after the audio bitstream encapsulation is obtained through encoding by using the audio encoding method shown in FIG. 4A, the audio bitstream encapsulation is transmitted to a decoder side. The decoder side receives the audio bitstream encapsulation.

Operation 201: Acquire, in response to a decoding request for the audio bitstream encapsulation, a target encoding mode and a target bit rate mode from a frame header included in the audio bitstream encapsulation.

Herein, the decoding request is configured for indicating performing audio decoding on the audio bitstream.

As an example, after the audio bitstream encapsulation is obtained through encoding using the audio encoding method shown in FIG. 4A, the audio bitstream encapsulation is transmitted to a decoder side. After receiving the audio bitstream encapsulation, the decoder side performs audio decoding on the audio bitstream encapsulation. Firstly, a target encoding mode and a target bit rate mode are acquired from the frame header included in the audio bitstream encapsulation. For example, the target encoding mode is acquired from the encoding mode bit included in the frame header, and the target bit rate mode is acquired from the bit rate mode bit included in the frame header.

Operation 202: Perform, by using the target encoding mode and the target bit rate mode, signal decoding on the audio bitstream to obtain an estimated value of an encoding feature corresponding to the audio bitstream.

Signal decoding is an inverse process of signal encoding. Therefore, signal decoding is performed on the audio bitstream by using a decoding mode corresponding to the target encoding mode and the target bit rate mode, to obtain the estimated value of the encoding feature corresponding to the audio bitstream. For example, if the target encoding mode is a wideband encoding mode, signal decoding is performed on the audio bitstream by using the wideband decoding mode, to obtain the estimated value of the encoding feature corresponding to the audio bitstream. If the target encoding mode is an ultra-wideband encoding mode, signal decoding is performed on the audio bitstream by using the ultra-wideband decoding mode, to obtain the estimated value of the encoding feature corresponding to the audio bitstream.

Signal decoding is an inverse process of signal encoding. A process in which the decoder side decodes the received bitstream is an inverse process of a process in which the encoder side performs encoding. Therefore, the value generated in the decoding process is an estimated value relative to the value generated in the encoding process. For example, a data value representing an encoding feature generated in the decoding process is an estimated value relative to an encoding feature generated in the encoding process. The former is not necessarily equal to a data value of an original encoding feature. For example, there may be a subtle difference between the two due to the encoding and decoding processes, and there may be situations where the data value of the original encoding feature cannot be completely restored by decoding. Therefore, the former is also referred to as “estimated value of the encoding feature”.

In some embodiments, the target encoding mode is a wideband encoding mode, and the target bit rate mode is configured for indicating using a target codebook to perform signal encoding on an encoding feature of an audio signal. Therefore, operation 202 may be implemented in the following manner: performing, by using a target bit rate corresponding to the target codebook, entropy decoding on the audio bitstream to obtain a quantization value corresponding to the audio bitstream; and performing, by using the target codebook, inverse quantization on the quantization value corresponding to the audio bitstream to obtain the estimated value of the encoding feature corresponding to the audio bitstream.

The inverse quantization is implemented by querying a quantization table. The quantization table is a mapping table generated through quantization in the encoding process. As an example, entropy decoding is first performed on a received bitstream, and an estimated value of a feature vector (e.g., an estimated value of an encoding feature corresponding to an audio bitstream) is obtained by looking up the quantization table (e.g., inverse quantization, where the quantization table is a mapping table generated through quantization in the encoding process).

Referring to FIG. 5B, FIG. 5B is a schematic flowchart of an audio decoding method according to some embodiments of the disclosure. The target encoding mode is an ultra-wideband encoding mode, the target bit rate mode includes indicating using a first codebook to perform signal encoding on a low-frequency feature of the audio signal, and using a second codebook to perform signal encoding on a high-frequency feature of the audio signal, and the audio bitstream includes a low-frequency bitstream and a high-frequency bitstream. Therefore, FIG. 5B shows that operation 202 may be implemented by using operation 2021 to operation 2024. Operation 2021: Acquire the low-frequency bitstream and the high-frequency bitstream from the audio bitstream by using the target encoding mode. Operation 2022: Perform, by using a bit rate corresponding to the first codebook, entropy decoding on the low-frequency bitstream to obtain a quantization value corresponding to the low-frequency bitstream, and perform, by using the first codebook, inverse quantization on the quantization value corresponding to the low-frequency bitstream to obtain an estimated value of the low-frequency feature corresponding to the low-frequency bitstream. Operation 2023: Perform, by using a bit rate corresponding to the second codebook, entropy decoding on the high-frequency bitstream to obtain a quantization value corresponding to the high-frequency bitstream, and perform, by using the second codebook, inverse quantization on the quantization value corresponding to the high-frequency bitstream to obtain an estimated value of the high-frequency feature corresponding to the high-frequency bitstream. Operation 2024: Determine, based on the estimated value of the low-frequency feature and the estimated value of the high-frequency feature, the estimated value of the encoding feature corresponding to the audio bitstream.

A data value representing a low-frequency feature generated in the decoding process is an estimated value relative to a low-frequency feature generated in the encoding process. The former is not necessarily equal to a data value of an original low-frequency feature. For example, there may be a subtle difference between the two due to the encoding and decoding processes, and there may be situations where the data value of the original low-frequency feature cannot be completely restored by decoding. Therefore, the former is also referred to as “estimated value of the low-frequency feature”. Similarly, an estimated value of the high-frequency feature generated in the decoding process is also an estimated value with respect to a high-frequency feature in the encoding process.

For example, for a low-frequency bitstream, entropy decoding is first performed on the low-frequency bitstream by using a bit rate corresponding to the first codebook, to obtain a quantization value corresponding to the low-frequency bitstream, and an estimated value F′_{LB} (n) of the low-frequency feature corresponding to the low-frequency bitstream is obtained by looking up the first codebook. For a high-frequency bitstream, entropy decoding is first performed on the high-frequency bitstream by using a bit rate corresponding to the second codebook, to obtain a quantization value corresponding to the high-frequency bitstream, and an estimated value F′_{HB}(n) of the high-frequency feature corresponding to the high-frequency bitstream is obtained by looking up the second codebook. When the target bit rate mode includes only indicating using the first codebook to perform signal encoding on the low-frequency feature of the audio signal and using the second codebook to perform signal encoding on the high-frequency feature of the audio signal, the estimated value of the low-frequency feature and the estimated value of the high-frequency feature are determined as the estimated value of the encoding feature corresponding to the audio bitstream. The estimated value of the high-frequency feature is configured for participating in high-frequency reconstruction, to generate an estimated value of a high-frequency sub-band signal.

In some embodiments, the audio bitstream further includes a residual bitstream, and the target bit rate mode further includes indicating using a third codebook to perform signal encoding on a residual feature of the high-frequency feature corresponding to the audio bitstream. Before operation 2024, by using a bit rate corresponding to the third codebook, entropy decoding is performed on the residual bitstream to obtain a quantization value corresponding to the residual bitstream, and by using the third codebook, inverse quantization is performed on the quantization value corresponding to the residual bitstream to obtain an estimated value of a residual feature corresponding to the residual bitstream. Correspondingly, operation 2024 may be implemented in the following manner: determining a sum of the estimated value of the high-frequency feature and the estimated value of the residual feature as a final estimated value of the high-frequency feature; and determining the estimated value of the low-frequency feature and the final estimated value of the high-frequency feature as the estimated value of the encoding feature corresponding to the audio bitstream.

An i^{th} value in the estimated value of the high-frequency feature is respectively added to a (2i−1)^{th} value and a 2i^{th} value in the estimated value of the residual feature, to respectively obtain a (2i−1)^{th} value and a 2i^{th} value in the final estimated value of the high-frequency feature. For example, if the estimated value of the high-frequency feature is F′_{HB}(n)=[e′₁, e′₂, . . . , e′₈] and the estimated value of the residual feature is F′_{C}(n)=[e′_{1C}, e′_{2C}, . . . , e′_{16C}], the final estimated value of the high-frequency feature is F′_{FHB}(n)=[e′₁+e′_{1C}, e′₁+e′_{2C}, . . . , e′₈+e′_{16C}].

Operation 203: Reconstruct, by using the target encoding mode, the estimated value of the encoding feature to obtain a reconstructed audio signal corresponding to the audio bitstream.

The reconstruction process is a reverse process of the extraction process. A process in which the decoder side decodes the received bitstream is an inverse process of a process in which the encoder side performs encoding. Therefore, the value generated in the decoding process is an estimated value relative to a value generated in the encoding process. For example, a reconstructed audio signal generated in the decoding process is an estimated value relative to the audio signal generated in the encoding process. The reconstructed audio signal is not necessarily equal to an original audio signal. There may be a subtle difference between the two due to the encoding and decoding processes, and there may be situations where the original audio signal cannot be completely restored by decoding.

In some embodiments, the target encoding mode is a wideband encoding mode, and operation 203 may be implemented in the following manner: invoking a third NN based on the wideband encoding mode; and reconstructing, by using the third NN, the estimated value of the encoding feature corresponding to the audio bitstream, to obtain the reconstructed audio signal corresponding to the audio bitstream.

The reconstruction process is performed by using the third NN is an inverse process of performing the extraction process by using the first NN.

As an example, the reconstructing the estimated value of the encoding feature corresponding to the audio bitstream, to obtain the reconstructed audio signal corresponding to the audio bitstream may be implemented in the following manner: performing, by using at least one residual unit included in the third NN, residual processing on the estimated value of the encoding feature corresponding to the audio bitstream, to obtain an estimated value of an audio feature corresponding to the audio bitstream; and performing feature reconstruction on the estimated value of the audio feature corresponding to the audio bitstream to obtain the reconstructed audio signal corresponding to the audio bitstream.

The third NN includes 4 decoding blocks, and each decoding block includes 4 or 5 residual units. The quantity of the decoding blocks is not limited in some embodiments of the disclosure, which may be any positive integer such as 2, 3, 4, or 5. The quantity of the residual units in the decoding block is not limited in some embodiments of the disclosure, either, which may be any positive integer such as 2, 3, 4, 5, or 6.

Based on characteristics of the residual unit, residual processing performed, by using at least one residual unit included in the third NN, on the estimated value of the encoding feature corresponding to the audio bitstream is configured for calculating a residual of the encoding feature at the decoding side. For example, the residual of the encoding feature is obtained by adding the encoding feature to an output of the residual unit at the decoding side. The encoding feature is used as an input of the residual unit. After the encoding feature is processed by the residual unit at the decoding side, the output of the residual unit is obtained. The input of the residual unit at the decoding side and the output of the residual unit are added through characteristics of skip connection of the residual unit to obtain the residual of the encoding feature.

Referring to FIG. 5C, FIG. 5C is a schematic flowchart of an audio decoding method according to some embodiments of the disclosure. The target encoding mode is an ultra-wideband encoding mode, and FIG. 5C shows that operation 203 may be implemented by using operation 2031 to operation 2033.

Operation 2031: Perform, by using a fourth NN, feature reconstruction on the estimated value of the low-frequency feature included in the estimated value of the encoding feature to obtain an estimated value of a low-frequency sub-band signal corresponding to the audio bitstream. A structure of the fourth NN is similar to that of the third NN.

In some embodiments, operation 2031 may be implemented by using operation 20311 to operation 20312.

Operation 20311: Perform, by using at least one residual unit included in the fourth NN, residual processing on the estimated value of the low-frequency feature to obtain an estimated value of a low-frequency encoding feature. The fourth NN includes 4 decoding blocks, and each decoding block includes 4 or 5 residual units.

In some embodiments, operation 20311 may be implemented by using operation 203111 to operation 203112.

In operation 203111, feature decoding processing is performed on the estimated value of the low-frequency feature to obtain a residual feature.

For example, feature decoding is an inverse process of feature encoding. Feature decoding is performed on the estimated value of the low-frequency feature to obtain the residual feature (an estimated value).

In some embodiments, operation 203111 may be implemented in the following manner: convolving the low-frequency feature to obtain a convolution feature, a quantity of channels of the convolution feature being less than a quantity of channels of the low-frequency feature; and upsampling the convolution feature to obtain the residual feature.

In the field of audio encoding and decoding, an upsampling operation is configured for increasing resolution of a feature map (e.g., the convolution feature) to reconstruct an audio signal more accurately. Upsampling involves interpolation or other forms of upsampling technologies to generate a feature map with higher precision, which helps to better recover original details and characteristics of the audio signal in the decoding process. NN technologies such as convolution, pooling, and upsampling are used in audio decoding so that useful features may be effectively extracted, calculation complexity may be reduced, and original content of the audio signal may be reconstructed more accurately. These technologies are of great significance for improving performance and efficiency of audio decoding, and promoting development and application of the audio encoding and decoding technology.

Certainly, before operation 203111, causal convolution may further be performed on the low-frequency feature to obtain a low-frequency feature obtained after the causal convolution, and operation 203111 is performed based on the low-frequency feature obtained after the causal convolution. For example, feature decoding is performed on the low-frequency feature obtained after the causal convolution to obtain the residual feature.

Operation 203112: Perform, by using at least one residual unit included in the fourth NN, feature residual processing on the residual feature to obtain the estimated value of the low-frequency encoding feature.

Herein, residual processing is performed on the residual feature to ensure that shallow feature information of the residual feature can be better utilized while comprehensively learning the residual feature, thereby avoiding omission of the shallow feature information. The residual feature obtained by performing feature decoding on the estimated value of the low-frequency feature is an estimated value relative to a residual feature at the encoding side. Since the encoding process and the decoding process are inverse processes of each other, the residual feature obtained by performing feature decoding on the estimated value of the low-frequency feature is not a residual result obtained by performing residual calculation at the decoding side. After the residual feature obtained by performing feature decoding on the estimated value of the low-frequency feature is obtained, residual calculation may be performed on the residual feature obtained by performing feature decoding on the estimated value of the low-frequency feature.

In some embodiments, when the at least one residual unit includes a plurality of cascaded residual units, operation 203112 may be implemented in the following manner: performing, by using one residual unit, single residual processing on the residual feature to obtain the estimated value of the low-frequency encoding feature.

In some embodiments, when the at least one residual unit includes a plurality of cascaded residual units, operation 203112 may be implemented in the following manner: performing single residual processing on the residual feature by using a first residual unit of the plurality of cascaded residual units; outputting the residual result outputted by the first residual unit to a subsequent cascaded residual unit, and continuing to perform single residual processing by using the subsequent cascaded residual unit and output a residual result; and using a residual result outputted by a last residual unit as the estimated value of the low-frequency encoding feature.

In some embodiments, a processing process of the residual unit is as follows: performing the following processing through a k^{th} residual unit of the plurality of cascaded residual units: convolving an input of the k^{th} residual unit to obtain a convolution result of the k^{th} residual unit; and adding the convolution result of the k^{th} residual unit to an input of the k^{th} residual unit to obtain a residual result outputted by the k^{th} residual unit, where k is a sequentially increasing positive integer, 1≤k≤J, and J is a quantity of residual units, when k is 1, the input of the k^{th} residual unit is a residual feature, and when k is not 1, the input of the k^{th} residual unit is a residual result outputted by a (k−1)^{th} residual unit.

Following the foregoing embodiment, each residual unit includes a dilated convolution operator; and the convolving an input of the k^{th} residual unit to obtain a convolution result of the k^{th} residual unit may be implemented in the following manner: performing the following processing through the k^{th} residual unit of the plurality of cascaded residual units: performing dilated convolution on the input of the k^{th} residual unit to obtain the convolution result of the k^{th} residual unit. Dilated convolution is performed on the residual feature through a dilated convolution operator included in the first residual unit to obtain a dilated convolution result of the first residual unit. The following processing is performed by using a j^{th} residual unit of the plurality of cascaded residual units: performing, by using a dilated convolution operator included in the j^{th} residual unit, dilated convolution on a residual result outputted by a (j−1)^{th} residual unit to obtain a dilated convolution result of the j^{th} residual unit, where j is a sequentially increasing positive integer, 1<j≤J, and J is a quantity of residual units.

Following the foregoing embodiment, each residual unit not only includes the dilated convolution operator, but also includes at least one causal convolution operator. After the input of the k^{th} residual unit is convolved to obtain the convolution result of the k^{th} residual unit, causal convolution is performed on an obtained dilated convolution result by using at least one causal convolution operator included in the k^{th} residual unit, and an obtained causal convolution result is used as the convolution result of the k^{th} residual unit. Causal convolution is performed on the dilated convolution result of the first residual unit by using at least one causal convolution operator included in the first residual unit, and an obtained causal convolution result is used as a convolution result outputted by the first residual unit. After dilated convolution is performed on the residual result outputted by the (j−1)^{th} residual unit by using the dilated convolution operator included in the j^{th} residual unit, to obtain the dilated convolution result of the j^{th} residual unit, causal convolution is performed on the dilated convolution result of the j^{th} residual unit by using at least one causal convolution operator included in the j^{th} residual unit, and a causal convolution result of the j^{th} residual unit is used as the convolution result of the j^{th} residual unit.

In some embodiments, when group convolution is applied to the dilated convolution operator included in the residual unit, performing dilated convolution on the low-frequency feature may be implemented in the following manner: grouping input channels of the residual feature to obtain a plurality of groups, where each group includes first elements corresponding to at least two channels in the residual feature; and performing dilated convolution on the first elements in each group. When group convolution is applied to the causal convolution operator included in the residual unit, performing causal convolution on the obtained dilated convolution result may be implemented in the following manner: grouping input channels of the dilated convolution result to obtain a plurality of groups, where each group includes second elements corresponding to at least two channels in the dilated convolution result; and performing causal convolution on the second elements in each group.

In some embodiments, the fourth NN configured for audio decoding includes a plurality of cascaded decoding blocks, and each decoding block includes a feature decoding block and at least one residual unit. Operation 203111 may be implemented by using operation 203111A, and operation 203112 may be implemented by using operation 203112A. In operation 203111A, feature decoding is performed on the low-frequency feature by using feature decoding blocks in the plurality of cascaded decoding blocks, to obtain the residual feature. Correspondingly, in operation 203112A, single residual processing is performed on the residual feature by using at least one residual unit in the plurality of cascaded decoding blocks, to obtain the estimated value of the low-frequency encoding feature.

In some embodiments, operation 203111A may be implemented in the following manner: performing, by using a feature decoding block in a first decoding block of the plurality of cascaded decoding blocks, feature decoding on the low-frequency feature, and outputting a decoding result outputted by the feature decoding block in the first decoding block to at least one residual unit in the first decoding block; performing, by using a feature decoding block in an i^{th} decoding block of the plurality of cascaded decoding blocks, feature decoding on a residual result outputted by at least one residual unit in an (i−1)^{th} decoding block, and outputting a decoding result outputted by the feature decoding block in the i^{th} decoding block to at least one residual unit in the i^{th} decoding block; and using a decoding result outputted by a feature decoding block in a last decoding block as the residual feature, where i is a sequentially increasing positive integer, 1<i≤I, and I is a quantity of decoding blocks. The decoding result outputted by the feature decoding block in the first decoding block is obtained by performing the following processing by using the feature decoding block in the first decoding block of the plurality of cascaded decoding blocks: convolving the low-frequency feature to obtain a convolution feature, where a quantity of channels of the convolution feature is less than a quantity of channels of the low-frequency feature; and upsampling the convolution feature to obtain the decoding result outputted by the feature decoding block in the first decoding block. The decoding result outputted by the feature decoding block in the i^{th} decoding block is obtained by performing the following processing through the feature decoding block in the i^{th} decoding block: convolving the residual result outputted by the at least one residual unit in the (i−1)^{th} decoding block to obtain a convolution feature, a quantity of channels of the convolution feature being less than a quantity of channels of the residual result outputted by the at least one residual unit; and upsampling the convolution feature to obtain the decoding result outputted by the feature decoding block in the i^{th} decoding block.

As an example, the fourth NN includes 4 decoding blocks, and each decoding block includes 4 or 5 residual units.

In some embodiments, operation 203112A may be implemented in the following manner: performing single residual processing on the residual feature by using at least one residual unit in the last decoding block of the plurality of cascaded decoding blocks, to obtain the estimated value of the low-frequency encoding feature.

Operation 2032: Perform high-frequency reconstruction on the estimated value of the high-frequency feature included in the estimated value of the encoding feature to obtain an estimated value of a high-frequency sub-band signal corresponding to the audio bitstream.

Feature reconstruction at the decoder side is an inverse process of extraction at the encoder side, and high-frequency reconstruction at the decoder side is an inverse process of high-frequency analysis at the encoder side.

In some embodiments, the performing high-frequency reconstruction on the estimated value of the high-frequency feature included in the encoding feature to obtain an estimated value of a high-frequency sub-band signal corresponding to the audio bitstream may be implemented in the following manner: invoking a sixth NN to perform feature reconstruction on the estimated value of the high-frequency feature included in the encoding feature, to obtain the estimated value of the high-frequency sub-band signal corresponding to the audio bitstream. A structure of the sixth NN is similar to that of the third NN.

In some embodiments, operation 2032 may be implemented by using operation 20321 to operation 20324.

Operation 20321: Perform frequency domain transform on first-half sample points and second-half sample points included in the estimated value of the low-frequency sub-band signal to obtain a first transform coefficient corresponding to the first-half sample points and a second transform coefficient corresponding to the second-half sample points.

A frequency domain transform method in this embodiment of the disclosure includes MDCT, DCT, FFT, and the like. A frequency domain transform mode is not limited in this embodiment of the disclosure.

Operation 20322: Perform inverse bandwidth extension on the estimated value of the high-frequency feature based on the first transform coefficient to obtain an estimated value of a first high-frequency sub-band signal.

In some embodiments, operation 20322 may be implemented in the following manner: performing spectrum replication on a second-half transform coefficient in the first transform coefficient to obtain a first reference transform coefficient of a reference high-frequency sub-band signal; performing, based on a first-half sub-band spectral envelope corresponding to the estimated value of the high-frequency feature, gain processing on the first reference transform coefficient to obtain a first reference transform coefficient obtained after gain processing; and performing inverse frequency domain transform on the first reference transform coefficient obtained after gain processing, to obtain the estimated value of the first high-frequency sub-band signal.

In some embodiments, the performing, based on a first-half sub-band spectral envelope corresponding to the estimated value of the high-frequency feature, gain processing on the first reference transform coefficient to obtain a first reference transform coefficient obtained after gain processing includes: dividing, based on the first-half sub-band spectral envelope, the first reference transform coefficient of the reference high-frequency sub-band signal into a plurality of first sub-bands; and performing the following processing on any one of the plurality of first sub-bands: determining first average energy corresponding to the first sub-band in the first-half sub-band spectral envelope, and determining second average energy corresponding to the first sub-band; and determining a gain factor based on a ratio of the first average energy to the second average energy; and multiplying the gain factor by each first reference transform coefficient included in the first sub-band, to obtain the first reference transform coefficient obtained after gain processing.

As an example, first, MDCT of 320 points is also performed twice on the estimated value of the low-frequency sub-band signal x′_{LB}(n) generated by the decoder side, generating two groups of MDCT coefficients of 160 points (e.g., the first transform coefficient corresponding to the first-half sample points and the second transform coefficient corresponding to the second-half sample points).

Then, for the first group of MDCT coefficients of 160 points (e.g., the first transform coefficient corresponding to the first-half sample points), the MDCT coefficients of 160 points generated by x′_{LB}(n) are replicated to generate MDCT coefficients of a high-frequency part. With reference to a basic feature of a voice signal, there are more harmonics in the low-frequency part and fewer harmonics in the high-frequency part. Therefore, to avoid that the manually generated MDCT spectrum of the high-frequency part includes excessive harmonics due to simple replication, the last 80 points in the MDCT coefficients of 160 points on which the low-frequency sub-band depends may be used as a master template, and the spectrum is replicated 2 times to generate a reference value of MDCT coefficients of 160 points of the high-frequency sub-band signal (e.g., the first reference transform coefficient of the reference high-frequency sub-band signal).

Next, the previously obtained 8 sub-band spectral envelopes (e.g., 8 sub-band spectral envelopes obtained by querying the quantization table, e.g., the sub-band spectral envelope corresponding to the high-frequency feature) are invoked. The 8 sub-band spectral envelopes correspond to 8 high-frequency sub-bands, and the generated reference value of the MDCT coefficients of 160 points of the reference high-frequency sub-band signal is divided into 8 reference high-frequency sub-bands (e.g., the first reference transform coefficient of the reference high-frequency sub-band signal is divided into a plurality of first sub-bands). In a band-wise mode, based on a high-frequency sub-band and a corresponding reference high-frequency sub-band, gain processing is performed on the generated reference value of the MDCT coefficients of 320 points of the reference high-frequency sub-band signal (multiplication is performed in a frequency domain). For example, a gain factor is calculated according to average energy (e.g., the first average energy) of the high-frequency sub-band and average energy (second average energy) of the corresponding reference high-frequency sub-band, and an MDCT coefficient corresponding to each point in the corresponding reference high-frequency sub-band is multiplied by the gain factor to ensure that energy of a high-frequency MDCT coefficient virtually generated through decoding is close to original coefficient energy of the encoder side.

For example, it is assumed that average energy of a reference high-frequency sub-band (e.g., a first sub-band obtained by dividing generated reference values of MDCT coefficients of 160 points of a high-frequency part signal) is Y_L, and average energy of a current high-frequency sub-band (e.g., a sub-band corresponding to a sub-band spectral envelope obtained by decoding based on a bitstream) is Y_H, a gain factor a=sqrt(Y_H/Y_L) is calculated, where sqrt( ) represents a square root calculation function configured for calculating a square root of (Y_H/Y_L). After the gain factor a is provided, an MDCT coefficient of each point in the reference high-frequency sub-band is directly multiplied by a. The average energy of the MDCT coefficient (virtually generated) obtained after gain processing is very close to the original one of the encoder side.

Finally, inverse MDCT is invoked to generate an estimated value of a first sub-frame of the high-frequency sub-band signal (e.g., the estimated value of the first high-frequency sub-band signal).

Operation 20323: Perform inverse bandwidth extension on the estimated value of the high-frequency feature based on the second transform coefficient to obtain an estimated value of the second high-frequency sub-band signal.

Herein, operation 20323 is similar to operation 20322. A difference lies in that the processing object in operation 20323 is the second transform coefficient, while the processing object in operation 20322 is the first transform coefficient.

In some embodiments, operation 20323 may be implemented in the following manner: performing spectrum replication on a second-half transform coefficient in the second transform coefficient to obtain a second reference transform coefficient of a reference high-frequency sub-band signal; performing, based on a second-half sub-band spectral envelope corresponding to the estimated value of the high-frequency feature, gain processing on the second reference transform coefficient to obtain a second reference transform coefficient obtained after gain processing; and performing inverse frequency domain transform on the second reference transform coefficient obtained after gain processing, to obtain the estimated value of the second high-frequency sub-band signal.

In some embodiments, the performing, based on a second-half sub-band spectral envelope corresponding to the estimated value of the high-frequency feature, gain processing on the second reference transform coefficient to obtain a second reference transform coefficient obtained after gain processing includes: dividing, based on the second-half sub-band spectral envelope, the second reference transform coefficient of the reference high-frequency sub-band signal into a plurality of second sub-bands; and performing the following processing on any one of the plurality of second sub-bands: determining first average energy corresponding to the second sub-band in the second-half sub-band spectral envelope, and determining second average energy corresponding to the second sub-band; and determining a gain factor based on a ratio of the first average energy to the second average energy; and multiplying the gain factor by each second reference transform coefficient included in the second sub-band, to obtain the second reference transform coefficient obtained after gain processing.

Operation 20324: Obtain the estimated value of the high-frequency sub-band signal corresponding to the audio bitstream by combining the estimated value of the first high-frequency sub-band signal and the estimated value of the second high-frequency sub-band signal.

Operation 2033: Perform sub-band synthesis on the estimated value of the low-frequency sub-band signal and the estimated value of the high-frequency sub-band signal to obtain the reconstructed audio signal corresponding to the audio bitstream.

For example, sub-band synthesis is an inverse process of sub-band decomposition. The decoder side performs sub-band synthesis on the estimated value of the low-frequency sub-band signal and the estimated value of the high-frequency sub-band signal, to recover the reconstructed audio signal. The reconstructed audio signal is a recovered reconstructed signal.

In some embodiments, the performing sub-band synthesis on the estimated value of the low-frequency sub-band signal and the estimated value of the high-frequency sub-band signal to obtain the reconstructed audio signal includes: upsampling the estimated value of the low-frequency sub-band signal to obtain a low-pass filtered signal; upsampling the estimated value of the high-frequency sub-band signal to obtain a high-frequency filtered signal; and filtering and synthesizing the low-pass filtered signal and the high-frequency filtered signal to obtain the reconstructed audio signal.

For example, after the estimated value of the low-frequency sub-band signal and the estimated value of the high-frequency sub-band signal are acquired, sub-band synthesis is performed on the estimated value of the low-frequency sub-band signal and the estimated value of the high-frequency sub-band signal by using the QMF synthesis filter, to recover the reconstructed audio signal.

In some embodiments, the frame header further includes at least 1 channel bit, and the channel bit is configured for indicating performing audio decoding on the audio bitstream by mono decoding or stereo decoding. When the channel bit in the frame header included in the audio bitstream encapsulation is a first value, it indicates that the audio bitstream needs to be decoded by stereo decoding. For example, a synthesized stereo signal is reconstructed by using a reconstructed audio signal obtained through decoding and a stereo feature vector in the audio bitstream encapsulation. When the channel bit in the frame header included in the audio bitstream encapsulation is a second value, it indicates that audio decoding needs to be performed on the audio bitstream by mono decoding. For example, the decoded reconstructed audio signal is used as a mono reconstructed audio signal.

Exemplary application of some embodiments of the disclosure in an actual application scene will be described below.

Some embodiments of the disclosure may be applied to various audio scenes, such as a voice call and instant messaging. A description is provided below using a voice call as an example.

In the related art, a voice encoding principle is roughly as follows. The voice encoding may directly encode voice waveform samples sample by sample. Alternatively, related low-dimensional features are extracted based on a human sounding principle, an encoder side encodes the features, and a decoder side reconstructs a voice signal based on these parameters.

The foregoing encoding principles come from voice signal modeling, e.g., a signal processing-based compression method. Compared with the signal processing-based compression method, to improve the encoding quality while ensuring the voice encoding efficiency, some embodiments of the disclosure provide a multi-mode multi-rate voice encoding method (e.g., the audio encoding method and the audio decoding method). Based on characteristics of an audio signal, after an important part (a low-frequency sub-band signal) is processed based on the NN technology, a feature vector having a dimension lower than that of an inputted low-frequency sub-band signal may be obtained. An operation similar to “partitioning” is used in the NN, which can reduce algorithm complexity and improve an encoding effect. For the low-frequency feature vector (e.g., the foregoing low-frequency feature), quantization and encoding may be performed based on the same low-frequency feature vector and by using codebooks of different quantization precision, to achieve a multi-rate encoding and decoding effect. For the high-frequency feature vector (e.g., the foregoing high-frequency feature vector), multi-level quantization and encoding are employed to achieve the multi-rate encoding and decoding effect.

Some embodiments of the disclosure may be applied to a voice communication link shown in FIG. 6C. Using a voice over Internet protocol (VoIP) conference system as an example, the voice encoding and decoding technology involved in some embodiments of the disclosure is deployed in encoding and decoding parts to achieve a basic function of voice compression. An encoder is deployed in an uplink client 601, and a decoder is deployed in a downlink client 602. The uplink client acquires a voice, performs processing such as preprocessing enhancement and encoding, and transmits a bitstream obtained through encoding to the downlink client 602 by using a network. The downlink client 602 performs processing such as decoding and enhancement to play back a decoded voice on the downlink client 602.

Considering forward compatibility (e.g., a new encoder is compatible with an existing encoder), a transcoder needs to be deployed in a backend (e.g., a server) of a system to resolve the problem of interconnection and intercommunication between the new encoder and the existing encoder. For example, a transmitting end (uplink client) is a new NN encoder, and a receiving end (downlink client) is a public switched telephone network (PSTN) (G.722). In the backend, an NN decoder needs to be executed to generate a voice signal, and then a G.722 encoder is invoked to generate a specific bitstream to implement a transcoding function so that the receiving end can perform correct decoding based on the specific bitstream.

The audio encoding method and the audio decoding method provided in some embodiments of the disclosure will be described below with reference to a high-frequency part and a low-frequency part of a mono signal.

The audio encoding method and the audio decoding method provided in some embodiments of the disclosure are described below with reference to FIG. 7.

The following processing is performed on the encoder side:
decomposing, by using an analysis filter, an input audio signal x(n) of an n^{th} frame into a low-frequency sub-band signal x_{LB}(n) and a high-frequency sub-band signal x_{HB}(n).

For the high-frequency sub-band signal x_{HB}(n), considering that the high frequency is less important to the quality than the low frequency, other solutions may be used for the high-frequency sub-band signal x_{HB}(n) to extract the feature vector F_{HB}(n). For example, for a bandwidth extension technology based on voice signal analysis, a high-frequency sub-band signal may be generated using only a small number of bits. An NN structure the same as that of the low-frequency sub-band signal or a more simplified network (e.g., an output feature vector is smaller than the low-frequency feature vector F_{LB}(n)) may further be used. For the high-frequency feature vector F_{HB}(n), multi-level quantization and encoding are employed to achieve the multi-rate encoding and decoding effect.

VQ or scalar quantization is performed on a feature vector (e.g., F_{LB}(n) and F_{HB}(n)) corresponding to the sub-band signal, entropy encoding is performed on a quantized quantization value, and a bitstream (a low-frequency bitstream and a high-frequency bitstream) obtained after encoding is transmitted to the decoder side.

The following processing is performed on the decoder side:
decoding a bitstream (including a low-frequency bitstream and a high-frequency bitstream) received by the decoder side to obtain an estimated value F_{LB}^{l}(n) of a low-frequency feature vector and an estimated value F_{HB}^{l}(n) of a high-frequency feature vector.

For the low-frequency part, a third NN is invoked based on the estimated value F_{LB}^{l}(n) of the low-frequency feature vector, to obtain an estimated value x_{LB}^{l}(n) of a low-frequency sub-band signal. An operation similar to “partitioning” is used in the NN, thereby reducing algorithm complexity and improving an encoding effect. According to an actual codeword length in a bitstream, codebooks with different quantization precision may be used to generate F_{LB}^{l}(n) and x_{LB}^{l}(n) with different quantization precision, thereby achieving a multi-rate encoding and decoding effect.

For the high-frequency part, high-frequency reconstruction is invoked based on the estimated value F_{HB}^{l}(n) of the high-frequency feature vector to generate an estimated value x_{HB}^{l}(n) of a high-frequency sub-band signal. According to an actual codeword length in a bitstream, codebooks with different quantization precision may be used to generate F_{HB}^{l}(n) and x_{LB}^{l}(n) with different quantization precision, thereby achieving a multi-rate encoding and decoding effect.

Finally, the QMF synthesis filter is invoked to generate a reconstructed synthesized voice signal x′(n).

The audio encoding method and the audio decoding method provided in some embodiments of the disclosure are specifically described below.

In some embodiments, a voice signal with a sampling rate Fs=32000 Hz is used as an example (the method provided in this embodiment of the disclosure is further applicable to scenes with other sampling rates, including, but not limited to, 8000 Hz, 32000 Hz, and 48000 Hz). In addition, it is assumed that a frame length is set to 20 ms. Therefore, for Fs=32000 Hz, it is equivalent to that each frame includes 640 sample points.

The encoder side and the decoder side are described in detail below with reference to the flowchart shown in FIG. 7.

A procedure of the encoder side of the low-frequency part and the high-frequency part of the mono signal is as follows.

For an audio signal (a mono signal) with a sampling rate Fs=32000 Hz, an input signal of an n^{th} frame including 640 sample points is recorded as an input signal x(n) (e.g., a mono input signal).

Operation 11: Invoke a QMF analysis filter to perform signal decomposition.

The QMF analysis filter (2-channel QMF) is invoked, and downsampling is performed to obtain two sub-band signals, e.g., a low-frequency sub-band signal x_{LB}(n) and a high-frequency sub-band signal x_{HB}(n). Effective bandwidths of the low-frequency sub-band signal x_{LB}(n) and the high-frequency sub-band signal x_{HB}(n) are 0 to 8 kHz and 8 to 16 kHz, respectively, and a quantity of sample points of the low-frequency sub-band signal x_{LB}(n) and the high-frequency sub-band signal x_{HB}(n) is 320.

Operation 12: Invoke a second NN based on the low-frequency sub-band signal.

The second NN is invoked based on the low-frequency sub-band signal x_{LB}(n) to generate a lower-dimensional feature vector F_{LB}(n). A dimension of x_{LB}(n) is 320, and a dimension of F_{LB}(n) is 56. From the perspective of the data volume, the second NN realizes dimension reduction to implement a function of data compression. This embodiment of the disclosure is not limited to the dimension of F_{LB}(n), and other dimensions smaller than that of x_{LB}(n) are acceptable.

Referring to the network structure diagram of the second NN shown in FIG. 11, a process in which the second NN performs data compression is specifically described below.

First, a 16-channel causal convolution is invoked, and an input tensor (e.g., a vector) may be extended into a 16×320 tensor.

Then, the 16×320 tensor is preprocessed. For example, after a convolution operation is performed on the 16×320 tensor, a pooling operation with a factor of 2 is performed, and an activation function may be a PReLU to generate a 16×160 tensor.

Next, 4 encoding blocks having different downsampling factors (Down_factor) are cascaded. Each encoding block includes a residual block, a convolution layer, and a pooling layer. Each residual block includes 5 dilated convolution-based residual units (feature dimensions of the input and output of the residual unit may not change). The convolution layer is configured to double a quantity of input channels, and an activation function may be a PReLU, thereby ensuring the data volume and avoiding data loss. The pooling layer is a pooling operation including Down_factor to complete downsampling and implement data compression. Herein, Down_factors of the 4 encoding blocks are respectively set to 2, 4, 4, and 5. Therefore, quantities of output channels of the 4 encoding blocks are respectively set to 32, 64, 128, and 256. After being processed by the 4 encoding blocks, an input 16×160 tensor is converted into 32×80, 64×20, 128×5, and 256×1 tensors. The quantity of the encoding blocks is not limited in this embodiment of the disclosure, which may be any positive integer such as 2, 3, 4, or 5. In addition, in this embodiment of the disclosure, a quantity of residual units in an encoding block is not limited, which may be any positive integer such as 2, 3, 4, 5, or 6. Quantities of residual units in a plurality of encoding blocks may be the same or may be different. For example, one encoding block includes 4 residual units, and another encoding block includes 5 residual units.

The residual unit is further described herein. The residual unit refers to a module in a deep NN. A cross-layer connection is introduced in the NN so that the NN is optimized more easily in a training process, thereby avoiding problems such as gradient vanishing or gradient exploding. This is to perform residual learning on an input inside the module. For example, input information is directly transferred to an output by bypassing a part of layers through a direct path, so that the network may better utilize shallow feature information in the learning process. FIG. 12A is a schematic structural diagram of a residual block used in an encoding block in a second NN. The residual block includes 4 dilated convolution-based residual units, and each residual unit includes a dilated convolution block with a specified dilation rate. For example, each dilated convolution block includes a convolution operator with a specified dilation rate (e.g., dilation rate=3). In this embodiment of the disclosure, using 5 dilated convolution blocks with progressive dilation rates is equivalent to using different receptive fields to extract features of the input at different resolutions so that data can be better analyzed comprehensively. After residual processing of 5 dilated convolution blocks of specified dilation rates, the result is added to an input obtained through skip connection to obtain an output result of the residual block, and the output result is outputted to a convolution layer connected to the residual block.

Herein, any residual unit in FIG. 12A is further described, as shown in FIG. 12B. For any residual unit, at least one dilated convolution (configured for expanding a receptive field) with a specified dilation rate is included, and a PReLU may be used as an activation function. In addition, one or more causal convolution (configured for extracting local information) may be cascaded, and the PReLU may be used as the activation function. A convolution kernel size of the foregoing dilated convolution with a specified dilation rate may be 3, 5, 7, 9, or the like, and a convolution kernel size of the foregoing causal convolution may be 1, 3, or the like. The convolution kernel size of the foregoing dilated convolution of a specified dilation rate or the foregoing causal convolution is not limited in this embodiment of the disclosure. In addition, the causal convolution or the dilated convolution in this embodiment of the disclosure may further be implemented by another convolution unit with a specific similar or equivalent function.

In addition, for the residual unit, to reduce the algorithm complexity, a group convolution algorithm is introduced. The group convolution is to divide the input channels into a plurality of groups to perform a convolution operation, and only the input channels and the output channels in each group are associated. Herein, it is assumed that there are 16 input channels and 32 output channels. If the quantity of groups is 1, each input channel is associated with 32 output channels. If the quantity of groups is 2, the 16 input channels are first divided into two groups 0-7 and 8-15. In each of the two groups, the input channel is associated with the output channel in this group. For example, input channels 0-7 in the first group are associated with output channels 0-15, and input channels 8-15 in the second group are associated with output channels 16-31. For example, the output channel 0 is only associated with the input channels 0-7 and is not associated with the input channels 8-15, and the output channel 25 is only associated with the input channels 8-15 and is not associated with the input channels 0-7. As can be seen from such a comparison, the introduction of group convolution may prevent association of any input channel with all output channels and reduce a quantity of connections, thereby reducing the complexity. Certainly, a larger quantity of groups indicates smaller association between the input channel and the output channel, and affects the encoding effect. Therefore, a larger quantity of groups is not always better. In this embodiment of the disclosure, different configurations of the quantity of groups may be used for dilated convolution included in the 5 residual blocks corresponding to the 4 encoding blocks. Specific configurations of the number of groups are shown in Table 1.

TABLE 1
Configuration of quantities of groups used by
residual units in different encoding blocks

| Encoding block | Quantity of groups |
|---|---|
| Encoding block (Down_factor = 2) | 2 |
| Encoding block (Down_factor = 4) | 4 |
| Encoding block (Down_factor = 4) | 4 |
| Encoding block (Down_factor = 5) | 4 |

Finally, causal convolution similar to preprocessing is performed on the 256×1 tensor to output a 56-dimensional feature vector F_{LB}(n). According to the calculation of the second NN, each value in the 56-dimensional feature vector F_{LB}(n) falls within the range of [−1, 1].

Operation 13: Perform high-frequency analysis on the high-frequency sub-band signal x_{HB}(n).

An objective of high-frequency analysis is to extract key information of the high-frequency sub-band signal x_{HB}(n) and generate a lower-dimensional feature vector F_{HB}(n). This embodiment of the disclosure is not limited to the dimension of F_{HB}(n), and other dimensions smaller than that of x_{LB}(n) are acceptable, but the dimension of F_{HB}(n) is smaller than the dimension of F_{LB}(n).

In some embodiments, referring to operation 12, another structure similar to the second NN is introduced to generate a low-dimensional feature vector. Compared with the low-frequency sub-band signal, the high-frequency sub-band signal is less important for quality. Therefore, the structure of the NN for the high-frequency sub-band signal does not need to be as complex as that of the second NN. The structure of the NN for the high-frequency sub-band signal is similar to that of the second NN. However, compared with the structure of the second NN, the quantity of channels is greatly reduced in the structure of the NN for the high-frequency sub-band signal.

Some embodiments of the disclosure provide another method for compressing a high-frequency sub-band signal, e.g., bandwidth extension (recovering a wideband audio signal from a band-limited narrowband audio signal). Application of bandwidth extension in this embodiment of the disclosure is specifically described below.

For a high-frequency sub-band signal x_{HB}(n) including 320 points (e.g., sample points), the high-frequency sub-band signal x_{HB}(n) of 320 points is divided into two sub-frames (a first sub-frame and a second sub-frame), and each sub-frame includes 160 points. Compared to MDCT of 640 points with 50% overlap, using MDCT of 320 points with 50% overlap through framing can reduce an algorithmic delay by 10 ms. Therefore, the MDCT of 320 points may be performed 2 times on each 20 ms frame, to extract features.

For any sub-frame, e.g., the high-frequency sub-band signal including 160 points, MDCT is invoked to generate MDCT coefficients of 160 points. Specifically, if the overlap is 50%, a first sub-frame of an (n+1)^{th} frame and a second sub-frame of an n^{th} frame may be combined (spliced), MDCT of 320 points is calculated, and MDCT coefficients of 160 points of the first sub-frame of the (n+1)^{th} frame are obtained. The second sub-frame of an (n+1)^{th} frame is combined with the first sub-frame of the (n+1)^{th} frame, MDCT of 320 points is calculated, and MDCT coefficients of 160 points of the second sub-frame of the (n+1)^{th} frame are obtained.

The following processing is performed on the MDCT coefficients of 160 points in either of the foregoing 2 sub-frames in the same manner: dividing the MDCT coefficients of 160 points into N sub-bands. A sub-band herein is a group formed by a plurality of adjacent MDCT coefficients, and the MDCT coefficients of 160 points may be divided into 4 sub-bands. For example, the 160 points may be evenly allocated (e.g., each sub-band includes a same quantity of points). Certainly, in this embodiment of the disclosure, the 160 points cannot be non-uniformly divided. For example, a low-frequency sub-band includes fewer MDCT coefficients (higher frequency resolution), and a high-frequency sub-band includes more MDCT coefficients (lower frequency resolution).

According to Nyquist sampling theory (to recover an original signal from a sampled signal without distortion, a sampling frequency is to be greater than twice the highest frequency of the original signal; when the sampling frequency is less than twice the highest frequency of a spectrum, aliasing occurs in a spectrum of the signal; and when the sampling frequency is greater than twice the highest frequency of the spectrum, no aliasing occurs in the spectrum of the signal), the foregoing MDCT coefficients of 320 points represent a spectrum of 8 to 16 kHz. However, for ultra-wideband voice communication, the spectrum does not necessarily need to be set to 16 kHz. For example, if the spectrum is set to 14 kHz, only MDCT coefficients of the first 240 points need to be considered, and correspondingly, the number of sub-bands may be controlled to be 6.

For each sub-band, average energy of all MDCT coefficients in a current sub-band is calculated as a sub-band spectral envelope (the spectral envelope is a smooth curve passing through main peak points of the spectrum). For example, if the MDCT coefficients included in the current sub-band are x(n), n=1, 2, . . . , and 40, the average energy Y=((x(1)²+x(2)²+ . . . +x(40)²)/40) is calculated. In a case that the MDCT coefficients of 160 points are divided into 4 sub-bands, 4 sub-band spectral envelopes may be obtained. The 4 sub-band spectral envelopes are sub-band spectral envelopes F_{HB}⁽ⁱ⁾(n) corresponding to the sub-bands, where i=1 represents the first sub-frame, and i=2 represents the second sub-frame. A feature vector F_{HB}(n) of a high-frequency sub-band signal is obtained with reference to the sub-band spectral envelopes F_{HB}⁽ⁱ⁾(n) corresponding to two sub-bands.

In summary, through either of the foregoing two methods (the NN structure and the bandwidth extension), a 160-dimensional high-frequency sub-band signal may be outputted as a 4-dimensional feature vector. Therefore, for each 20 ms frame, only a minimum of 8-dimensional data is required to represent high-frequency information, and encoding efficiency is significantly improved.

Operation 14. Perform quantization encoding.

Scalar quantization (the components are quantized separately) and an entropy encoding method may be performed on the feature vector F_{LB}(n) of the low-frequency sub-band signal and the feature vector F_{HB}(n) of the high-frequency sub-band signal. In addition, in this embodiment of the disclosure, a technical combination of VQ (combining a plurality of adjacent components into a vector for joint quantization) and entropy encoding is not limited.

Herein, quantization encoding on the low-frequency feature vector F_{LB}(n) is described. According to the foregoing description, after the low-frequency sub-band signal is processed by using the second NN, a 56-dimensional feature vector F_{LB}(n) is obtained. Some embodiments of the disclosure provide a method based on scalar quantization and entropy encoding, including: 1) for each dimension in F_{LB}(n), the interval [−1, 1] is evenly divided into 11 equal parts to form a codebook including 11 elements, and each dimensional value is quantized into one of the 11 elements; 2) according to Shannon's entropy theorem, for a codebook including 11 uniformly distributed elements, the entropy (average bits) is −1*log 2( 1/11)=3.46 bits, so an average number of bits per frame for the low-frequency sub-band signal is 193.76 bits; and 3) for the framing mode with a frame length of 20 ms, there are 50 frames per second, so an average bit rate is 9.69 kbps. According to an entropy encoding theory, probability distribution statistics may be performed on each of the foregoing dimensions, to generate 56 codebooks. Generally, dimensions are unevenly distributed, so an actual bit rate is around 9.69 kbps or is less than 9.69 kbps.

In addition, to achieve an objective of multi-rate encoding and decoding on the low-frequency feature vector FLB(n), the following implementation forms may be adopted.

The codebook in the foregoing implementation (e.g., the codebook including 11 elements in each dimension) is named a low-frequency codebook −1, with a reference bit rate of 9.69 kbps.

Similarly, for each dimension, the interval [−1, 1] is evenly divided into 9 equal parts, the entropy is 3.17, and the average bit rate is 3.17*56*50/1000=8.88 kbps. It is named a low-frequency codebook −2, with a reference bit rate of 8.88 kbps. In this way, there are at least 2 bit rate modes, and different bit rates correspond to different quality, thereby implementing multi-rate encoding.

The rest can be deduced by analogy. For each dimension, the interval [−1, 1] is evenly divided into 7 equal parts, with the average bit rate of 7.86 kbps, which is named a low-frequency codebook −3. The interval [−1, 1] is evenly divided into 5 equal parts, with the average bit rate of 6.50 kbps, which is named a low-frequency codebook −4.

In this way, for an original 56-dimensional feature vector calculated for each frame of data, encoding modes of low-frequency features of at least 4 bit rate modes are achieved through the configuration of quantization precision. In this embodiment of the disclosure, other multi-bit-rate construction modes and codebook quantities are not limited.

For the feature vector F_{HB}(n) of the 8-dimensional high-frequency sub-band signal in each frame (including 2 sub-frames), a specific implementation of quantization encoding thereof includes: 1) performing scalar quantization separately for each dimension, and allocating 5 bits, so that 40 bits are allocated per frame; and 2) for the framing mode with a frame length of 20 ms, there are 50 frames per second, so an average bit rate is 2 kbps. If entropy encoding (including, but not limited to, Huffman coding or range coding) is performed on each of the foregoing dimension quantization values, an overall bit rate may be less than 2 kbps. The codebook is defined as a high-frequency codebook −1, and the quantization value is defined as a high-frequency feature vector quantization value (e.g., a quantization value of a high-frequency feature).

In addition, to achieve an objective of multi-rate encoding and decoding on the high-frequency feature vector F_{HB}(n), residual processing may be further introduced. The following implementation forms may be adopted.
1) For each 10 ms sub-frame, 4 sub-bands of the sub-frame are further evenly divided into 2 subsets.

For example, a set of envelope values of the 4 sub-bands is {e₁, e₂, e₃, e₄}.
2) For each subset of each sub-band, an envelope value of the subset is calculated.

For example, a set of the envelope values of all the subsets is {e₁ₐ, e_{1b}, e₂ₐ, e_{2b}, e₃ₐ, e_{3b}, e₄ₐ, e_{4b}}.
3) A quantization value of a corresponding high-frequency feature vector is subtracted from the envelope value of each subset to obtain a first high-frequency feature vector residual (briefly referred to as a first residual value).

For example, if the quantization value of the high-frequency feature vector is { [symbol] }, the first high-frequency feature vector residual is {e₁ₐ- [symbol] , e_{1b}- [symbol] , e₂ₐ- [symbol] , e_{2b}- [symbol] , e₃ₐ- [symbol] , e_{3b}- [symbol] , e₄ₐ- [symbol] , e_{4b}- [symbol] }.
4) Similar quantization and entropy encoding are performed on the foregoing first high-frequency feature residual to obtain a quantization value of the first high-frequency feature vector residual (briefly referred to as a quantization value of the first residual value).

Herein, considering that a dynamic range of a residual value is much lower than that of an original value, when scalar quantization is performed on each residual, only 2 bits need to be allocated. In this way, a reference bit rate (similarly, due to the use of entropy encoding of non-uniform distribution, an actual bit rate is generally less than 1.6 kbps) of 2*16*50=1.6 kbps is required, to obtain the quantization value of the first high-frequency feature vector residual.
5) A sum of the quantization value of the corresponding high-frequency feature vector and the quantization value of the first high-frequency feature vector residual is subtracted from the envelope value of each subset to obtain a second high-frequency feature vector residual (briefly referred to as a second residual value).

Herein, similarly, quantization and entropy encoding of the second high-frequency feature vector residual may be completed by using a reference bit rate of 1.6 kbps.

The rest can be deduced by analogy. As more residuals are calculated, it can be ensured that the high-frequency feature vector reconstructed at the decoder side is infinitely approximate to the original high-frequency feature vector. In addition, a multi-rate encoding effect is achieved according to presence or absence of the high-frequency feature vector residual or on a quantity of high-frequency feature vector residuals. In this embodiment of the disclosure, a quantity of types of residual encoding (no residual encoding, a first high-frequency feature vector residual, a second high-frequency feature vector residual, a third high-frequency feature vector residual, and the like) may be defined according to a bit rate requirement, which is not limited herein.

In addition, some embodiments of the disclosure provide a solution of additionally extracting side information at an encoder side, to instruct a decoder side to perform more refined processing, so as to improve audio quality. In principle, a main function of bandwidth extension is to replicate a low-frequency spectrum to a high frequency, and then perform gain processing. However, relative to a low-frequency spectrum, a high-frequency spectrum is flatter and has fewer harmonics. If direct replication is performed, an artificially generated high frequency includes excessive harmonics. Therefore, some embodiments of the disclosure proposes that particular side information is estimated at the encoder side and is written to a bitstream. The decoder side determines, based on the foregoing flatness side information, whether to perform additional processing at the decoder side. The foregoing flatness side information may only indicate at the decoder side whether additional processing is required for a current frame. In a special case, no additional processing is required for an entire voice.

The foregoing side information estimation is implemented at the encoder side as follows.
1) For each 10 ms sub-frame, the MDCT coefficients of 160 points are divided into two blocks. Uniform partition may be performed, or MDCT coefficients of first 2 sub-bands may be used as a first block, and MDCT coefficients of last 2 sub-bands may be used as a second block.
2) For each block, a power of each MDCT coefficient is calculated (e.g., p(i)=c(i)²).
3) An arithmetic mean

$${ave}_{a} = \frac{{\sum }_{i} p ( i )}{I}$$

of all MDCT coefficients in a current block is calculated, where I represents a quantity of MDCT coefficients of the current block.
4) A geometric mean

$${ave}_{g} = \frac{{\sum }_{i} In ( p ( i ) )}{I}$$

of all the MDCT coefficients of the current block is calculated, where In represents a logarithmic operation, and I represents a quantity of MDCT coefficients of the current block.
5) First flatness of the current block

$${sfp}_{H i} = \frac{{e}^{{ave}_{g}}}{{ave}_{a}}$$

is calculated. Generally, sfp_{Hi} is a value in a range of [0, 1].
6) Similarly, second flatness sfp_{Lo} of an MDCT coefficient of a low-frequency specified frequency band is calculated.
7) When (sfp_{Hi}[i]<sfp_{Lo}[i]) or (sfp_{Hi}[i]<SP_THD), Sfp_FLAG=0. Otherwise, Sfp_FLAG=1. SF_THD represents a set flatness threshold, and Sfp_FLAG represents flatness side information.

Herein, if Sfp_FLAG=1, it indicates that additional processing is required at the decoder side to prevent excessive artificial harmonics at the high frequency. According to the foregoing operation, each frame requires an additional 4 bits to represent flatness side information of two blocks in 2 sub-frames of 10 ms. Some embodiments of the disclosure are not limited to the foregoing extraction mode, and another analysis mode may alternatively be adopted to extract the foregoing flatness side information, to instruct the decoder side to perform decoding subsequently.

After quantization encoding, a bitstream may be generated. According to an experiment, in a range of 5 to 10 kbps, high-quality compression can be implemented for a 16 kHz wideband signal. In a range of 8 to 15 kbps, high-quality compression can be implemented for a 32 kHz ultra-wideband signal.

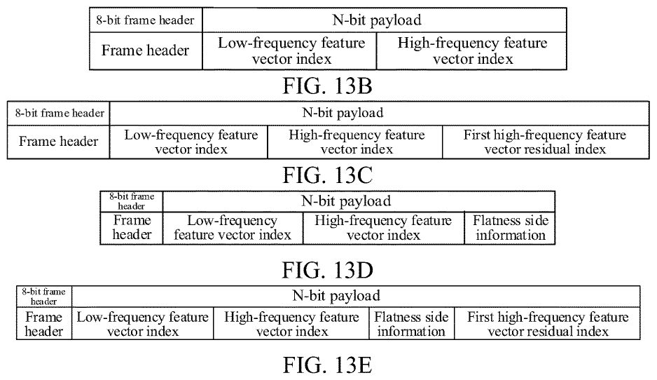

In addition, to achieve the foregoing objective of multi-mode multi-rate encoding and decoding, a bitstream structure needs to be designed. As shown in FIG. 13A to FIG. 13E, an implementation form of a bitstream structure is as follows.

Each frame of bitstream generally includes an 8-bit frame header. The 8-bit frame header includes at least a 1-bit encoding mode bit, and it can be known according to the 1-bit encoding mode bit whether wideband encoding (a value of the 1-bit encoding mode bit is 0) or ultra-wideband encoding (a value of the 1-bit encoding mode bit is 1) is used. The encoding mode includes two types (wideband encoding and ultra-wideband encoding). In addition, a 2-bit encoding rate bit is further included, and it can be known according to the 2-bit encoding rate bits which bit rate mode is used in a corresponding wideband encoding mode or ultra-wideband encoding mode. Positions of the 1-bit encoding mode bit and the 2-bit encoding rate bit in the frame header are not limited in some embodiments of the disclosure. For example, the 1-bit encoding mode bit may reside in the first bit of the frame header, and the 2-bit bit rate mode may reside in the last two bits of the frame header.

As shown in FIG. 13A, for the wideband encoding mode, the frame header is immediately followed by a 56-dimensional low-frequency feature vector index. Since entropy encoding is performed, encoding lengths vary. As described above, according to a 2-bit rate mode bit, a low-frequency bitstream obtained after quantization encoding is performed by using different low-frequency codebooks is stored in the part of the 56-dimensional low-frequency feature vector index.

The 2-bit encoding rate bit in the wideband encoding mode is explained as follows.
1) 00 indicates that the low-frequency codebook −4 is used, with the reference average bit rate of 6.5 kbps, which is also the lowest bit rate in the wideband encoding mode.
2) 01 indicates that the low-frequency codebook −3 is used, with the reference average bit rate of 7.86 kbps.
3) 10 indicates that the low-frequency codebook −2 is used, with the reference average bit rate of 8.88 kbps.
4) 11 indicates that the low-frequency codebook −1 is used, with the reference average bit rate of 9.69 kbps, which is also the highest bit rate in the wideband encoding mode.

For the ultra-wideband encoding mode, the 2-bit rate mode bit is defined according to whether residual encoding is used. The 2-bit encoding rate bit in the ultra-wideband encoding mode is explained as follows.
1) 00 (not including residual encoding) indicates that the low-frequency codebook −4 is used for the low-frequency part, a bitstream encapsulation structure includes quantization encoding using the low-frequency codebook −4, 4 spectral envelopes for ultra-wideband encoding, and 4-bit flatness, and the reference average bit rate is 6.5+2+0.2=8.7 kbps.
2) 01 (not including residual encoding) indicates that the low-frequency codebook −1 is used for the low-frequency part, the bitstream encapsulation structure includes quantization encoding using the low-frequency codebook −1, 4 spectral envelopes for ultra-wideband encoding, and 4-bit flatness, and the reference average bit rate is 9.69+2+0.2=11.9 kbps.
3) 10 (including first residual encoding) indicates that the low-frequency codebook −1 is used for the low-frequency part, the bitstream encapsulation structure includes quantization encoding using the low-frequency codebook −1, 4 spectral envelopes for ultra-wideband encoding, 8 first residuals, and 4-bit flatness, and the reference average bit rate is 9.69+2+1.6+0.2=13.5 kbps.
4) 11 (including first residual encoding and second residual encoding) indicates that the low-frequency codebook −1 is used for the low-frequency part, the bitstream encapsulation structure includes quantization encoding using the low-frequency codebook −1, 4 spectral envelopes for ultra-wideband encoding, 8 first residuals, 8 second residuals, and 4-bit flatness, and the reference average bit rate is 9.69+2+1.6+1.6+0.2=15.0 kbps.

As shown in FIG. 13A to FIG. 13C, according to the 2-bit rate mode bit, related bitstreams of a low-frequency feature vector index and a high-frequency feature vector index are placed immediately after a frame header. As shown in FIG. 13D to FIG. 13E, if the bitstream encapsulation structure includes 4-bit flatness side information, the 4-bit side information may be placed immediately after the 8-dimensional high-dimensional feature vector index.

In summary, when audio encoding is performed by using an encoder, a user may input to-be-encoded voice data and a correct configuration parameter to the encoder. For example, when the input voice data is wideband, a sampling rate is 16000 Hz, and when the input voice data is ultra-wideband, the sampling rate is 32000 Hz. For ease of description, a wideband signal based on 16000 Hz sampling and an ultra-wideband signal based on 32000 Hz sampling are used as examples. However, other combinations are not limited in some embodiments of the disclosure.

In addition, the user needs to configure a configuration parameter of a used bit rate mode, and the encoder may select an appropriate codebook according to the configured bit rate mode. Generally, a higher bit rate mode indicates that the encoder may use more bits for encoding, and correspondingly, a reconstructed voice has higher quality. As shown above, in some embodiments of the disclosure, 4 bit rate modes are provided for both the wideband encoding mode and the ultra-wideband encoding mode. However, some embodiments of the disclosure are not limited to the 4 bit rate modes.

For example, when the user inputs a wideband signal based on 16000 Hz sampling, the encoder may perform encoding by using the wideband encoding mode, directly use the second NN for the inputted wideband signal, to extract a low-frequency feature, and perform quantization encoding on the extracted low-frequency feature, to obtain a bitstream of the wideband signal. When the user inputs an ultra-wideband signal based on 32000 Hz sampling, the encoder may perform encoding by using the ultra-wideband encoding mode. The input ultra-wideband signal first passes through an analysis filter, to separate a low-frequency sub-band signal and a high-frequency sub-band signal. The second NN is directly used for the low-frequency sub-band signal, to extract a low-frequency feature F_{LB}(n). Quantization encoding is performed on F_{LB}(n) to obtain a low-frequency bitstream. High-frequency analysis is performed on a high-frequency sub-band signal, to extract a high-frequency feature F_{HB}(n). Quantization encoding is performed on F_{HB}(n) to obtain a high-frequency bitstream. In addition, according to a bit rate mode inputted at the encoder side, the encoder may select a corresponding codebook for quantization encoding.

A procedure of a low-frequency part and a high-frequency part at a decoder side is as follows.

Operation 21: Perform quantization decoding.

Quantization decoding is an inverse process of quantization encoding. Entropy decoding is first performed on a received bitstream (including a high-frequency bitstream and a low-frequency bitstream), and an estimated value F′_{LB} (n) of a feature vector of the low-frequency bitstream and an estimated value F′_{HB}(n) of a feature vector of the high-frequency bitstream are obtained by looking up a quantization table.

Referring to FIG. 13E, the configuration of the ultra-wideband encoding mode with the rate mode bit of 10 is taken as an example for the following description.

First, a frame header of a bitstream encapsulation is parsed. When the encoding mode bit is 1, it indicates that ultra-wideband encoding is used during encoding. When the bit rate mode bit is 10, it indicates that during encoding, the low-frequency codebook −1 is used for the wideband part, and after the ultra-wideband part is encoded, the encapsulated bitstream includes an 8-dimensional high-frequency feature vector index and a 16-dimensional first high-frequency feature vector residual index.

For the wideband part, a low-frequency bitstream is parsed by using an entropy encoding and decoding technology, and an estimated value F′_{LB}(n) of a 56-dimensional low-frequency feature vector may be obtained by using the low-frequency codebook −1.

For the ultra-wideband part, first, based on a 5-bit codebook, an estimated value of an 8-dimensional high-frequency feature vector is obtained per frame. Then, based on a 2-bit codebook, an estimated value of a 16-dimensional first high-frequency feature vector residual is obtained per frame. A final estimated value of a 16-dimensional high-frequency feature vector (e.g., the final estimated value of the high-frequency feature above) may be obtained through the corresponding estimated value of the 8-dimensional high-frequency feature vector (e.g., the estimated value of the high-frequency feature above) and the estimated value of the 16-dimensional first high-frequency feature vector residual (e.g., the estimated value of the first residual feature above). An i^{th} value in the estimated value of the high-frequency feature vector is respectively added to a (2i−1)^{th} value and a 2i^{th} value in the estimated value of the first high-frequency feature vector residual, to respectively obtain a (2i−1)^{th} value and a 2i^{th} value in the final estimated value of the high-frequency feature vector. For example, if the estimated value of the high-frequency feature is F′_{HB}(n)=[e′₁, e′₂, . . . , e′₈] and the estimated value of the first high-frequency feature vector residual is F′_{C}(n)=[e′_{1C}, e′_{2C}, . . . , e′_{16C}], the final estimated value of the high-frequency feature vector is F′_{FHB}(n) [e′₁+e′_{1C}, e′₁+e′_{2C}, . . . , e′₈+e′_{16C}].

Referring to FIG. 13D, configuration of an ultra-wideband encoding mode with a rate mode bit of 01 is taken as an example for the following description.

First, a frame header of a bitstream encapsulation is parsed. When the encoding mode bit is 1, it indicates that ultra-wideband encoding is used during encoding. When the rate mode bit is 01, it indicates that during encoding, the low-frequency codebook −1 is used for the wideband part, and after the ultra-wideband part is encoded, the bitstream encapsulation includes 8-dimensional high-frequency feature vector indices.

For the wideband part, a low-frequency bitstream is parsed by using an entropy encoding and decoding technology, and an estimated value F′_{LB}(n) of a 56-dimensional low-frequency feature vector may be obtained by using the low-frequency codebook −4.

For the ultra-wideband part, first, based on a 5-bit codebook, an estimated value of an 8-dimensional high-frequency feature vector is obtained per frame, and the estimated value of the 8-dimensional high-frequency feature vector is replicated to obtain a final estimated value of a 16-dimensional high-frequency feature vector (e.g., the final estimated value of the high-frequency feature above). For example, if the estimated value of the high-frequency feature is F′_{HB}(n)=[e′₁, e′₂, . . . , e′₈], the final estimated value of the high-frequency feature is F′_{FHB}(n)=[e′₁, e′₁, . . . , e′₈, e′₈].

Configuration of an ultra-wideband encoding mode with a rate mode bit of 11 is taken as an example for the following description.

First, a frame header of a bitstream encapsulation is parsed. When the encoding mode bit is 1, it indicates that ultra-wideband encoding is used during encoding. When the rate mode bit is 11, it indicates that during encoding, the low-frequency codebook −1 is used for the wideband part, and after the ultra-wideband part is encoded, the bitstream encapsulation includes 8-dimensional high-frequency feature vector indices, 16-dimensional first high-frequency feature vector residual indices, and 16-dimensional second high-frequency feature vector residual indices.

For the wideband part, a low-frequency bitstream is parsed by using an entropy encoding and decoding technology, and an estimated value F′_{LB}(n) of a 56-dimensional low-frequency feature vector may be obtained by using the low-frequency codebook −1.

For the ultra-wideband part, first, based on a 5-bit codebook, an estimated value of an 8-dimensional high-frequency feature vector is obtained per frame. Then, based on a 2-bit codebook, an estimated value of a 16-dimensional first high-frequency feature vector residual and an estimated value of a 16-dimensional second high-frequency feature vector residual are obtained per frame. A final estimated value of a 16-dimensional high-frequency feature vector (e.g., the final estimated value of the high-frequency feature above) may be obtained through the corresponding estimated value of the 8-dimensional high-frequency feature vector (e.g., the estimated value of the high-frequency feature above), the estimated value of the 16-dimensional first high-frequency feature vector residual (e.g., the estimated value of the first residual feature above), and the estimated value of the 16-dimensional second high-frequency feature vector residual (e.g., the estimated value of the second residual feature above). An i^{th} value in the estimated value of the high-frequency feature vector is added to a (2i−1)^{th} value in the estimated value of the first high-frequency feature vector residual and a (2i−1)^{th} value in the estimated value of the second high-frequency feature vector residual, to obtain a (2i−1)^{th} value in the final estimated value of the high-frequency feature vector. The i^{th} value in the estimated value of the high-frequency feature vector is added to a 2i^{th} value in the estimated value of the first high-frequency feature vector residual and a 2i^{th} value in the estimated value of the second high-frequency feature vector residual, to obtain a 2i^{th} value in the final estimated value of the high-frequency feature vector. For example, if the estimated value of the high-frequency feature is F′_{HB}(n)=[e′₁, e′₂, . . . , e′₈], the estimated value of the first high-frequency feature vector residual is F′_{C}(n)=[e′_{1C}, e′_{2C}, . . . , e′_{16C}], and the estimated value of the second high-frequency feature vector residual is F′_{B}(n)=[e′_{1B}, e′_{2B}, . . . , e′_{16B}], the final estimated value of the high-frequency feature is F′_{FHB}(n)=[e′₁+e′_{1C}+e′_{1B}, e′₁+e′_{2C}+e′_{2B}, . . . , e′₈+e′_{16C}+e′_{16B}].

Operation 22: Invoke a third NN based on the estimated value F′_{LB}(n) of the feature vector of the low-frequency bitstream.

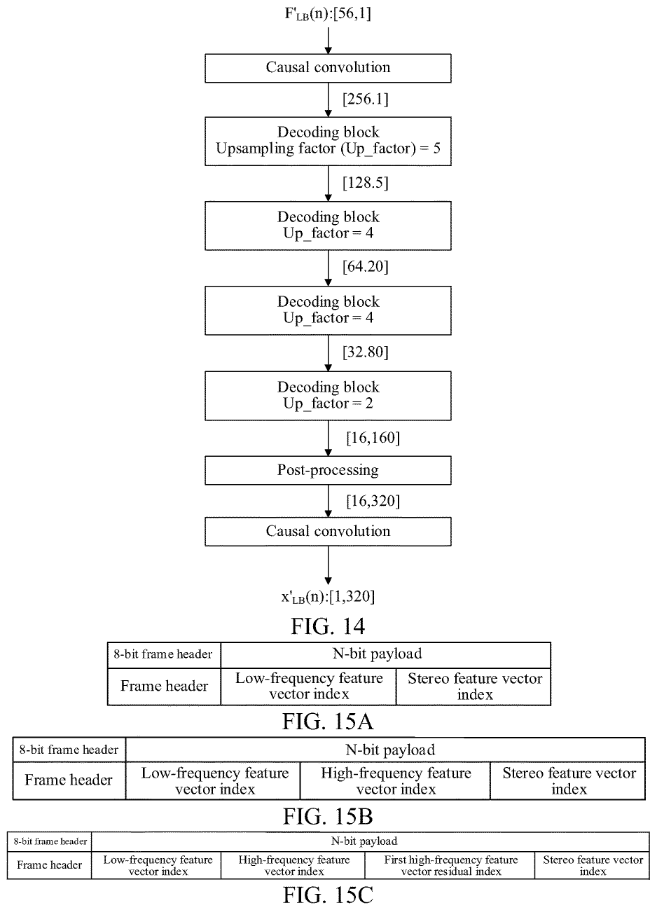

First, the third NN as shown in FIG. 14 is invoked based on the estimated value F′_{LB}(n) of the feature vector of the low-frequency bitstream, to generate an estimated value x′_{LB} (n) of the low-frequency sub-band signal. The third NN is similar to the second NN, for example, causal convolution, and a post-processing structure is similar to the preprocessing structure in the second NN. A structure of the decoding block is symmetric to that of the encoding block at the encoding side. Dilated convolution is first performed on the encoding block at the encoding side, and then pooling is performed to complete downsampling. Pooling is first performed on the decoding block at the decoding side to complete upsampling, and then dilated convolution is performed. A specific procedure of the third NN is as follows.

First, a causal convolution is invoked to extend an input tensor F′_{LB}(n) from 56×1 to 256×1.

Next, 4 decoding blocks having different upsampling factors (Up_factor) are cascaded. Each decoding block includes a convolution layer, an upsampling module, and a residual block. The convolution layer is configured to half the number of input channels. The upsampling module includes a specific Up_factor to complete upsampling. One residual block includes 5 dilated convolution-based residual units. Up_factors of the 4 decoding blocks are set to 5, 4, 4, and 2. Therefore, quantities of output channels of the 4 decoding blocks are respectively set to 128, 64, 32, and 16. After being processed by the 4 decoding blocks, the 256×1 tensor is converted into 128×5, 64×20, 32×80, and 16×160 tensors. The quantity of the decoding blocks is not limited in this embodiment of the disclosure, which may be any positive integer such as 2, 3, 4, or 5.

Herein, for the upsampling module including a specific Up_factor, the upsampling operation may be completed through repeated padding by using a replication (repeat) operation. In this way, complexity can be reduced.

Herein, configuration of the 5 dilated convolution-based residual units of the decoder side is similar to configuration of the residual unit of the encoder side, including but not limited to, an internal structure of the residual unit, a convolution kernel size, a dilation rate, and the like. Configuration of a quantity of groups used by dilated convolution in the decoding block is shown in Table 2. Herein, in the decoding block, the quantity of groups being 2 is frequently used, to associate more input channels and output channels, thereby improving the quality of voice reconstruction.

TABLE 2
Configuration of quantities of groups used by
residual units in different decoding blocks

| Decoding block | Quantity of groups |
|---|---|
| Decoding block (Up_factor = 5) | 4 |
| Decoding block (Up_factor = 4) | 4 |
| Decoding block (Up_factor = 4) | 2 |
| Decoding block (Up_factor = 2) | 2 |

Then, the 16×160 tensor outputted by the cascade decoding block is post-processed. For example, a repeat operation with a factor of 2 is performed on the 16×160 tensor outputted by the cascade decoding block to complete upsampling. Then, a convolution operation is performed, and an activation function may be a PReLU to generate a 16×320 tensor.

Finally, a causal convolution is invoked, and an input 16×320 tensor may be converted into a 1×320 tensor to reconstruct a low-frequency sub-band signal.

Operation 23: Perform high-frequency reconstruction on the estimated value F′_{HB}(n) of the feature vector of the high-frequency sub-band signal.

Similar to the high-frequency analysis at the encoder side, high-frequency reconstruction in this embodiment of the disclosure includes two solutions.

A first implementation of high-frequency reconstruction, corresponds to the first implementation of high-frequency analysis at the encoder side. Based on the estimated value F′_{HB}(n) of the feature vector of the high-frequency sub-band signal, the NN is invoked to generate an estimated value x′_{HB} (n) of the high-frequency sub-band signal.

A second implementation of high-frequency reconstruction corresponds to the bandwidth extension technology of high-frequency analysis at the encoder side. The following operations are performed based on 16 MDCT sub-band spectral envelopes (each 10 ms sub-frame includes 8 sub-band spectral envelopes) decoded from the high-frequency bitstream (e.g., the final estimated value of the high-frequency feature vector).

First, MDCT of 320 points is also performed twice on the estimated value x′_{LB}(n) of the low-frequency sub-band signal generated at the decoder side, to generate two groups of MDCT coefficients of 160 points (e.g., MDCT coefficients of the low-frequency part, including a first group of MDCT coefficients of 160 points and a second group of MDCT coefficients of 160 points).

Then, the MDCT coefficients of 160 points generated by x′_{LB}(n) are replicated to generate MDCT coefficients of the high-frequency part. With reference to a basic feature of a voice signal, there are more harmonics in the low-frequency part and fewer harmonics in the high-frequency part. Therefore, to avoid that the manually generated MDCT spectrum of the high-frequency part includes excessive harmonics due to simple replication, the last 80 points in the MDCT coefficients of 160 points on which the low-frequency sub-band depends may be used as a master template, and the spectrum is replicated 2 times to generate a reference value of MDCT coefficients of 160 points of the high-frequency sub-band signal.

If the bitstream encapsulation includes flatness side information, additional processing is required. When Sfp_FLAG==0, no operation is performed. When Sfp_FLAG==1, an additional flattening operation is required. An implementation form of the flattening operation is as follows.

Using an MDCT coefficient c(i) at an i^{th} position as an example, an average power spectrum eₐᵥₑ(i) of a neighborhood of c(i) is calculated, as shown in Formula (3).

$${e}_{ave} ( i ) = \sqrt{\frac{{c ( i - 1 )}^{2} + {c ( i )}^{2} + {c ( i + 1 )}^{2}}{e}} \qquad ( 3 )$$

where c(i−1) represents an MDCT coefficient at an (i−1)^{th} position, and c(i+1) represents an MDCT coefficient at an (i+1)^{th} position.

When eₐᵥₑ(i)==0, smoothing processing is not performed on the MDCT coefficient c(i) at the i^{th} position (e.g., c(i)=c(i)). Otherwise, smoothing processing is performed on the MDCT coefficient c(i) at the i^{th} position. c(i) is updated to a ratio of c(i) to eₐᵥₑ(i), e.g., c(i)=c(i)/eₐᵥₑ(i).

After the flattening operation is performed, the previously obtained 8 sub-band spectral envelopes (e.g., the 8 sub-band spectral envelopes obtained by querying the quantization table) are invoked. The 8 sub-band spectral envelopes correspond to 8 high-frequency sub-bands, and the generated reference value of the MDCT coefficients of 160 points of the high-frequency sub-band signal is divided into 8 reference high-frequency sub-bands. Based on a high-frequency sub-band and a corresponding reference high-frequency sub-band, gain processing is performed on the generated reference value of the MDCT coefficients of 160 points of the high-frequency sub-band signal (multiplication is performed in a frequency domain). For example, a gain factor is calculated according to average energy of the high-frequency sub-band and average energy of the corresponding reference high-frequency sub-band, and an MDCT coefficient corresponding to each point in the corresponding reference high-frequency sub-band is multiplied by the gain factor to ensure that energy of a high-frequency MDCT coefficient virtually generated through decoding is close to original coefficient energy of the encoder side.

For example, it is assumed that average energy of a reference high-frequency sub-band (e.g., a sub-band obtained by dividing generated reference values of MDCT coefficients of 160 points of a high-frequency part signal) is Y_L, and average energy of a current high-frequency sub-band (e.g., a sub-band corresponding to a sub-band spectral envelope obtained by decoding based on a bitstream) is Y_H, a gain factor a=sqrt(Y_H/Y_L) is calculated, where sqrt( ) represents a square root calculation function configured for calculating a square root of (Y_H/Y_L). After the gain factor a is provided, an MDCT coefficient of each point in the reference high-frequency sub-band is directly multiplied by a. The average energy of the MDCT coefficient (virtually generated) obtained after gain processing is very close to the original average energy of the encoder side.

Finally, inverse MDCT is invoked to generate an estimated value of a first sub-frame of the high-frequency sub-band signal (an estimated value of a sub-frame calculated by using the first group of MDCT coefficients of 160 points) and an estimated value of a second sub-frame of the high-frequency sub-band signal (an estimated value of a sub-frame calculated by using the second group of MDCT coefficients of 160 points), and the estimated value x′_{HB}(n) of the high-frequency sub-band signal is obtained by combining the estimated value of the first sub-frame and the estimated value of the second sub-frame. Inverse MDCT is performed on the MDCT coefficients of 320 points obtained after gain processing, to generate estimated values of 640 points. Through overlapping, estimated values of the first 320 effective points are used as x′_{HB}(n).

Operation 24: Synthesis filter.

After the decoder side obtains the estimated value x′_{LB}(n) of the low-frequency sub-band signal and the estimated value x′_{HB}(n) of the high-frequency sub-band signal, only upsampling and invoking the QMF synthesis filter is required to generate a reconstructed signal x′(n) of 640 points.

In this embodiment of the disclosure, related networks of the encoder side and the decoder side may be jointly trained by acquiring data, to obtain an optimal parameter. The user only needs to prepare data and set a corresponding network structure. After training is completed in the backend, a trained model may be used.

In a voice communication system, communication manners include mono voice communication and stereo communication. Therefore, this embodiment of the disclosure is not limited to the foregoing mono voice communication encoding and decoding technology, which may alternatively be a stereo encoding and decoding technology. The stereo encoding and decoding technology may implement that an encoder receives signals from left and right channels (e.g., a left-channel input signal and a right-channel input signal), so that the user may have a particular sense of left-right space when wearing an earphone to make a call.

The audio encoding method and the audio decoding method provided in some embodiments of the disclosure are described below with reference to a stereo signal.

A stereo encoding mode in this embodiment of the disclosure includes, but is not limited to, the following two manners for implementation: (1) the left and right channels respectively employ the foregoing mono signal encoding and decoding technology for encoding and decoding, and a stereo signal is restored at a decoder side by combining a decoded mono reconstructed signal; and 2) a parameter stereo technology is used for encoding and decoding.

A parametric stereo encoding technology is a technology of effectively encoding a stereo signal as a mono signal plus a small part of parameter overhead for describing stereo image information. At the encoder side, the input signals from the left and right channels (e.g., stereo signals) are downmixed into a signal. The signal is treated as the foregoing input signal x(n), which is then encoded using the mono signal encoding method described in this embodiment of the disclosure. In addition, feature information (e.g., a stereo feature vector, generally 1 to 2 kbps) of correlation between the left and right channels is extracted through parametric stereo encoding, and the stereo feature vector is configured for mixing mono side information. At the decoder side, a downmixed signal (e.g., the foregoing reconstructed signal) is obtained through decoding. Stereo signals for the left and right channels are reconstructed by using the downmixed signal obtained through decoding and the stereo feature vector that describes the correlation between the left and right channels.

Following the foregoing embodiments, for an 8-bit frame header in the bitstream encapsulation, a 1-bit channel bit may be allocated, and it may be known, according to a 1-bit stereo encoding bit, whether mono encoding or stereo encoding is used. A specific implementation is as follows.

At the encoder side, if the quantity of input channels is 1, a channel flag is set to 0, and 0 is written to the channel bit corresponding to the frame header, indicating that mono encoding is performed on the input signal. The foregoing encoding mode for the input signal x(n) is reused for encoding. If the quantity of input channels is 2 (e.g., stereo), the channel flag is set to 1, and 1 is written to the channel bit of the corresponding frame header, indicating that stereo encoding is performed on the input signal, where the parametric stereo encoding mode described above is reused for encoding.

At the decoder side, the channel bit corresponding to the frame header is parsed. If the channel bit is 0, it indicates mono decoding, and the foregoing decoding mode is reused to decode the reconstructed signal. If the channel bit is 1, it indicates stereo decoding, and the parametric stereo decoding mode described above is reused for decoding.

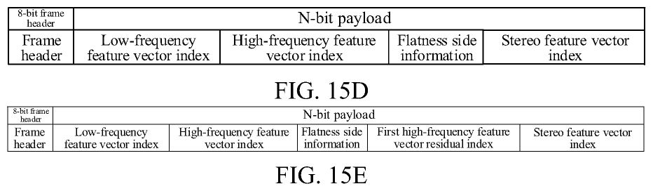

The bitstream encapsulation as shown in FIG. 15A to FIG. 15E, carries a stereo feature vector based on the bitstream encapsulation shown in FIG. 13A to FIG. 13E. At the decoder side, the stereo signals for the left and right channels are reconstructed by using the downmixed signal obtained through decoding and the stereo feature vector that describes the correlation between the left and right channels.

In addition, for the 8-bit frame header in the bitstream encapsulation, the channel bit may not be allocated. For example, if there is no channel bit, mono encoding is used by default.

The frame header in some embodiments of the disclosure is not limited to 8 bits, which may be more or fewer bits. In another embodiment, more bits may alternatively be allocated to the channel bit, for example, a 2-bit channel bit, to represent encoding and decoding for more channels, for example, 3.1 channels or 4.1 channels.

In summary, compared with the signal processing solution, through an organic combination of the signal decomposition and signal processing technology and the deep NN, the multi-mode, multi-rate encoding and decoding method provided in some embodiments of the disclosure significantly improves audio quality while ensuring acceptable complexity.

The audio encoding method or the audio decoding method provided in some embodiments of the disclosure is described with reference to exemplary application and implementations of the terminal device provided in some embodiments of the disclosure. Some embodiments of the disclosure further provide a method for processing a bitstream. The bitstream is decoded based on the foregoing audio decoding method or is generated according to the foregoing audio encoding method.

The audio encoding method or the audio decoding method provided in some embodiments of the disclosure is described with reference to exemplary application and implementations of the terminal device provided in some embodiments of the disclosure. Some embodiments of the disclosure further provide an audio encoding apparatus and an audio decoding apparatus. In actual application, functional modules in the audio encoding apparatus and the audio decoding apparatus may be cooperatively implemented by a hardware resource of an electronic device (e.g., a terminal device, a server, or a server cluster), a computing resource such as a processor, a communication resource (e.g., configured for supporting implementation of communication in various modes such as an optical cable and a cellular mode), and a memory. FIG. 3A shows the audio encoding apparatus 555 stored in the memory 550, and FIG. 3B shows the audio decoding apparatus 655 stored in the memory 650. The apparatus may be software in the form of a program, a plug-in, or the like, e.g., an implementation such as a software module designed in a programming language such as C/C++ or Java, application software designed in the programming language such as C/C++ or Java, a dedicated software module in a large software system, an application programming interface, a plug-in, or a cloud service. Different implementations are exemplified below.

The audio encoding apparatus 555 includes a series of modules, including a second acquisition module 5551, an extraction module 5552, and a signal encoding module 5553. The following continues to describe a solution in which the modules in the audio encoding apparatus 555 provided in this embodiment of the disclosure cooperate to implement audio encoding.

The second acquisition module 5551 is configured to acquire, in response to an encoding request for an audio signal, a target encoding mode for the audio signal from a plurality of encoding modes, and acquire a target bit rate mode for the audio signal from a plurality of bit rate modes. The extraction module 5552 is configured to extract, by using the target encoding mode, an encoding feature of the audio signal from the audio signal. The signal encoding module 5553 is configured to perform, by using the target bit rate mode, signal encoding on the encoding feature to obtain an audio bitstream of the audio signal. The construction module 5554 is configured to determine a frame header based on the target encoding mode and the target bit rate mode. The generation module 5555 is configured to generate an audio bitstream encapsulation of the audio signal based on the audio bitstream and the frame header.

In some embodiments, when the target encoding mode is a wideband encoding mode, the extraction module 5552 is further configured to invoke a first NN based on the wideband encoding mode; and extract, by using the first NN, the encoding feature of the audio signal from the audio signal.

In some embodiments, the extraction module 5552 is further configured to perform feature extraction on the audio signal to obtain an audio feature of the audio signal; and perform, by using at least one residual unit included in the first NN, residual processing on the audio feature to obtain the encoding feature of the audio signal.

In some embodiments, the first NN includes 4 encoding blocks, and each of the encoding blocks includes 4 or 5 residual units.

In some embodiments, the target bit rate mode is configured for indicating using a target codebook to perform signal encoding on the encoding feature of the audio signal; and the signal encoding module 5553 is further configured to perform, by using the target codebook, quantization on the encoding feature of the audio signal to obtain a quantization value of the encoding feature; and perform, by using a target bit rate corresponding to the target codebook, entropy encoding on the quantization value to obtain the audio bitstream of the audio signal.

In some embodiments, when the target encoding mode is an ultra-wideband encoding mode, the extraction module 5552 is further configured to perform sub-band decomposition on the audio signal to obtain a low-frequency sub-band signal and a high-frequency sub-band signal of the audio signal; extract, by using a second NN, a low-frequency feature of the low-frequency sub-band signal from the low-frequency sub-band signal; perform high-frequency analysis on the high-frequency sub-band signal to obtain a high-frequency feature of the high-frequency sub-band signal; and determine the low-frequency feature and the high-frequency feature as the encoding feature of the audio signal.

In some embodiments, the extraction module 5552 is further configured to perform framing on the high-frequency sub-band signal to obtain a plurality of sub-frames of the high-frequency sub-band signal; perform bandwidth extension processing on each of the sub-frames to obtain a sub-band spectral envelope of the sub-frame; and use the sub-band spectral envelopes respectively corresponding to the plurality of sub-frames as the high-frequency feature of the high-frequency sub-band signal.

In some embodiments, the extraction module 5552 is further configured to perform frequency domain transform based on a plurality of sample points included in the sub-frame to obtain transform coefficients respectively corresponding to the plurality of sample points; divide the transform coefficients respectively corresponding to the plurality of sample points into a plurality of sub-bands; and average the transform coefficients included in each of the sub-bands to obtain average energy corresponding to the sub-band, and using the average energy as a sub-band spectral envelope corresponding to the sub-band.

In some embodiments, the target bit rate mode includes indicating using a first codebook to perform signal encoding on the low-frequency feature, and using a second codebook to perform signal encoding on the high-frequency feature; and the signal encoding module 5553 is further configured to perform, by using the first codebook, quantization on the low-frequency feature to obtain a quantization value of the low-frequency feature, and perform, by using a bit rate corresponding to the first codebook, entropy encoding on the quantization value of the low-frequency feature to obtain a low-frequency bitstream of the low-frequency sub-band signal; perform, by using the second codebook, quantization on the high-frequency feature to obtain a quantization value of the high-frequency feature, and perform, by using a bit rate corresponding to the second codebook, entropy encoding on the quantization value of the high-frequency feature to obtain a high-frequency bitstream of the high-frequency sub-band signal; and construct the audio bitstream of the audio signal based on the low-frequency bitstream and the high-frequency bitstream.

In some embodiments, the target bit rate mode further includes indicating using a third codebook to perform signal encoding on a residual feature of the high-frequency feature; and the signal encoding module 5553 is further configured to determine sub-bands corresponding to sub-frames of the high-frequency sub-band signal, and divide the sub-bands into a plurality of subsets; average transform coefficients included in each of the subsets to obtain average energy corresponding to the subset, and use the average energy as an envelope value corresponding to the subset; determine, in the quantization value of the high-frequency feature, a quantization value of a sub-band spectral envelope of a sub-band corresponding to the subset, and use a difference between the envelope value corresponding to the subset and the quantization value of the sub-band spectral envelope as a first residual value; determine the residual feature of the high-frequency feature based on the first residual value; and perform, by using the third codebook, quantization on the residual feature of the high-frequency feature to obtain a quantization value of the residual feature of the high-frequency feature, and perform, by using a bit rate corresponding to the third codebook, entropy encoding on the quantization value of the residual feature of the high-frequency feature to obtain a residual bitstream of the residual feature. The construction module 5554 is further configured to use the low-frequency bitstream, the high-frequency bitstream, and the residual bitstream as the audio bitstream of the audio signal.

In some embodiments, when a quantity of residual values is N, N being a positive integer greater than 1, the signal encoding module 5553 is further configured to determine a quantization value of an n^{th} residual value, and determine a sum of the quantization value of the n^{th} residual value and the quantization value of the sub-band spectral envelope of the corresponding sub-band; use a difference between the envelope value corresponding to the subset and the sum as an (n+1)^{th} residual value; and determine the N residual values as the residual feature of the high-frequency feature; where n is a sequentially increasing positive integer, and 1≤n≤N.

In some embodiments, before the audio bitstream encapsulation of the audio signal is generated based on the audio bitstream and the frame header, the signal encoding module 5553 is further configured to determine flatness side information of the high-frequency sub-band signal; and the generation module 5555 is further configured to obtain the audio bitstream encapsulation of the audio signal by combining the audio bitstream, the frame header, and the flatness side information.

In some embodiments, the signal encoding module 5553 is further configured to divide transform coefficients included in sub-frames of the high-frequency sub-band signal into a plurality of blocks; determine first flatness of each of the blocks, and determine second flatness of a specified low-frequency band of the audio signal; set the flatness side information to a first value when the first flatness is less than the second flatness or the first flatness is less than a flatness threshold, where the first value indicates that flattening processing is required during audio decoding; and set the flatness side information to a second value when the first flatness is greater than or equal to the second flatness and the first flatness is greater than or equal to the flatness threshold, where the second value indicates that flattening processing is not required during audio decoding.

In some embodiments, the frame header further includes at least 1 channel bit, and the channel bit is configured for indicating performing audio encoding on the audio signal by using mono encoding or stereo encoding.

The audio decoding apparatus 655 includes a series of modules, including a first acquisition module 6551, a signal decoding module 6552, and a reconstruction module 6553. The following continues to describe a solution in which the modules in the audio encoding apparatus 555 provided in this embodiment of the disclosure cooperate to implement audio encoding.

The first acquisition module 6551 is configured to acquire an audio bitstream encapsulation, the audio bitstream encapsulation including an audio bitstream, the audio bitstream being obtained by performing audio encoding on an audio signal by using a target encoding mode and a target bit rate mode, the target encoding mode being acquired from a plurality of candidate encoding modes, and the target bit rate mode being acquired from a plurality of candidate bit rate modes; and acquire, in response to a decoding request for the audio bitstream encapsulation, the target encoding mode and the target bit rate mode from a frame header included in the audio bitstream encapsulation. The signal decoding module 6552 is configured to perform, by using the target encoding mode and the target bit rate mode, signal decoding on the audio bitstream to obtain an estimated value of an encoding feature corresponding to the audio bitstream. The reconstruction module 6553 is configured to reconstruct, by using the target encoding mode, the estimated value of the encoding feature to obtain a reconstructed audio signal corresponding to the audio bitstream.

In some embodiments, when the target encoding mode is a wideband encoding mode, the target bit rate mode is configured for indicating using a target codebook to perform signal encoding on an encoding feature of the audio signal; and the signal decoding module 6552 is further configured to perform, by using a target bit rate corresponding to the target codebook, entropy decoding on the audio bitstream to obtain a quantization value corresponding to the audio bitstream; and perform, by using the target codebook, inverse quantization on the quantization value corresponding to the audio bitstream to obtain the estimated value of the encoding feature corresponding to the audio bitstream.

In some embodiments, when the target encoding mode is a wideband encoding mode, the reconstruction module 6553 is further configured to invoke a third NN based on the wideband encoding mode; and reconstruct, by using the third NN, the estimated value of the encoding feature corresponding to the audio bitstream to obtain the reconstructed audio signal corresponding to the audio bitstream.

In some embodiments, the reconstruction module 6553 is further configured to perform, by using at least one residual unit included in the third NN, residual processing on the estimated value of the encoding feature corresponding to the audio bitstream to obtain an estimated value of an audio feature corresponding to the audio bitstream; and perform feature reconstruction on the estimated value of the audio feature corresponding to the audio bitstream to obtain the reconstructed audio signal corresponding to the audio bitstream.

In some embodiments, the third NN includes 4 decoding blocks, and each of the decoding block includes 4 or 5 residual units.

In some embodiments, when the target encoding mode is an ultra-wideband encoding mode, the target bit rate mode includes indicating using a first codebook to perform signal encoding on a low-frequency feature of the audio signal, and using a second codebook to perform signal encoding on a high-frequency feature of the audio signal, and the audio bitstream includes a low-frequency bitstream and a high-frequency bitstream; and the signal decoding module 6552 is further configured to acquire the low-frequency bitstream and the high-frequency bitstream from the audio bitstream by using the target encoding mode; perform, by using a bit rate corresponding to the first codebook, entropy decoding on the low-frequency bitstream to obtain a quantization value corresponding to the low-frequency bitstream, and perform, by using the first codebook, inverse quantization on the quantization value corresponding to the low-frequency bitstream to obtain an estimated value of the low-frequency feature corresponding to the low-frequency bitstream; perform, by using a bit rate corresponding to the second codebook, entropy decoding on the high-frequency bitstream to obtain a quantization value corresponding to the high-frequency bitstream, and perform, by using the second codebook, inverse quantization on the quantization value corresponding to the high-frequency bitstream to obtain an estimated value of the high-frequency feature corresponding to the high-frequency bitstream; and determine, based on the estimated value of the low-frequency feature and the estimated value of the high-frequency feature, the estimated value of the encoding feature corresponding to the audio bitstream.

In some embodiments, the audio bitstream further includes a residual bitstream, and the target bit rate mode further includes indicating using a third codebook to perform signal encoding on a residual feature of a high-frequency feature corresponding to the audio bitstream; and the signal decoding module 6552 is further configured to perform, by using a bit rate corresponding to the third codebook, entropy decoding on the residual bitstream to obtain a quantization value corresponding to the residual bitstream, and perform, by using the third codebook, inverse quantization on the quantization value corresponding to the residual bitstream to obtain an estimated value of the residual feature corresponding to the residual bitstream; determine a sum of the estimated value of the high-frequency feature and the estimated value of the residual feature as a final estimated value of the high-frequency feature; and determine the estimated value of the low-frequency feature and the final estimated value of the high-frequency feature as the estimated value of the encoding feature corresponding to the audio bitstream.

In some embodiments, the reconstruction module 6553 is further configured to perform, by using a fourth NN when the target encoding mode is ultra-wideband encoding, feature reconstruction on the estimated value of the low-frequency feature included in the estimated value of the encoding feature to obtain an estimated value of a low-frequency sub-band signal corresponding to the audio bitstream; perform high-frequency reconstruction on the estimated value of the high-frequency feature included in the estimated value of the encoding feature to obtain an estimated value of a high-frequency sub-band signal corresponding to the audio bitstream; and perform sub-band synthesis on the estimated value of the low-frequency sub-band signal and the estimated value of the high-frequency sub-band signal to obtain the reconstructed audio signal corresponding to the audio bitstream.

In some embodiments, the reconstruction module 6553 is further configured to perform frequency domain transform on first-half sample points and second-half sample points included in the estimated value of the low-frequency sub-band signal to obtain a first transform coefficient corresponding to the first-half sample points and a second transform coefficient corresponding to the second-half sample points; perform, based on the first transform coefficient, inverse bandwidth extension on the estimated value of the high-frequency feature to obtain an estimated value of a first high-frequency sub-band signal; perform, based on the second transform coefficient, inverse bandwidth extension on the estimated value of the high-frequency feature to obtain an estimated value of a second high-frequency sub-band signal; and obtain the estimated value of the high-frequency sub-band signal corresponding to the audio bitstream by combining the estimated value of the first high-frequency sub-band signal and the estimated value of the second high-frequency sub-band signal.

In some embodiments, the reconstruction module 6553 is further configured to perform spectrum replication on a second-half transform coefficient in the first transform coefficient to obtain a first reference transform coefficient of a reference high-frequency sub-band signal; perform, based on a first-half sub-band spectral envelope corresponding to the estimated value of the high-frequency feature, gain processing on the first reference transform coefficient to obtain a first reference transform coefficient obtained after gain processing; and perform inverse frequency domain transform on the first reference transform coefficient obtained after gain processing, to obtain the estimated value of the first high-frequency sub-band signal.

In some embodiments, the audio bitstream encapsulation includes flatness side information; and after performing spectrum replication on a second-half transform coefficient in the first transform coefficient to obtain a first reference transform coefficient of a reference high-frequency sub-band signal, the reconstruction module 6553 is further configured to determine, when the flatness side information indicates that flattening processing is required during audio decoding, an (i−1)^{th} first reference transform coefficient, an i^{th} first reference transform coefficient, and an (i+1)^{th} first reference transform coefficient; determine an average power spectrum based on the (i−1)^{th} first reference transform coefficient, the i^{th} first reference transform coefficient, and the (i+1)^{th} first reference transform coefficient; and using a ratio of the i^{th} first reference transform coefficient to the average power spectrum as a new i^{th} first reference transform coefficient; where 1<i<I, i is a positive integer, and I is a quantity of the first reference transform coefficients.

In some embodiments, the frame header further includes at least 1 channel bit, and the channel bit is configured for indicating performing audio decoding on the audio bitstream by using mono decoding or stereo decoding.

Some embodiments of the disclosure provide a computer program product. The computer program product includes a computer-executable instruction, and the computer-executable instruction is stored in a computer-readable storage medium. A processor of an electronic device reads the computer-executable instruction from the computer-readable storage medium, and the processor executes the computer-executable instruction to cause the electronic device to perform the foregoing audio encoding method or audio decoding method according to some embodiments of the disclosure.

Some embodiments of the disclosure provide a computer-readable storage medium, having a computer-executable instruction stored therein. When the computer-executable instruction is executed by a processor, the processor is caused to perform the audio encoding method or the audio decoding method provided in some embodiments of the disclosure, for example, the audio encoding method shown in FIG. 4A.

In some embodiments, the computer-readable storage medium may be a memory such as a ferroelectric RAM (FRAM), a ROM, a programmable ROM (PROM), an erasable programmable ROM (EPROM), an electrically erasable programmable ROM (EEPROM), a flash memory, a magnetic surface memory, an optical disk, or a CD-ROM; and may alternatively be various electronic devices including one or any combination of the foregoing memories.

In some embodiments, the computer-executable instructions (briefly referred to as executable instructions) may be written in any form of programming language (including a compiled or interpreted language, or a declarative or procedural language) in a form of a program, software, a software module, a script, or code, and may be deployed in any form, including being deployed as an independent program or being deployed as a module, a component, a subroutine, or another unit applicable for use in a computing environment.

As an example, the executable instructions may, but do not necessarily, correspond to a file in a file system, and may be stored in a part of a file that saves another program or other data, for example, be stored in one or more scripts in a hypertext markup language (HTML) file, stored in a file that is specially configured for a program in discussion, or stored in the plurality of collaborative files (e.g., be stored in files of one or modules, subprograms, or code parts).

In an example, the executable instructions may be deployed to be executed on one electronic device, or deployed to be executed on a plurality of electronic devices at one location, or deployed to be executed on a plurality of electronic devices that are distributed at a plurality of locations and interconnected by using a communication network.

According to some embodiments of the disclosure, when the target encoding mode is a wideband encoding mode, the extracting of the encoding feature of the audio signal from the audio signal includes invoking a first NN based on the wideband encoding mode; and extracting, using the first NN, the encoding feature of the audio signal from the audio signal.

The extracting the encoding feature of the audio signal from the audio signal includes performing feature extraction based on the audio signal to obtain an audio feature of the audio signal; and performing, using at least one residual unit comprised in the first NN, residual processing based on the audio feature to obtain the encoding feature of the audio signal.

The first NN includes 4 encoding blocks, each of the encoding blocks including 4 or 5 residual units.

The target bit rate mode is used to indicate using a target codebook to perform signal encoding based on the encoding feature of the audio signal. The performing signal encoding on the encoding feature to obtain the audio bitstream of the audio signal includes performing, using the target codebook, quantization based on the encoding feature to obtain a quantization value of the encoding feature; and performing, using a target bit rate corresponding to the target codebook, entropy encoding based on the quantization value to obtain the audio bitstream of the audio signal.

When the target encoding mode is an ultra-wideband encoding mode, the extracting of the encoding feature of the audio signal from the audio signal includes performing sub-band decomposition based on the audio signal to obtain a low-frequency sub-band signal and a high-frequency sub-band signal of the audio signal; extracting, using a second NN, a low-frequency feature of the low-frequency sub-band signal from the low-frequency sub-band signal; performing high-frequency analysis based on the high-frequency sub-band signal to obtain a high-frequency feature of the high-frequency sub-band signal; and determining the low-frequency feature and the high-frequency feature as the encoding feature of the audio signal.

The performing high-frequency analysis to obtain the high-frequency feature of the high-frequency sub-band signal includes performing framing based on the high-frequency sub-band signal to obtain a plurality of sub-frames of the high-frequency sub-band signal; performing bandwidth extension processing based on each of the sub-frames to obtain a sub-band spectral envelope of the sub-frame; and using the sub-band spectral envelopes respectively corresponding to the plurality of sub-frames as the high-frequency feature of the high-frequency sub-band signal.

The performing of bandwidth extension processing to obtain the sub-band spectral envelope of the sub-frame include performing frequency domain transform based on a plurality of sample points included in the sub-frame to obtain transform coefficients respectively corresponding to the plurality of sample points; dividing the transform coefficients respectively corresponding to the plurality of sample points into a plurality of sub-bands; and averaging the transform coefficients included in each of the sub-bands to obtain average energy corresponding to the sub-band, and using the average energy as a sub-band spectral envelope corresponding to the sub-band.

The target bit rate mode is used to indicate using a first codebook to perform signal encoding on the low-frequency feature, and using a second codebook to perform signal encoding on the high-frequency feature. The performing of the signal encoding on the encoding feature to obtain an audio bitstream of the audio signal includes performing, using the first codebook, quantization based on the low-frequency feature to obtain a quantization value of the low-frequency feature; performing, using a bit rate corresponding to the first codebook, entropy encoding based on the quantization value of the low-frequency feature to obtain a low-frequency bitstream of the low-frequency sub-band signal; performing, using the second codebook, quantization based on the high-frequency feature to obtain a quantization value of the high-frequency feature; performing, using a bit rate corresponding to the second codebook, entropy encoding based on the quantization value of the high-frequency feature to obtain a high-frequency bitstream of the high-frequency sub-band signal; and constructing the audio bitstream of the audio signal based on the low-frequency bitstream and the high-frequency bitstream.

The target bit rate mode further includes indicating using a third codebook to perform signal encoding on a residual feature of the high-frequency feature. The audio encoding method further includes determining sub-bands corresponding to sub-frames of the high-frequency sub-band signal, and dividing the sub-bands into a plurality of subsets; averaging transform coefficients included in each of the subsets to obtain average energy corresponding to the subset, and using the average energy as an envelope value corresponding to the subset; determining, in the quantization value of the high-frequency feature, a quantization value of a sub-band spectral envelope of a sub-band corresponding to the subset, and using a difference between the envelope value corresponding to the subset and the quantization value of the sub-band spectral envelope as a first residual value; determining the residual feature of the high-frequency feature based on the first residual value; performing, using the third codebook, quantization based on the residual feature of the high-frequency feature to obtain a quantization value of the residual feature of the high-frequency feature; and performing, using a bit rate corresponding to the third codebook, entropy encoding based on the quantization value of the residual feature of the high-frequency feature to obtain a residual bitstream of the residual feature. The constructing the audio bitstream of the audio signal based on the low-frequency bitstream and the high-frequency bitstream includes using the low-frequency bitstream, the high-frequency bitstream, and the residual bitstream as the audio bitstream of the audio signal.

When a quantity of residual values is N that is a positive integer greater than 1, the determining of the residual feature of the high-frequency feature based on the first residual value includes determining a quantization value of an nth residual value, and determining a sum of the quantization value of the nth residual value and the quantization value of the sub-band spectral envelope of the corresponding sub-band; using a difference between the envelope value corresponding to the subset and the sum as an (n+1)th residual value; and determining the N residual values as the residual feature of the high-frequency feature. n is a sequentially increasing positive integer, and 1≤n≤N.

Before the generating an audio bitstream encapsulation of the audio signal based on the audio bitstream and the frame header, the audio encoding method further includes determining flatness side information of the high-frequency sub-band signal. The generating an audio bitstream encapsulation of the audio signal based on the audio bitstream and the frame header includes obtaining the audio bitstream encapsulation of the audio signal by at least combining the audio bitstream, the frame header, and the flatness side information.

The determining of the flatness side information of the high-frequency sub-band signal include dividing transform coefficients included in sub-frames of the high-frequency sub-band signal into a plurality of blocks; determining first flatness of each of the blocks, and determining second flatness of a specified low-frequency band of the audio signal; setting the flatness side information to a first value when the first flatness is less than the second flatness or the first flatness is less than a flatness threshold, the first value indicating that flattening processing is required during audio decoding; and setting the flatness side information to a second value when the first flatness is greater than or equal to the second flatness and the first flatness is greater than or equal to the flatness threshold, the second value indicating that flattening processing is not required during audio decoding.

The frame header further includes at least 1 channel bit, the channel bit being configured for indicating performing audio encoding on the audio signal by using mono encoding or stereo encoding.

Related data such as user information is involved in some embodiments of the disclosure. When some embodiments of the disclosure are applied to a specific product or technology, user permission or consent is required, and acquisition, use, and processing of related data need to comply with related laws, regulations, and standards in related countries and regions.

The foregoing descriptions are merely embodiments of the disclosure and are not intended to limit the protection scope of the disclosure. Any modification, equivalent replacement, and improvement made within the spirit and scope of the disclosure fall within the protection scope of the disclosure.

What is claimed is:

1. An audio decoding method performed by an electronic device, the audio decoding method comprising:
acquiring an audio bitstream encapsulation, the audio bitstream encapsulation including an audio bitstream, the audio bitstream being obtained by at least performing, using a target encoding mode and a target bit rate mode, audio encoding based on an audio signal, the target encoding mode being acquired from a plurality of candidate encoding modes, and the target bit rate mode being acquired from a plurality of candidate bit rate modes;
acquiring, when a decoding request for the audio bitstream encapsulation is obtained, the target encoding mode and the target bit rate mode from a frame header included in the audio bitstream encapsulation;
performing, using the target encoding mode and the target bit rate mode, signal decoding based on the audio bitstream to obtain an estimated value of an encoding feature corresponding to the audio bitstream; and
reconstructing, using the target encoding mode, the estimated value of the encoding feature to obtain a reconstructed audio signal corresponding to the audio bitstream.

2. The audio decoding method according to claim 1, wherein, when the target encoding mode is a wideband encoding mode, the target bit rate mode is used to indicate using a target codebook to perform signal encoding based on an encoding feature of the audio signal, and
wherein the performing the signal decoding to obtain the estimated value comprises:
performing, using a target bit rate corresponding to the target codebook, entropy decoding based on the audio bitstream to obtain a quantization value corresponding to the audio bitstream; and
performing, using the target codebook, inverse quantization based on the quantization value to obtain the estimated value of the encoding feature corresponding to the audio bitstream.

3. The audio decoding method according to claim 1, wherein, when the target encoding mode is a wideband encoding mode, the reconstructing of the estimated value comprises:
invoking a third neural network (NN) based on the wideband encoding mode; and
reconstructing, using the third NN, the estimated value of the encoding feature to obtain the reconstructed audio signal corresponding to the audio bitstream.

4. The audio decoding method according to claim 3, wherein the reconstructing of the estimated value of the encoding feature to obtain the reconstructed audio signal comprises:
performing, using at least one residual unit included in the third NN, residual processing based on the estimated value of the encoding feature to obtain an estimated value of an audio feature corresponding to the audio bitstream; and
performing feature reconstruction based on the estimated value of the audio feature to obtain the reconstructed audio signal corresponding to the audio bitstream.

5. The audio decoding method according to claim 4, wherein the third NN includes 4 decoding blocks, each of the decoding blocks including 4 or 5 residual units.

6. The audio decoding method according to claim 1, wherein, when the target encoding mode is an ultra-wideband encoding mode:
the target bit rate mode is used to indicate using a first codebook to perform signal encoding on a low-frequency feature of the audio signal, and using a second codebook to perform signal encoding on a high-frequency feature of the audio signal; and
the audio bitstream includes a low-frequency bitstream and a high-frequency bitstream; and
wherein the performing of the signal decoding to obtain the estimated value of the encoding feature corresponding to the audio bitstream comprises:
acquiring, using the target encoding mode, the low-frequency bitstream and the high-frequency bitstream based on the audio bitstream;
performing, using a bit rate corresponding to the first codebook, entropy decoding based on the low-frequency bitstream to obtain a quantization value corresponding to the low-frequency bitstream;
performing, using the first codebook, inverse quantization based on the quantization value corresponding to the low-frequency bitstream to obtain an estimated value of the low-frequency feature corresponding to the low-frequency bitstream;
performing, using a bit rate corresponding to the second codebook, entropy decoding based on the high-frequency bitstream to obtain a quantization value corresponding to the high-frequency bitstream;
performing, using the second codebook, inverse quantization based on the quantization value corresponding to the high-frequency bitstream to obtain an estimated value of the high-frequency feature corresponding to the high-frequency bitstream; and
determining, based on the estimated value of the low-frequency feature and the estimated value of the high-frequency feature, the estimated value of the encoding feature corresponding to the audio bitstream.

7. The audio decoding method according to claim 6, wherein the audio bitstream further includes a residual bitstream,
wherein the target bit rate mode further includes indicating using a third codebook to perform signal encoding based on a residual feature of a high-frequency feature corresponding to the audio bitstream, and
wherein the audio decoding method further comprises:
performing, using a bit rate corresponding to the third codebook, entropy decoding based on the residual bitstream to obtain a quantization value corresponding to the residual bitstream; and
performing, using the third codebook, inverse quantization based on the quantization value corresponding to the residual bitstream to obtain an estimated value of the residual feature corresponding to the residual bitstream; and
wherein the determining of the estimated value of the encoding feature comprises:
determining a sum of the estimated value of the high-frequency feature and the estimated value of the residual feature as a final estimated value of the high-frequency feature; and
determining the estimated value of the low-frequency feature and the final estimated value of the high-frequency feature as the estimated value of the encoding feature corresponding to the audio bitstream.

8. The method according to claim 7, wherein the reconstructing of the estimated value of the encoding feature to obtain a reconstructed audio signal comprises:
when the target encoding mode is ultra-wideband encoding, performing, using a fourth NN, feature reconstruction on the estimated value of the low-frequency feature included in the estimated value of the encoding feature to obtain an estimated value of a low-frequency sub-band signal corresponding to the audio bitstream;
performing high-frequency reconstruction based on the estimated value of the high-frequency feature included in the estimated value of the encoding feature to obtain an estimated value of a high-frequency sub-band signal corresponding to the audio bitstream; and
performing sub-band synthesis based on the estimated value of the low-frequency sub-band signal and the estimated value of the high-frequency sub-band signal to obtain the reconstructed audio signal corresponding to the audio bitstream.

9. The audio decoding method according to claim 8, wherein the performing of the high-frequency reconstruction to obtain the estimated value of the high-frequency sub-band signal comprises:
performing frequency domain transform based on first-half sample points and second-half sample points included in the estimated value of the low-frequency sub-band signal to obtain a first transform coefficient corresponding to the first-half sample points and a second transform coefficient corresponding to the second-half sample points;
performing, using the first transform coefficient, inverse bandwidth extension based on the estimated value of the high-frequency feature to obtain an estimated value of a first high-frequency sub-band signal;
performing, using the second transform coefficient, inverse bandwidth extension based on the estimated value of the high-frequency feature to obtain an estimated value of a second high-frequency sub-band signal; and
obtaining the estimated value of the high-frequency sub-band signal corresponding to the audio bitstream by at least combining the estimated value of the first high-frequency sub-band signal and the estimated value of the second high-frequency sub-band signal.

10. The audio decoding method according to claim 9, wherein the performing of the inverse bandwidth extension to obtain the estimated value of the first high-frequency sub-band signal comprises:
performing spectrum replication based on a second-half transform coefficient in the first transform coefficient to obtain a first reference transform coefficient of a reference high-frequency sub-band signal;
performing, using a first-half sub-band spectral envelope corresponding to the estimated value of the high-frequency feature, gain processing based on the first reference transform coefficient to obtain a gain processed first reference transform coefficient; and
when gain processing is performed, performing inverse frequency domain transform on the gain processed first reference transform coefficient, to obtain the estimated value of the first high-frequency sub-band signal.

11. The audio decoding method according to claim 10, wherein the audio bitstream encapsulation includes flatness side information; and
when spectrum replication is performed based on a second-half transform coefficient in the first transform coefficient to obtain the first reference transform coefficient of the reference high-frequency sub-band signal, the audio encoding method further comprises:
determining, when the flatness side information indicates that flattening processing is to be performed during audio decoding, an (i−1)^{th} first reference transform coefficient, an i^{th} first reference transform coefficient, and an (i+1)^{th} first reference transform coefficient;
determining an average power spectrum based on the (i−1)^{th} first reference transform coefficient, the i^{th} first reference transform coefficient, and the (i+1)^{th} first reference transform coefficient; and
using a ratio of the i^{th} first reference transform coefficient to the average power spectrum as a new i^{th} first reference transform coefficient;
wherein 1<i<I,
wherein i is a positive integer, and
wherein I is a quantity of the first reference transform coefficients.

12. The audio decoding method according to claim 1, wherein the frame header further includes at least one channel bit, the at least one channel bit being used to indicate mono decoding or stereo decoding for performing audio decoding based on the audio bitstream.

13. An audio decoding apparatus, comprising:
at least one memory configured to store computer program code; and
at least one processor configured to read the program code and operate as instructed by the program code, the program code comprising:
acquisition code configured to cause the at least one processor to:
acquire an audio bitstream encapsulation, the audio bitstream encapsulation including an audio bitstream, the audio bitstream being obtained by at least performing, using a target encoding mode and a target bit rate mode, audio encoding based on an audio signal, the target encoding mode being acquired from a plurality of candidate encoding modes, and the target bit rate mode being acquired from a plurality of candidate bit rate modes; and
acquire, when a decoding request for the audio bitstream encapsulation is obtained, the target encoding mode and the target bit rate mode from a frame header included in the audio bitstream encapsulation;
signal decoding code configured to cause the at least one processor to:
perform, using the target encoding mode and the target bit rate mode, signal decoding based on the audio bitstream to obtain an estimated value of an encoding feature corresponding to the audio bitstream; and
reconstruction code configured to cause the least one processor to reconstruct, using the target encoding mode, the estimated value of the encoding feature to obtain a reconstructed audio signal corresponding to the audio bitstream.

14. The audio decoding apparatus according to claim 13, wherein, when the target encoding mode is a wideband encoding mode, the target bit rate mode is used to indicate using a target codebook to perform signal encoding based on an encoding feature of the audio signal.

15. The audio decoding apparatus according to claim 14, wherein, when the target encoding mode is a wideband encoding mode, the reconstruction code is further configured to cause at least one processor to:
invoke a third neural network (NN) based on the wideband encoding mode; and
reconstruct, using the third NN, the estimated value of the encoding feature to obtain the reconstructed audio signal corresponding to the audio bitstream.

16. The audio decoding apparatus according to claim 15, the reconstruction code is further configured to cause at least one processor to:
perform, using at least one residual unit included in the third NN, residual processing based on the estimated value of the encoding feature to obtain an estimated value of an audio feature corresponding to the audio bitstream; and
perform feature reconstruction based on the estimated value of the audio feature to obtain the reconstructed audio signal corresponding to the audio bitstream.

17. The audio decoding apparatus according to claim 16, wherein the third NN includes 4 decoding blocks, each of the decoding blocks including 4 or 5 residual units.

18. The audio decoding apparatus according to claim 13, wherein, when the target encoding mode is an ultra-wideband encoding mode:
the target bit rate mode is used to indicate using a first codebook to perform signal encoding on a low-frequency feature of the audio signal, and using a second codebook to perform signal encoding on a high-frequency feature of the audio signal; and
the audio bitstream includes a low-frequency bitstream and a high-frequency bitstream; and
wherein the signal decoding code is further configured to cause at least one processor to:
acquiring, using the target encoding mode, the low-frequency bitstream and the high-frequency bitstream based on the audio bitstream;
performing, using a bit rate corresponding to the first codebook, entropy decoding based on the low-frequency bitstream to obtain a quantization value corresponding to the low-frequency bitstream;
performing, using the first codebook, inverse quantization based on the quantization value corresponding to the low-frequency bitstream to obtain an estimated value of the low-frequency feature corresponding to the low-frequency bitstream;
performing, using a bit rate corresponding to the second codebook, entropy decoding based on the high-frequency bitstream to obtain a quantization value corresponding to the high-frequency bitstream;
performing, using the second codebook, inverse quantization based on the quantization value corresponding to the high-frequency bitstream to obtain an estimated value of the high-frequency feature corresponding to the high-frequency bitstream; and
determining, based on the estimated value of the low-frequency feature and the estimated value of the high-frequency feature, the estimated value of the encoding feature corresponding to the audio bitstream.

19. The audio decoding apparatus according to claim 18, wherein the audio bitstream further includes a residual bitstream,
wherein the target bit rate mode is further used to indicate using a third codebook to perform signal encoding based on a residual feature of a high-frequency feature corresponding to the audio bitstream, and
wherein the signal decoding code is further configured to cause at least one processor to:
perform, using a bit rate corresponding to the third codebook, entropy decoding based on the residual bitstream to obtain a quantization value corresponding to the residual bitstream;
perform, using the third codebook, inverse quantization based on the quantization value corresponding to the residual bitstream to obtain an estimated value of the residual feature corresponding to the residual bitstream;
determine a sum of the estimated value of the high-frequency feature and the estimated value of the residual feature as a final estimated value of the high-frequency feature; and
determine the estimated value of the low-frequency feature and the final estimated value of the high-frequency feature as the estimated value of the encoding feature corresponding to the audio bitstream.

20. The non-transitory computer-readable storage medium, storing computer code, when executed by at least one processor, causes the at least one processor to at least:
acquire an audio bitstream encapsulation, the audio bitstream encapsulation including an audio bitstream, the audio bitstream being obtained by at least performing, using a target encoding mode and a target bit rate mode, audio encoding based on an audio signal, the target encoding mode being acquired from a plurality of candidate encoding modes, and the target bit rate mode being acquired from a plurality of candidate bit rate modes;
acquire, when a decoding request for the audio bitstream encapsulation is obtained, the target encoding mode and the target bit rate mode from a frame header included in the audio bitstream encapsulation;
perform, using the target encoding mode and the target bit rate mode, signal decoding based on the audio bitstream to obtain an estimated value of an encoding feature corresponding to the audio bitstream; and
reconstruct, using the target encoding mode, the estimated value of the encoding feature to obtain a reconstructed audio signal corresponding to the audio bitstream.
